(19) United States
(12) Patent Application Publication
(10) Pub. No.: US 2004/0034663 A1
(43) Pub. Date: Feb. 19, 2004

(54) Information providing/requesting database building method and information searching method

(76) Inventor: Takashi Noguchi, Koto-ku (JP)

Correspondence Address: Johnson & Associates, 14625 Baltimore Avenue #282, Laurel, MD, 20707, US

(21) Appl. No.: 10/399,404

(22) PCT Filed: Oct. 18, 2001
(86) PCT No.: PCT/JP01/09146

(30) Foreign Application Priority Data
Oct. 24, 2000 (JP) 2000-324782
Jul. 3, 2001 (JP) 2001-202702

(51) Int. Cl. G06F 17/00

(52) U.S. Cl. 707/104.1

(57) ABSTRACT

The abstract of the first invention is described as follows. An information providing database is added to URL as URL information and published on a communications circuit network. Similarly, an information requested database is added to a URL as URL information and published on a communications circuit network. Using a computer connected to the communications circuit network, the information about each item of the information providing database is sequentially compared with the information about each item of the information requested database from an item of the highest priority in the narrowest and lowest concept gradually to an item of a lower priority in a broader and upper concept until a matching combination can be detected. When a matching combination is detected, the information that a matching combination has been detected is displayed on the home pages of an information provider and an information requester, and the home page of the partner is directly displayed. Additionally, in the second invention, the information providing database and the information requested database are separately designed in advance, and a retrieval identifier is set.

### TECHNICAL FIELD

The present invention relates to an information providing database generating method, an information requested database generating method, and information retrieving method using the information providing database generating method, and the information requested database generating method.

### BACKGROUND ART

First Conventional Information Providing Database

In the conventional information providing database, the information item and a corresponding answer are configured only by what designate static events such as a ‘person’, ‘thing’, ‘information/service’, ‘money’, etc., and do not include what designate dynamic events such as an information interchange system etc. Therefore, it takes a long time to settle a transaction and a business discussion.

Additionally, in the conventional information providing database, a plurality of information items are parallel to the corresponding answers. Therefore, if the concept of an information item is too narrow, it is hard to find request information. On the other hand, if the concept of an information item is too broad, then the request information can be easily detected, but the providing information and the request information do not always match. That is, with the conventional information providing database, there has been a problem with the structures of a plurality of information items and the corresponding answers.

Described below will be the conventional information retrieving and checking method.

Second Conventional Information Retrieving and Checking Method

There is a home page transmission and communications system. A ‘home page transmission and communications system’ can be prepared by: (1-1) each of an information provider and an information requester generating a home page, and describing providing information and request information in free and random form; (1-2) publishing the home page on an information communications network; (1-3) the information provider and the information requester then sequentially viewing home pages published on the information communications network, and comparing them with their own providing information or request information using a manual, and reporting to the other party when a matching home page can be detected; or (1-4) waiting for contact from the party who has viewed the home page of the information provider and the information requester.

However, since the ‘home page transmission and communications system’ is a ‘push-type system’, and requires a predetermined high-level technology in using the system, a common user cannot freely use the technology.

Third Conventional Information Retrieving and Checking Method

There is a ‘recorded information retrieval and distribution system’ by a portal site sponsor using a search engine. The information recorded in the portal site can be automatically and quickly retrieved by a search engine. However, since the information is sifted and ranked by the discretion of the site sponsor or a recorder (information provider), a fair and impartial information distribution cannot be guaranteed based on an objective determination.

Fourth Conventional Information Retrieving and Checking Method

Furthermore, there is also a ‘total text retrieval information retrieval and distribution system’. However, since the value of target information cannot be determined in this system, a large number of pages are retrieved, and the user cannot quickly access requested information.

Commonly in the second to fourth conventional information retrieving and checking methods, the information requester has to visit a plurality of portal sites to find requested information.

Additionally, by visiting a portal site, the information requester is forced to inspect unnecessary information, or unwillingly disclose his or her own information.

Then, there is the problem that it cannot be determined whether or not there is the information requested by the information requester on the Internet until the information requester visits the portal site and inspects the WEB of the site.

Fifth Conventional Information Retrieving and Checking Method

To solve the abovementioned complaints of the information requester, a part of the URL is input in Japanese, the names of a specific product and a manufacturer are input using a keyword, thereby generating a system for simplifying the process of accessing requested information. However, in the system, all information on the WEB of various kinds and types cannot be accessed.

However, there is the following problem with the fifth conventional technology.

Problem (1-1) Requested information cannot be easily retrieved on the Internet.

Problem (1-2) On the Internet, a user has to visit a portal site each time and obtain information sequentially using a search engine.

Problem (1-3) Furthermore, when information is transmitted, it is to be recorded in a portal site with a large fee paid, thereby charging a large fee to a person or middle and small companies.

Sixth Conventional Database

The sixth conventional database has the structure of a retrieval code and corresponding data arranged in a complete database with data prescribed for obtaining the retrieval code as a retrieval key.

Problem (2-4)

However, in the above mentioned conventional database structure, since a retrieval code and data are impartially coupled, the entire code system has to be corrected when a large volume of data is frequently updated, and simultaneously the database itself is to be rewritten. Thus, the database requires complicated maintenance, thereby causing a troublesome task to be performed.

Seventh Conventional Information Providing Database and Information Requested Database

Problem (2-5)

Furthermore, in the conventional information providing database and information requested database, a piece of information is designated for one item. Therefore, the contents of information are fixed, and the true intention of an information provider and an information requester cannot be correctly reflected.

Problem (2-6)

The priority of an item in the information providing database and the information requested database has not been assigned in the conventional technology. That is, all items are equal or a system generator defines the order. Therefore, the information determined as matching as a retrieval result often cannot be found, and matching information cannot be found with an item weighed by an information provider and an information requester.

Problem (2-7)

Additionally, since an item is defined by a system generator in the seventh conventional information providing database and the information requested database, it is often different from the item requested by an information provider and an information requester. Especially, problems easily occur when information is provided and requested on the product whose sales quantity, sales price, and sales date and time are limited. It is troublesome for a system generator, takes a long time and a large cost, and easily outputs a nonmatching result, to frequently amend a database for generation of an information providing database and a database for generation of an information requested database.

### DISCLOSURE OF THE INVENTION

The above mentioned problems (1-1), (1-2), and (1-3) can be solved by claims 1 to 19 described in the first invention of the present application.

The above mentioned problems (2-4), (2-5), (2-6), and (2-7) can be solved by claims 20 to 28 described in the second invention of the present application.

The above mentioned problems (2-4), (2-5), (2-6), and (2-7) can also be solved by claims 29 to 35 described in the third invention of the present application.

The above mentioned problems (2-4), (2-5), (2-6), and (2-7) can also be solved by claims 36 to 39 described in the fourth invention of the present application.

### BRIEF DESCRIPTION OF THE DRAWINGS

FIG. 1 shows the outline of the system of the information retrieving method using the information providing database and the information requested database according to a first invention;

FIG. 2 shows the configuration of the hardware according to an embodiment of the first invention;

FIG. 3 shows the information request HP generation system according to an embodiment of the first invention;

FIG. 4 shows the configuration of the screen during information request input and the information request contents generation procedure (1) according to an embodiment of the first invention;

FIG. 5 shows the configuration of the screen during information request input and the information request contents generation procedure (2) according to an embodiment of the first invention;

FIG. 6 shows the configuration of the screen during information request input and the information request contents generation procedure (3) according to an embodiment of the first invention;

FIG. 7 shows an information request item and an option (1) according to an embodiment of the first invention;

FIG. 8 shows an information request item and an option (2) according to an embodiment of the first invention;

FIG. 9 is a general flow of generating an information request HP according to an embodiment of the first invention;

FIG. 10 shows the system of generating an information providing HP according to an embodiment of the first invention;

FIG. 11 shows the configuration of the screen during information providing input and the information request contents generation procedure according to an embodiment of the first invention;

FIG. 12 shows the configuration of the screen during information providing input and the information request contents generation procedure according to an embodiment of the first invention;

FIG. 13 shows the configuration of the screen during information providing input and the information request contents generation procedure according to an embodiment of the first invention;

FIG. 14 shows an information providing item and an option (1) according to an embodiment of the first invention;

FIG. 15 shows an information providing item and an option (2) according to an embodiment of the first invention;

FIG. 16 is a general flow (1) of an HP checking according to an embodiment of the first invention;

FIG. 17 is a general flow (2) of an HP checking according to an embodiment of the first invention;

FIG. 18 shows the outline of the system of generating the information providing database and the information requested database according to an embodiment of a second invention;

FIG. 19 shows the configuration of the hardware of the system of generating the information providing database and the information requested database according to an embodiment of the second invention;

FIG. 20 shows the system of generating the information requested database when the information providing database is generated and amended according to an embodiment of the second invention;

FIG. 21 shows the system of generating the retrieval checking information providing database according to an embodiment of the second invention;

FIG. 22 shows the process of generating the information providing database according to an embodiment of the second invention;

FIG. 23 shows the details of the information providing database according to an embodiment of the second invention;

FIG. 24 shows the details of the information requested database according to an embodiment of the second invention;

FIG. 25 shows the process of generating the retrieval checking information providing database and the retrieval checking information requested database according to an embodiment of the second invention;

FIG. 26 shows the automatic update system of the information providing database based on the overdue information providing and retrieval result according to an embodiment of the second invention;

FIG. 27 shows a first general flow of checking the retrieval checking information providing database and the retrieval checking information requested database according to an embodiment of the second invention;

FIG. 28 shows a second general flow of checking the retrieval checking information providing database and the retrieval checking information requested database according to an embodiment of the second invention;

FIG. 29 shows a third general flow of checking the retrieval checking information providing database and the retrieval checking information requested database according to an embodiment of the second invention;

FIG. 30 shows the outline of the system of generating the information record and requested database, and generating the information provider database and the information requester database according to an embodiment of a third or fourth invention;

FIG. 31 shows the configuration of the hardware of the system of generating the information record and requested database, and generating the information provider database and the information requester database according to an embodiment of the third or fourth invention;

FIG. 32 shows the system of generating the information provider database and the information requester database when the information record and requested database are generated and amended according to an embodiment of the third or fourth invention;

FIG. 33 shows the process of generating the information record and requested database, and generating the information provider database and the information requester database according to an embodiment of the third or fourth invention;

FIG. 34 shows the process of generating the information record and requested database according to an embodiment of the third or fourth invention;

FIG. 35 shows the details of generating the information record and requested database, and generating the information provider database and the information requester database according to an embodiment of the third or fourth invention;

FIG. 36 shows the retrieval checking process when the information record and requested database, the information provider database, and the information requester database are distributed on the Internet according to an embodiment of the third or fourth invention;

FIG. 37 shows the details of generating the information record and requested database according to an embodiment of the third or fourth invention;

FIG. 38 shows the process of generating the information provider database according to an embodiment of the third or fourth invention;

FIG. 39 shows the process of generating the information requester database according to an embodiment of the third or fourth invention;

FIG. 40 shows the outline of the retrieval and checking process of the information provider database and the information requester database according to an embodiment of the third or fourth invention;

FIG. 41 shows the details of the retrieval and checking process of the information provider database and the information requester database according to an embodiment of the third or fourth invention;

FIG. 42 shows the outline of the system of generating the information provider database code and the information requester database code from the information record and requested database according to an embodiment of the fourth invention;

FIG. 43 shows the system of generating the information provider database code and the information requester database code from the information record and requested database according to an embodiment of the fourth invention;

FIG. 44 shows the process of generating the information provider database code and the information requester database code from the information record and requested database according to an embodiment of the fourth invention;

FIG. 45 shows the details of the retrieval and checking process of the information provider database code and the information requester database code according to an embodiment of the fourth invention; and

FIG. 46 shows the link information automatic generating system in the information record and requested database according to an embodiment of the first invention.

### BEST MODE FOR CARRYING OUT THE INVENTION

Embodiment 1 of the Invention

First, the embodiments of a first invention will be described below in detail by referring to the attached drawings.

An embodiment of the information retrieving method according to the first invention used when a private investor retrieves a prospect for the most profitable and safe item from among the products relating to foreign money deposits will be described below.

Step 1. Generating an Information Request Home Page (HP)

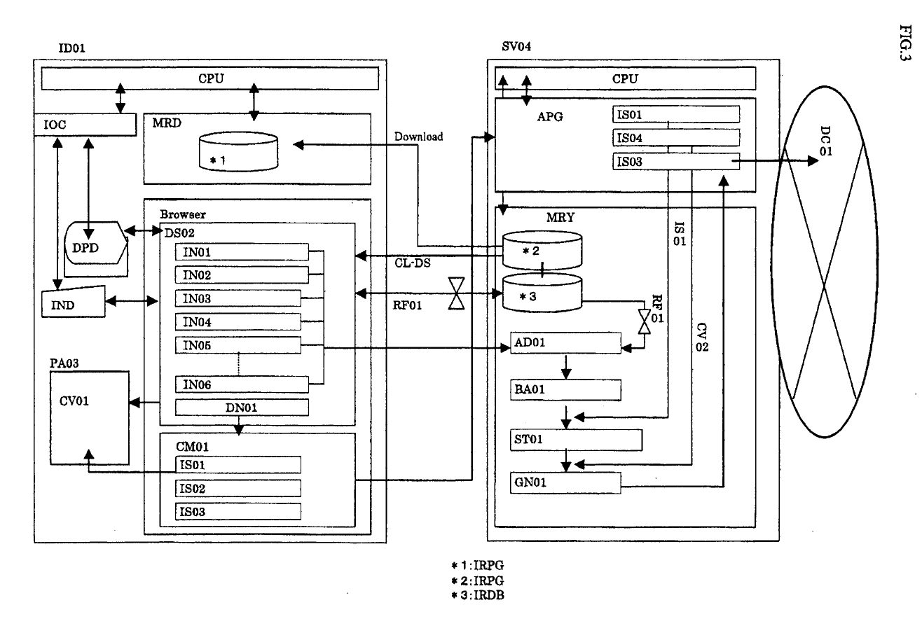

The step will be described below by referring to FIGS. 3, 4, 5, 6, 7, 8, and 9.

1-1. Downloading and running a computer program for generation of an information requested database from a storage area in the server storing the computer program for generation of an information requested database to the information device operated by the information requester through the Internet.

1-2. The computer program for generation of an information requested database comprises the-functions of:

opening a dialog box in:

(A) information requested database generation format;

(B) database for generation of an information requested database defined on a separate table; and

(C) information requested database generation format such that a necessary item can be input or selected, and displaying an option list indicating the information elements in the database for generation of an information requested database;

(D) assigning an identifier to an input or selected item by referring to the database for generation of an information requested database, generating it as a third information element, and instructing the third information element to be stored on the server side;

(E) sorting the generated third information element;

(F) assigning an identifier to the generated third information element;

(G) converting the completely input first to fourth information elements into the sorted URL information provided with identifiers, and adding the information to the sub-directory of URL; and

(H) publishing the URL to which URL information is added on the Internet, retrieving the URL including the first information element indicating the corresponding information providing database using an identifier as a key, checking the internal third information element, directly displaying the matching information providing home page on the browser of the information requester, or displaying the URL of the information provider on the information request home page.

Described below will be the functions of the computer program for generation of the information requested database determined for each item.

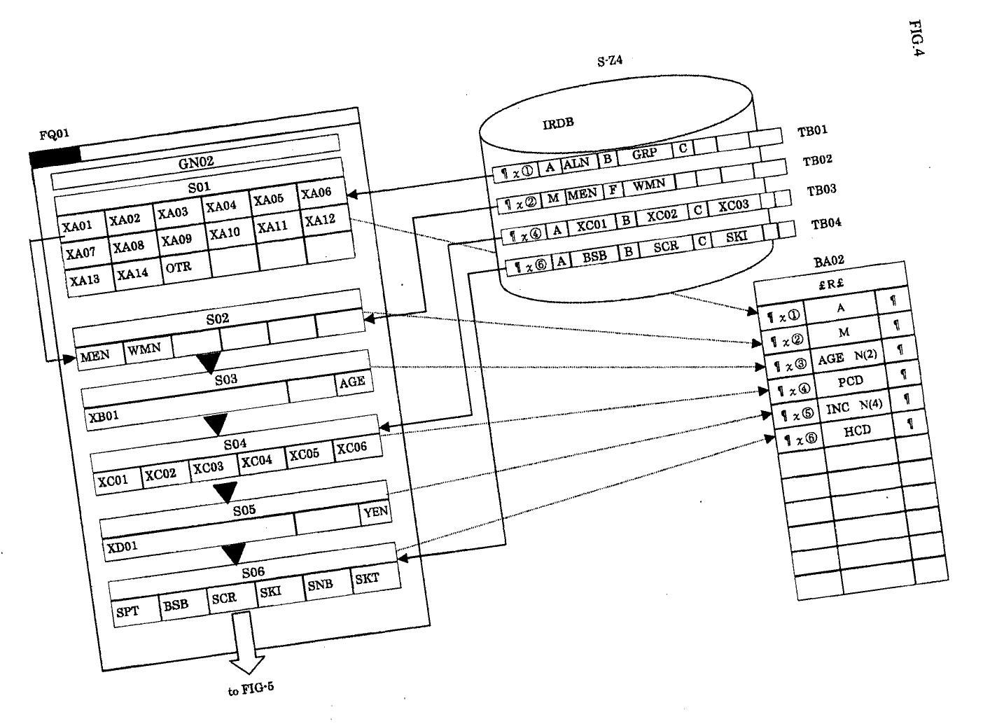

1-3. The information requester calls the page for generation of an information requested database on the browser of the information device (including personal computer, mobile telephone, electric information appliance, information watch, and information telephone). The dialog box is opened in the order of the item selection displayed on the page. From the list of the items displayed on the dialog box (hereinafter referred to as an input box), predetermined items are input or selected (refer to FIG. 4).

1-4. The input or selected option is generated as an information element in the order displayed in the procedure 2.

1-5. An information requester sequentially inputs a predetermined request item by selecting an option displayed on the screen while referring to the database for generation of an information requested database stored in the server according to the instruction of the input box. Items not to be input are not input and control is passed to the subsequent items.

1-6. However, the functions defined in the computer program for generation of an information requested database, the database for generation of an information requested database contained therein, and (A) to (H) of the above mentioned (2) can be collectively downloaded to the information device of the information requester, and the information requester can perform offline the operation to which an identifier is assigned.

1-7. The calling of the database item, the procedure of displaying the input box, and the selecting operation by an information requester are repeatedly performed until the information requested database generating operation is completed as described below in and after the following procedure 1-9.

1-8. The input page from which an option of request information has been selected is stored as an ‘information request home page’ in file form as is. However, the directory of the page is replaced with the request information character string after the request information is sorted and added as indicated in 2-12 of the procedure 2 below.

1-9. The request information starts with the selection of the ‘information requester attribute’. In this case, the ‘information requester attribute’ specifies the ‘person’ from among the options displayed on the input box. The computer program for generation of an information requested database refers to the information requester attribute database, and extracts the corresponding code ‘A’.

1-10. Furthermore, the detailed items of information requester attribute are input. At an instruction of the input box, the ‘sex’, ‘age’, ‘occupation’, ‘annual income’, and ‘hobby/taste’ are selected. The ‘sex’ is represented by the ‘M’ and ‘F’ respectively indicating male and female, and the ‘age’ or ‘annual income’ is represented by inputting an actual value. The ‘occupation’ and ‘hobby/taste’ are extracted by referring to ‘occupation database’ and ‘hobby database’.

1-11. In the case of the 1-4 above, an item not to be input is not input and control is passed to the subsequent items. In this case, generated request information is delimited only by an identifier as shown in the following example (described in the procedure 2 below), and is represented by an input omitted code.

(example) ¶χn¶

1-12. Then, at an instruction of the input box displayed on the page for generation of an information request home page, the ‘request information base’ is input. In this case, the computer program for generation of an information requested database extracts the code ‘D’ for ‘money’ which is the corresponding element by referring to the request information base database.

1-13. Furthermore, at an instruction of the input box displayed on the page for generation of an information request home page, items are sequentially input in the order of ‘request information statement’, ‘details’, ‘classification’, and ‘fragmentation’ In this case, since a foreign money deposit product of a high estimated yield is obtained, ‘by financial product’ ‘F’ is selected for ‘statement’, and ‘foreign money deposit’ indicating the selection by field of the financial product for ‘details’ is selected.

1-14. In this case, ‘classification’ can be ‘in U.S. dollars’, ‘in Euro’, etc. For the ‘fragmentation’, a practical product name such as ‘foreign money deposit in U.S. dollars’ etc. is selected. When the information requester knows the product name, the product name can be input.

1-15. Additionally, options of ‘high estimated yield’ and ‘guaranteed safety’ are specified from among the ‘fine classification’ and ‘finest classification’ databases positioned in the two lower hierarchical level layers.

1-16. In this case, in the ‘fine classification’, for example, ‘estimated yield of 5% or more’ etc. are selected, and the information relating to the feature of a product such as the ‘guaranteed principal’ etc. can be selected for ‘finest classification’.

1-17. Then, at an instruction of the input box displayed on the page for generation of an information request home page, ‘request information base element’ is input. In this case, the computer program for generation of an information requested database refers to the request information base element database, and is to be informed of the corresponding financial product. Therefore, the code ‘L’ corresponding to the request of ‘request to know free of charge’ is extracted.

1-18. Then, at an instruction of the input box displayed on the page for generation of an information request home page, ‘request information distribution configuration’ is input. In this case, the computer program for generation of an information requested database refers to the information distribution configuration database, and is to be informed of the corresponding financial product. Therefore, the code ‘B’ corresponding to the request to ‘request to be informed’ is extracted. In this case, if information by electronic mail is simultaneously requested, then the code ‘A’ can be specified. If a plurality of items are selected from among the same information element hierarchical layers, then the generated request information can be assigned the ‘repeated selection identifier’=‘§’ to simultaneously select and set a plurality of items (described below in the following procedure 2).

1-19. The information requester can further describe the ‘comment on request information’ in free text. For example, in this case, comments such as ‘reliable guarantee of principal’, ‘(request to) avoid exchange-rate fluctuation risk’, etc. can be added in free text. The specification of a code in this case is described in 2-4 of the procedure 2.

1-20. Then, ‘specifying information request range’ is recorded. In this case, a target product can be naturally selected by ‘A’ as ‘limited to Japan’.

1-21. Then, the information requester optionally specifies ‘requested price’, ‘requested quantity’, ‘term of information request’, ‘distribution method’, ‘payment method’, and ‘reply information (range) specification’, etc. relating to a requested product, information, task, etc. from the database. However, in this example, it is not necessary to input these items because it is an inquiry only for requested financial product information, thereby omitting input.

1-22. However, ‘one million yen’, ‘ten thousand dollars’, etc. can be set for ‘requested price’. In this case, ‘one million yen’ is input.

1-23. Also in this case, since an exchange rate fluctuates, the ‘valid request term’ is delimited as two weeks from the request information transmission date, the specified period can be designated by YYMMDD.

1-24. Furthermore, a request to return, for example, ‘C’=‘necessary item only’ can be issued in the ‘reply information specification’ at a point where the home page describing the desired product information in this case is considered to be limited in a home page of the information provider.

1-25. Thus, the basic request information items are completely specified. Finally, in this case, ‘F’ is selected using the source system as a general-purpose personal computer. This option can be replaced with a code automatically delimiting the source system.

Step 2. Generating Request Information

2-1. At an instruction of the input box displayed on the page for generation of an information request home page, a buffer area for storage of the request information generated by sequentially inputting necessary items is set in the server, and the request information is temporarily stored therein (refer to FIG. 3).

2-2. When the extracting process is performed, the database for generation of information requested database is referred to, each information element is assigned a predetermined delimiter code described below and defined in a separate table, thereby delimiting the elements by delimiter codes (identifiers). The contents delimited by delimiter codes are recognized as predetermined request information.

2-3. A delimiter code can be a character not used or not prohibited in an available character set in the markup language of HTML or XML. In this case, ‘¶’ is used. However, the delimiter code can be changed depending on the development of the subsequent markup language.

2-4. Furthermore, a multifunction code which can be freely described in free text form by a user (information requester) other than an index code prescribed by a common database for each information element can be specified. A multifunction code is formed by a code other than a code whose use is not prescribed in advance in the HTML or XML code system, and by a free text and free numerals as shown in the following examples. (A) A free text description type can be from ‘¶α□□¶’ to ‘¶αn□¶’ (B) A free numeric description type can be from ‘¶η□□¶’ to ‘¶ηn□¶’.

(C) The abovementioned numerals and description text are written as ‘¶αn□¶ηn’ and the contents, that is, numerics and characters, are described in the area sectioned by ‘¶αn□¶□ηn¶’.

2-5. Other than the index codes prescribed in the common database for each information element, a product code, etc. predetermined by government and municipal offices of each country can be used depending on the ‘recognition code’ indicating which code system the corresponding code belongs to in this case.

A ‘recognition code’ is described, for example, as follows.

(A) A ‘delimiter code’ indicating a recognition code (ex: Σ to Σ);

(B) A ‘country code’ indicating a recognition code by country; and

(C) A ‘classification code’ indicating what kind of code system it is (ex: classification code indicating a JAN code)

2-6. Each retrieval item prescribed in the common database for each information element can be assigned a ‘repeated selection recognition code’=‘§’ so that a plurality of items can be simultaneously selected in the settings. Using the function, the information to be obtained can be simultaneously retrieved and selected on a plurality of conditions.

2-7. When all request information can be completely input, an ‘end’ code is input by a key indicating a termination mode, thereby calling a sort instruction command and rearranging the request information stored in the buffer area in the following order to improve the retrieval efficiency.

1) ‘request information base’

2) ‘request information statement’

3) ‘request information details’

4) ‘request information details—classification’

5) ‘request information details—fragmentation’

6) ‘request information details—fine classification’

7) ‘request information details—finest classification’

8) ‘request information base element’

9) ‘request information distribution element’

10) ‘specifying information request range’

11) ‘requested price’

12) ‘requested quantity’

13) ‘term of information request’

14) ‘distribution method’

15) ‘payment method’

16) ‘reply information specification’

17) ‘source system attribute display’

18) ‘attribute information about operation subject’=information requester attribute

2-8. Furthermore, the function of replacing a character string in the URL is invoked by the ‘rename instruction’, and a series of sorted request information stored in the buffer of the server is written to the directory of the completely input information request home page. Simultaneously, the URL including the URL information containing the request information is published over the Internet (refer to FIG. 3).

2-9. However, when an information requester does not have a WEB domain, a provider stating in advance that an information requested database is accepted or an organization accepting the corresponding service adds a code having request information to the lower order of a specific URL set for the service in advance, generates the URL including the URL information having request information, and publishes the URL over the Internet.

2-10. When the computer programs for generation of an information requested database are collectively downloaded, the request information generated in the offline batch process, the function of invoking the request information generated in the offline batch process to the computer program for generation of mail of the information requester is allowed, and a notification of accepting request information is transmitted to the mail address of the provider or the company of the corresponding service.

2-11. The provider receiving the request information transmitted by the electronic mail or the organization accepting the corresponding service adds a code having request information to the lower order of a specific URL set for the service in advance, generates the URL including the URL information having request information, and publishes the URL over the Internet.

2-12. In this case, the URL including the URL information having generated request information is generated as follows.

1) In the case of a user having a home page=WEB domain (In the case of a user having a WEB domain, a ‘/’ indicating a sub-index is added after the domain name of the information requester, and an identifier ‘□R□’ indicating an information requested database is added.)

<WEB domain>□□R□¶φD¶φ□F¶φ□foreign money deposit code¶φ□U.S. dollars code¶φ□foreign money (U.S. dollar) deposit product name¶φ□estimated yield of 5% or more code¶φ□guaranteed principal code¶ω□L¶ω□§B§A§¶α□free comment (ex. guaranteed principal)¶□A¶ω□one million yen¶ω□¶ω□YYMMDD¶ω¶ω¶ω□C ¶ωF¶χ□A¶χ□M¶χ□ age¶χ□occupation code¶χ□annual income¶χ□hobby code¶

2) When a user holds only a mail address, not a home page=WEB domain

□R□¶φ□D¶φ□F¶φ□foreign money deposit code¶φ□U.S. dollars codeåφ□ foreign money (U.S. dollar) deposit product name¶φ□estimated yield of 5% or more code¶φ□guaranteed principal code¶φ□L¶ω□§B§A§¶α□free comment (ex. guaranteed principal) ¶ω□Aω□one million yen¶ω□¶ω□YYMMDDåω□¶ω□¶ω□C¶ω□F¶χ□A¶χ□M¶□age¶χ□occupation code¶χ□annual income¶χ□hobby code¶

Step 3. Procedure of Comparing Request Information with Providing Information

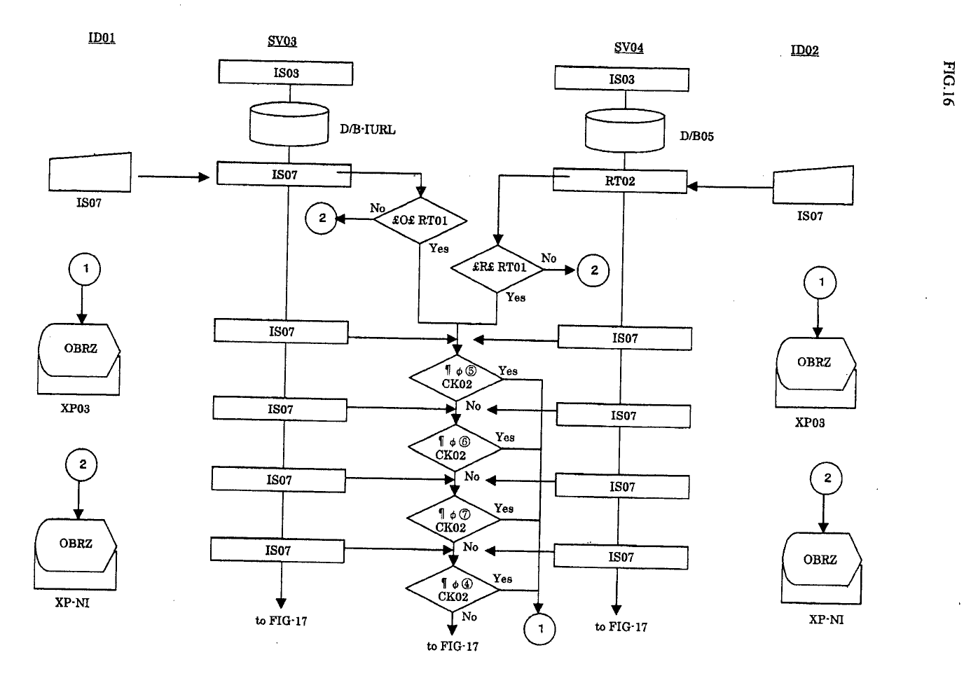

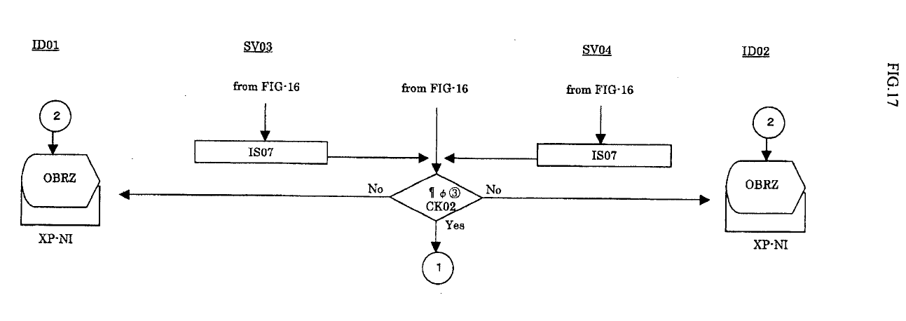

3-1. The request information published on the Internet is sequentially compared with the providing information generated in the same procedure as in the computer program for generation of an information requested database and shown in the step 4 as shown in the step 5, and the information providing home page matching the request information is displayed on the browser of the information requester. Otherwise, the URL list of the matching information providing home page is displayed on the information request home page. Otherwise, the URL of the information providing home page matching the request information is transmitted in electronic mail text to the mobile telephone of the information requester or an electric information appliance (refer to FIGS. 16 and 17).

Step 4. Generating Providing Information

4-1. The computer program for generation of an information providing database is invoked to the information device of the information provider through the Internet from the storage area of the server storing the computer program for generation of an information providing database, thereby running the computer program.

4-2. The computer program for generation of an information providing database comprises the functions of:

opening a dialog box in:

(A) information providing home page generation format;

(B) database for generation of an information providing database defined on a separate table; and

(C) information providing home page generation format such that a necessary item can be input or selected, and displaying a retrieval item list indicating the information elements in the database for generation of an information providing database;

(D) assigning an identifier to an input or selected item by referring to the database for generation of an information providing database, generating it as providing information, and instructing the providing information generated to be stored on the server side;

(E) sorting the generated providing information;

(F) assigning an identifier to the generated providing information;

(G) replacing the completely input URL of the information providing home page with the URL to which the URL information about the sorted and identifier added providing information is added;

(H) publishing the URL to which URL information is added on the Internet, retrieving the URL including the information indicating the corresponding information requested database using an identifier as a key, checking the internal request information, directly displaying the matching information request home page on the browser of the information provider, or displaying the URL of the request information on the information providing home page; and

(I) entering the linked-to URL to the page on which the providing information determined on the information providing homepage is described, jumping control to the linked-to address, and allowing the information requester to view the providing information description page.

Described below will be the functions of the computer program for generation of the information providing database determined for each item.

4-3. The information provider calls the page for generation of an information providing home page on the browser of the information device. The dialog box is opened in the order of the item selection displayed on the page. From the list of the items displayed on the dialog box (hereinafter referred to as an input box), predetermined items are input or selected.

4-4. The input or selected information code is generated as providing information in the procedure described below according to the procedure same as that of ‘generating an information request page’ shown in the procedure 1.

4-5. An information provider sequentially inputs a predetermined information providing item by selecting an option displayed on the screen while referring to the database for generation of an information providing database stored in the server according to the instruction of the input box. Items not to be input are not input and control is passed to the subsequent items.

4-6. However, the functions defined in the computer program for generation of an information providing database, the database for generation of an information providing database contained therein, and (A) to (I) of the above mentioned 2 can be collectively downloaded to the information device of the information provider, and the information provider can perform offline the operation of generating a URL of the providing information to which an identifier is assigned.

4-7. The calling of the database item, the procedure of displaying the input box, and the selecting operation by an information provider are repeatedly performed until the providing information generating operation is completed as described below in and after the following procedure 4-9.

4-8. The input page on which providing information has been selected is stored as an ‘information providing home page’ in file form as is. However, the directory of the page is replaced with the URL providing information character string after the providing information is sorted and an identifier is added.

4-9. In this case, the providing information generation procedure is described as follows.

4-10. In this case, since the ‘attribute of the information provider’ is an organization providing a financial product, a ‘business corporation’ is specified. The computer program for generation of an information providing database refers to an information provider attribute database, and extracts a corresponding code ‘o’.

4-11. Furthermore, the detailed item of the attribute of an information provider is input. At an instruction of an input box, ‘characteristic of organization and corporation’, ‘purpose’, and ‘scale’ are sequentially selected from the attribute database, and a corresponding code is extracted. 4-12. The ‘characteristic’ of the corporation, ‘purpose’, and ‘other remarks’ can also be described in free text. In this area, the PR etc. of the corresponding corporation can be input (the method of inputting free text is described in the procedure 1-2 above).

4-13. Then, at an instruction of the input box displayed on the computer program for generation of an information providing database, the ‘providing information base’ is input. First, the service and information title provided in free text are input (the title can be automatically extracted from the following providing information element).

4-14. Then, the practical contents of the ‘providing information’ are selected and represented by codes. However, in this case, the computer program for generation of an information providing database refers to the database for generation of an information providing database, and extracts a code ‘D’ of ‘money’ which is the corresponding element.

4-15. Furthermore, at an instruction of the input box displayed on the computer program for generation of an information providing database, items are sequentially input in the order of ‘providing information statement’, ‘details’, ‘classification’, ‘fragmentation’, ‘fine classification’, and ‘finest classification’.

4-16. In this case, since a target company is considered to provide various financial products and financial information in addition to foreign money products, the items corresponding to ‘details’ and ‘classification’ are selected and input for each home page.

4-17. In the ‘providing information statement’, the ‘by financial product’ information is selected, and an ‘F’ code is extracted.

4-18. In ‘details’, ‘foreign money deposit’ is indicated. In ‘classification’, the classification of the products such as ‘in U.S. dollars’, ‘in Euro’, etc. is indicated.

4-19. In the ‘fragmentation’, an actual ‘product name’ is selected, and in the ‘fine classification’ database in the lower hierarchical order, the ‘estimated yield’ information is selected. From the ‘finest classification’ database in the further lower hierarchical order, an option of ‘guaranteed safety’ is specified.

4-20. Furthermore, in free text, the summary of the provided information is described. Otherwise, the home page address at which the corresponding product is described can be displayed.

4-21. Then, at an instruction of the input box displayed on the computer program for generation of an information providing database, ‘providing information basic style’ is selected. In this case, since a corresponding financial product information is transmitted free of charge, the computer program for generation of an information providing database refers to the providing information base element database, and extracts the code ‘L’ corresponding to the request of ‘request to know free of charge’.

4-22. Then, at an instruction of the input box displayed on the computer program for generation of an information providing database, ‘providing information reception style’ is input. In this case, since it is natural that a pamphlet etc. of a corresponding product is transmitted, the computer program for generation of an information providing database refers to a reception and configuration database of providing information, and extracts a code ‘B’ corresponding to ‘the information will be sent to you’.

4-23. The information provider performs ‘specification of providing information range’. In this example, the providing product of ‘limited to Japan’ is selected.

4-24. The information provider inputs the price of the information to be continuously provided. In this case, the price such as the ‘lowest purchase unit price is one million yen’ is provided.

4-25. The information provider can specify ‘providing quantity’, ‘term of order’, ‘distribution method’, ‘payment method’, ‘delivery term’, ‘warranty deed responsibility’, etc. relating to the requested product, information, task, etc. after selecting any of them from the database.

4-26. In this case, it is not necessary to input ‘providing quantity’. The ‘term of order’ is determined by ‘YYMMDD’. The ‘distributionmethod’ is specified by ‘F’ of ‘transmission to the specified place’. The ‘payment method’ is specified by ‘B’ of ‘credit card’. The ‘delivery term’ is determined by ‘A’ of no term. The ‘warranty deed responsibility’ can be specified by selecting ‘A’ of ‘no guarantee’.

4-27. Next, when the information provider is assigned a rank by an external third party on the product provided by the information provider, the name of the evaluation authority and the evaluation value can be input.

4-28. Finally, the information provider can execute PR on own product using the user-defined area. The PR such as ‘prize-winningresult’, ‘discount privilege’, ‘campaign’, etc. can be executed.

4-29. At an instruction of the input box displayed on the computer program for generation of an information providing database, the providing information generated by sequentially inputting necessary items is rearranged to improve the retrieval efficiency in the following order.

1) ‘title of providing information’

2) ‘providing information base’

3) ‘providing information statement’

4) ‘providing information details’

5) ‘providing information details—classification’

6) ‘providing information details—fragmentation’

7) ‘providing information details—fine classification’

8) ‘providing information details—finest classification’

9) ‘summary of providing information’

10) ‘providing information basic style’

11) ‘providing information reception style’

12) ‘providing information range’

13) ‘providing price’

14) ‘providing quantity’

15) ‘term of order’

16) ‘distribution method’

17) ‘payment method’

18) ‘delivery term’

19) ‘warranty deed responsibility’

20) ‘ranking information’, ‘user-defined information’, etc.

As the 21st and subsequent items, ‘attribute of information provider’ etc. are listed.

4-30. In this case, the generated providing information is generated as follows.

<WEB domain>□□□O□¶α□title of providing information¶φ□D¶φ□F¶φ□foreign money deposit code¶φU.S. dollars code¶φ□foreign money (U.S. dollar) deposit product name¶φ□estimated yield of 5% or more code¶φ□guaranteed principal code¶α□summary ¶ω□L¶ω§B§A§□A¶ω□one million yen¶ω□¶ω□YYMMDD¶ω□¶ω□B¶ω□A¶ω□A¶ω□evaluation authority name code□evaluation point ¶ρ□campaign code¶χ□O¶χ□characteristic of corporation¶χ□purpose of corporation¶χ□scale of corporation, remarks¶χ□¶χ□¶

4-31. The providing information selected input page is stored as an ‘information providing home page’ in file form as is. However, the directory of the page is replaced with the providing information character string after sorting providing information and adding an identifier.

4-32. In the XML using environment, the computer program for generation of providing information has the function of searching the HTML-processed or XML-processed WEB (home page) of the generated home page, extracting a character string corresponding to providing information, and adding providing information. The process is performed in the following procedure.

(A) The source codes of WEB (home page) generated by the information provider are sequentially inspected, the database for generation of an information providing database is referred to, and the same character string as the item defined in each information element item of the database for generation of an information providing database, present on the source code is retrieved.

(B) In the XML using environment, the same character string can be extracted using a SELECT command used in extracting data.

(C) An extracted character string is enclosed by symbols ‘<’ and ‘>’ for identification of a tag, and an identifier shown in the database for generation of an information providing database as per attached sheet is added.

(D) The extracted character string is followed by ‘<’, ‘/’, and ‘>’ for identification of a tag, and the same identifier as that described above is added.

(E) The generated providing information with identifier is represented as follows.

<identifier>character string</identifier>

(F) The character string to which an identifier is added in the procedure from (A) to (D) is replaced with the extracted character string of the source code.

Step 5. Relating to Process of Matching Request Information with Providing Information

5-1. As described above, in the request information system and providing information system which are code systems for the information about all products, services, tasks, etc. processed on the Internet, a detailed level (=‘finest classification’), ‘information interchanging style’ (=‘request information basic style’ and ‘providing information basic style’), and ‘information request range/providing range’ through ‘requested price/providing price’ all correspond one to one to each other up to the hierarchical level defined by an identifier, thereby realizing a quick matching process.

5-2. As described above, in the system according to the first invention, the setting item has the function of a ‘retriever’. Furthermore, since each information element is assigned a hierarchical order by an identifier having the function of an order (that is, □ □, or □, etc.) determining the hierarchy, the request information and the providing information having equal hierarchical levels can be compared.

5-3. In the retrieval program in the system according to the first invention, the information request determines a protocol such that the providing information can be detected when the providing information having an identifier ‘□o□’ appears on the network. The information provider determines a protocol such that the request information can be detected when the request information having an identifier ‘□R□’ appears on the network.

5-4. Furthermore, when request information is generated, the character strings in the URL of the providing information having the identifier ‘□o□’ are searched, a character string in the URL of the providing information having the same identifier as the above mentioned identifier is extracted using an identifier as a retrieval key, and the character string is compared with the request information (refer to FIG. 16).

5-5. When providing information is generated, the character strings in the URL of the request information having the identifier ‘□R□’ are searched, a character string in the URL of the request information having the same identifier as the above mentioned identifier is extracted using an identifier as a key, and the character string is compared with the providing information (refer to FIG. 16).

5-6. The priority of the matching process in the above-mentioned procedures 5-4 and 5-5 is determined as follows.

5-7. First, when a practical product and service name shown in ‘φ□’ are described, they are retrieved by the highest priority.

5-8. In the system according to the first invention, since the code systems of the information request and the information providing correspond one to one for the information about products, services, and tasks, etc., setting or inputting a practical product name or service name in the ‘fragmentation’ can realize quick retrieval without inputting other classification items.

5-9. When the information does not match each other in the above mentioned procedures 5-7, the comparison of the code systems φ□→φ□→φ□→φ□ for the information about the products, services, tasks, etc. distributed on the Internet is performed by the highest priority, and the information providing home page having matching information is displayed on the browser of the information requester.

5-10. Otherwise, a list of URL of the information providing home page having matching information is displayed on the information request home page after preparing a display area.

5-11. For the information provider, the information request home page corresponding to the providing information is displayed on the browser of the information requester.

5-12. On the other hand, if no matching information page can be detected after the comparison up to φ□, then the message ‘no corresponding information’ is displayed.

5-13. If matching information can be detected during the comparison in the abovementioned 5-9, then ‘request information basic element’ (request information) represented by ω□ is retrieved and compared with ‘providing information base style’ (providing information) for selection of target information.

5-14. Then, ‘information distribution style’ represented by ω□ is checked.

5-15. The subsequent selecting and retrieving priorities are ‘request range’ ω□→‘requested price’ω□→‘requested quantity’ω□.

5-16. In any case of the above mentioned procedures 5-15, 5-16, and 5-17, when the request information and the providing information match, or when non-matching is detected, it is displayed on the browsers of the information requester and the information provider.

5-17. If a plurality of corresponding targets are selected in the retrieving process, the information requester has the function of specifying the display orders in order from the ‘earliest’, the ‘least expensive’, etc.

5-18. In the XML using environment, the character string replaced by assigning an identifier as described above in 4-32 of the procedure 4 is used as a tag having the function of a retrieval key, the identifier is specified as an attribute name using a command for use in extracting in the XML, and the WEB having the same identifier as the request information is directly called and displayed on the browser.

5-19. Also in the XML environment, the retrieval order is φ□→φ□→φ□→φ□ as indicated in the procedures 5-3 to 5-17 starting from the retrieval of the identifiers indicating the practical product and service names represented in φ□.

5-20. Since the entire system according to the first invention of the present patent application has the structure of an information element database in MATRIX form, a change in retrieval condition easily corresponds to an arrow cursor. That is, a less severe condition corresponds to a ‘↑’ cursor, and narrowing a condition corresponds to a ‘↓’ cursor. The information about less expensive items corresponds to a ‘←’ cursor. The information about earlier items corresponds to a ‘→’ cursor.

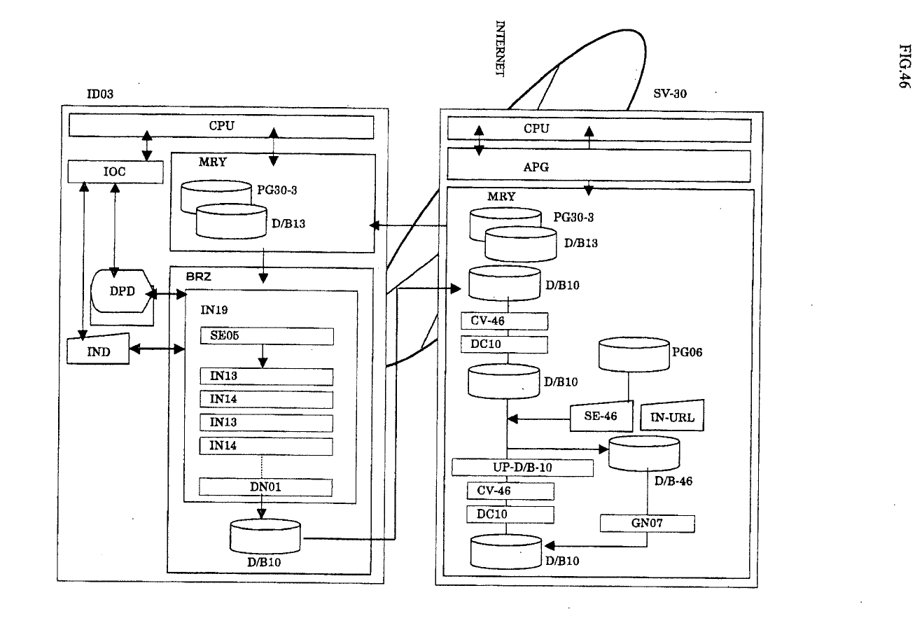

FIG. 46 shows a link information automatic generation system using the information record and requested database according to an embodiment of the first invention.

Using the system according to the first invention, and the link information automatic generation system with the information record and requested database, the information record and requested database is HTML-converted and described on the WEB, the product name provided by the information provider recorded in the information record and requested database is automatically linked with the home page of the information provider for providing the corresponding information, and the home page describing the product requested by the information requester can be accessed.

Since the link information is stored in the WEB link database, the link information can automatically be generated again using the system according to the first invention although the information record and requested database is updated.

Embodiment 2 of the Invention

The embodiments of a second invention will be described below in detail by referring to the attached drawings.

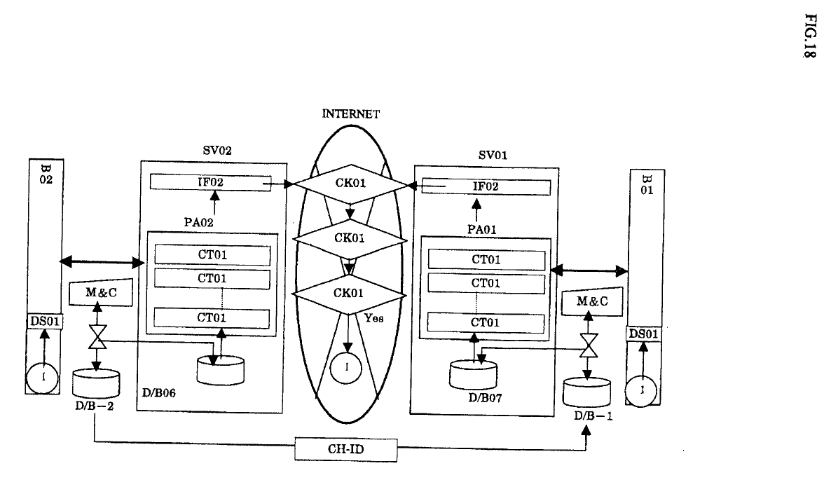

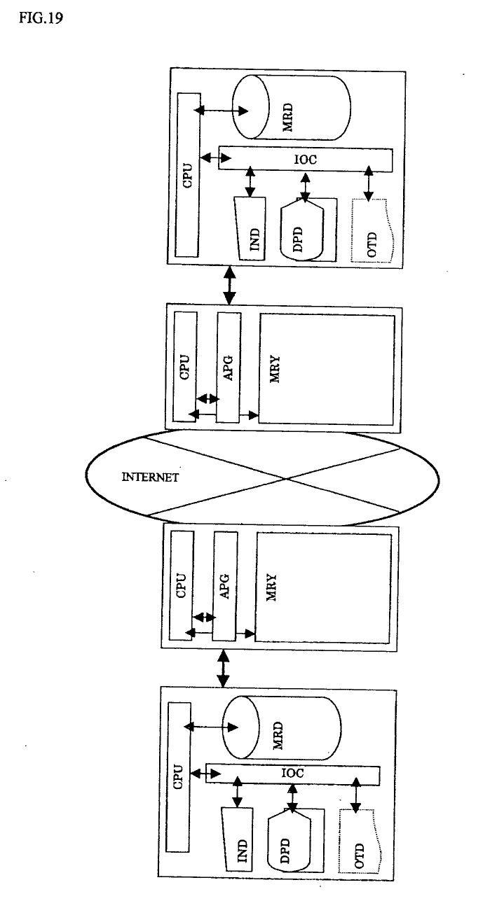

FIG. 18 shows the outline of the system of generating an information providing database and an information requested database according to an embodiment of the second invention. FIG. 19 shows the configuration of the hardware of the generation system of an information providing database and an information requested database according to an embodiment of the second invention.

In a sample case, a shopping mall sets a process of presenting an information providing database and a process of retrieving a product, and methods of generating and retrieving an information providing database and an information requested database are used.

Step 1. Generating an Information Providing Database

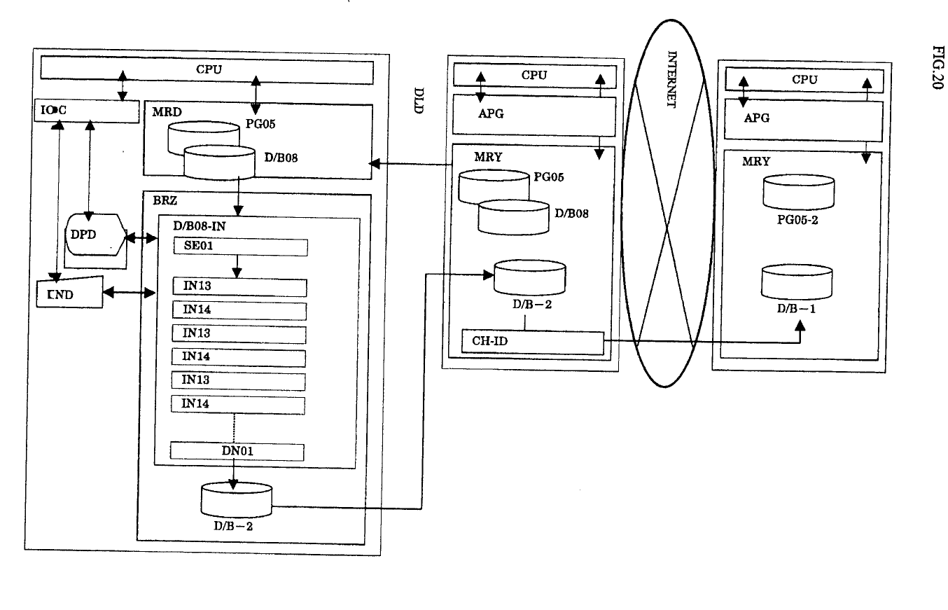

1-1. FIG. 20 shows a generation system for information requested database used when the information providing database is generated and amended according to an embodiment of the second invention. At least one information providing server computer 2 declared as corresponding to the generation system for the information providing and information requested database according to the second invention is connected to the Internet 1, and at least one information request server computer 3 declared as corresponding to the generation system for the information providing and information requested database according to the second invention is connected to the Internet 1. An information device 4 of the information provider or a user computer of the information provider is connected to the Internet 1.

The information providing server computer 2 comprises a main control unit 21, a drive program storage unit 22, and a storage area unit 23. The storage area unit 23 stores a computer program for generation of an information providing database, a database for generation of an information providing database, and an information providing database.

Similarly, the information request server computer 3 comprises a main control unit 31, a drive program storage unit 32, and a storage area unit 33. The storage area unit 33 stores a computer program for generation of an information requested database. When the procedure 1-12 is completed, the information requested database is stored in the storage area unit 33.

On the other hand, the information device 4 of the information provider comprises a main control unit 41, a storage area unit 42, an input/output control unit 44, an output device 45, and an input device 46.

The information device 4 of the information provider downloads the computer program for generation of an information providing database and the database for generation of an information providing database to the storage area unit 42 from the information providing server computer 2 through the Internet, drives the computer program for generation of an information providing database, and opens a page for generation of the information providing database on a browser 43.

1-2. The computer program for generation of an information providing database has:

(A) the format for generation of an information providing database included in the database for generation of an information providing database;

(B) the function of opening a dialog box for input of necessary number of items in the format for generation of an information providing database;

(C) the function of displaying all columns into which providing information is to be input in table form comprising rows and columns depending on the number of items of input providing information;

(D) the function of generating priority information for retrieval and check on the corresponding items as identifiers;

(E) the function of inputting and storing an information item name to be provided for each column by item;

(F) the function of displaying a column of the providing information item in which a plurality of selection items can be recorded on the display device, recording and storing plural pieces of providing information as options for the corresponding item, generating and storing the code information for retrieval and check of the input providing information;

(G) the function of freely adding and deleting as necessary the column in which an information item name and providing information name are input;

(H) the function of storing a generated information providing database on the server side; and

(I) the function of replacing the code information after generation with a URL.

1-3. Described below will be the generation of an information providing database determined in each of the items above. In this example, a shopping mall generates an information providing database with the settings of a bargain sale to common consumers.

1-4. Generating an information providing database starts with settings of the number of items. In this example, the number of items of providing information is 12. The number of columns in which information names are input is initially 18 because they can be freely added or deleted at a generation stage.

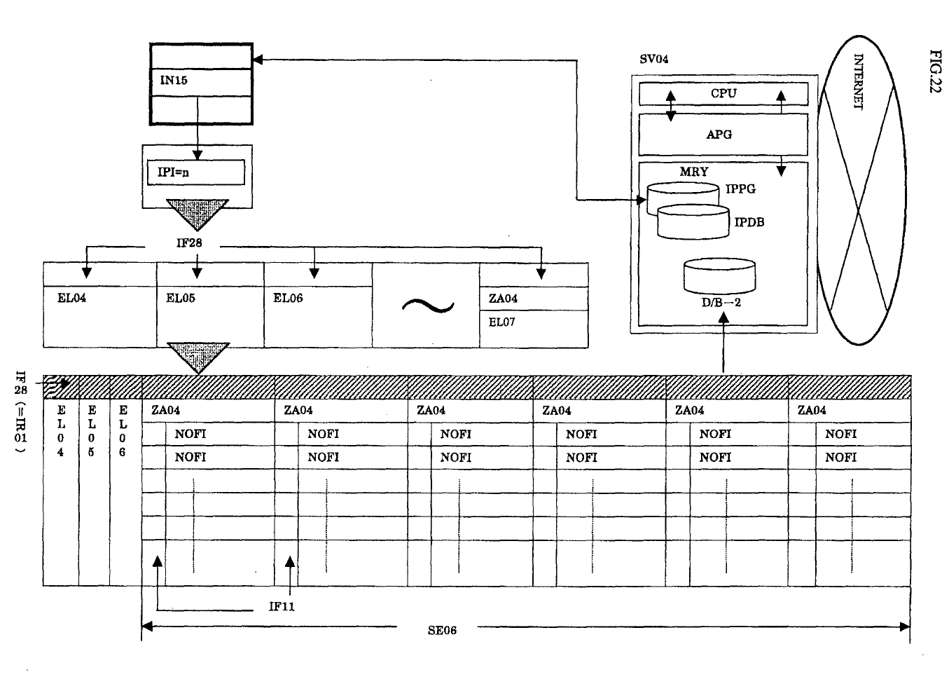

1-5. FIG. 22 shows a generation process of the information providing database according to an embodiment of the second invention. By setting the number of items, all columns in which providing information is input are displayed on the display device in table form, or a dialog box for prompting input is displayed, necessary information names are sequentially input, and an information providing database is formed. Otherwise, after specifying the information having hierarchical correlation, necessary information names are sequentially input, and an information providing database is generated.

1-6. The information item of the information providing database is defined by the following identifiers indicating the characteristic and structure of the information providing database.

(A) An identifier of the correspondence to the information retrieving method determined in the present patent.

(B) An identifier of an information providing subject: In this case, the identifier refers to the information providing database provided by the ‘∘∘∘shopping mall’.

(C) An identifier of an information providing database corresponding to the information retrieving method defined in the present patent.

(D) An identifier added to each item of providing information which is an item to be retrieved.

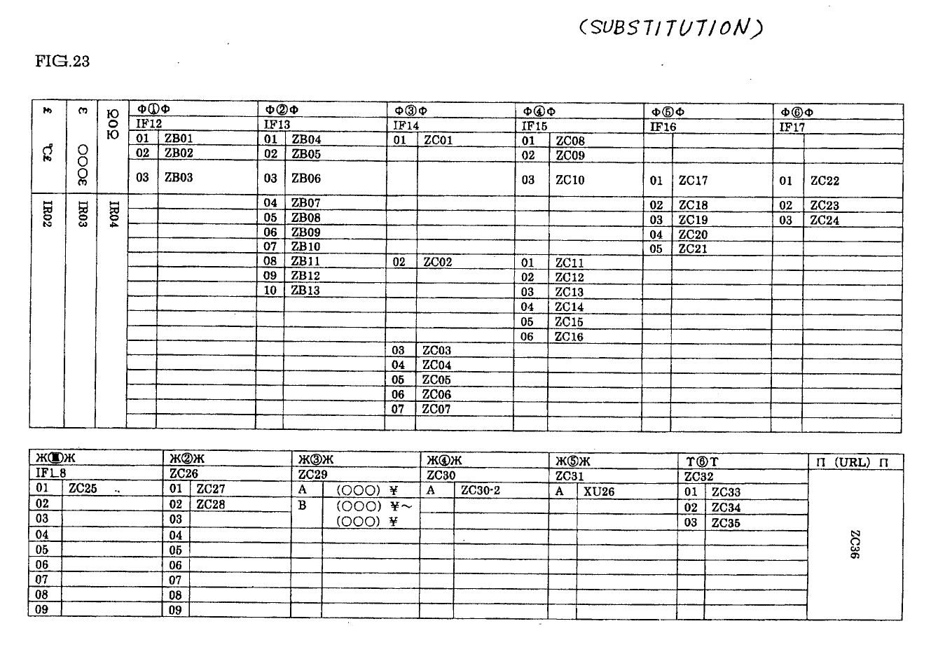

1-7. FIG. 23 shows the details of the information providing database according to an embodiment of the second invention. As shown in FIG. 22, the generator of an information providing database freely sets an item to be prioritized in retrieval and matching among the information items to which identifiers are assigned.

1-8. As shown in FIG. 23, an information name arbitrarily provided by an information provider is entered in the column of an information name according to the function defined in the above mentioned procedure 1-2.

1-9. The code information for retrieval and matching corresponding one to one to the entered information is assigned to each piece of input information. The code can be automatically assigned or arbitrarily set by the information provider.

1-10. At the end of the information providing database, a column in which the URL or a mail address of the information provider who provides the record information is provided, thereby:

(A) immediately calling and opening a home page containing the information when the information requested by the information requester matches the providing information; and

(B) immediately transmitting a matching result to the home page of the information provider or mail address regardless of whether or not the information requested by the information requester matches the providing information.

1-11. In this case, the information provider generates the information to be provided in the following procedure as the information providing database (refer to FIG. 23).

(A) First, since the information indicating the database generator which is a providing subject is the ∘∘∘ shopping mall, ‘∘∘∘’ is input.

(B) Into the providing information class 1, the titles of the information to be retrieved, that is, ‘the ∘-th sales’, ‘□-th sales’, and ‘□-th sales’ are input.

(C) Into the providing information class 2, the type of information to be provided, that is, ‘notions’, ‘foods’, ‘clothing’, ‘furniture’, etc. are input.

(D) An example generated when the ‘foods’ is input is shown below. When other items in the providing information class 2 are entered, control is returned to the items in providing information class 2, and lower order information is input.

(E) Into the providing information class 3, the contents of the information to be provided, that is, ‘fresh foods’, ‘cake and other sweet’, ‘canned and bottled foods’, etc. are input. As shown in the example, when detailed product information such as cake and other sweet is input, control is returned again to the providing information class 3, and lower order information is input.

(F) From the providing information class 4, the lower order information of the ‘fresh foods’, that is, ‘meat’, ‘fish’, ‘vegetables’, etc. are input.

(G) From the providing information class 5, the lower order information of the ‘vegetables’, that is, ‘radish’, ‘carrot’, ‘cabbage’, ‘Chinese cabbage’, ‘spinach’, etc. are input.

(H) Into the providing information fine class 6, the ‘from ∘∘∘’, ‘gathered this morning’, ‘without agrochemical’, etc. indicating the details of the information to be provided are input.

(I) In the providing information basic style, ‘sold out’ indicating the information providing style is input.

(J) In the providing information reception style, ‘cash’ and ‘specified card’ indicating the reception style of information are input.

(K) The ‘requested price’ is set such that the value of the providing information can be directly input in half-width numerics.

(L) The ‘requested quantity’ is set such that the quantity of the providing information can be directly input in half-width numerics.

(M) The valid term is set such that the valid term of the information to be provided can be input. In the present example, it is set up to DD, that is, ‘day’, but can be set with the designation of time in minute.

1-12. When all inputting operations are completed, the generated information providing database is stored in the storage area unit 23 of the information providing server 2 through the Internet 1.

Step 2. Generating a Retrieval Checking Information Providing Database

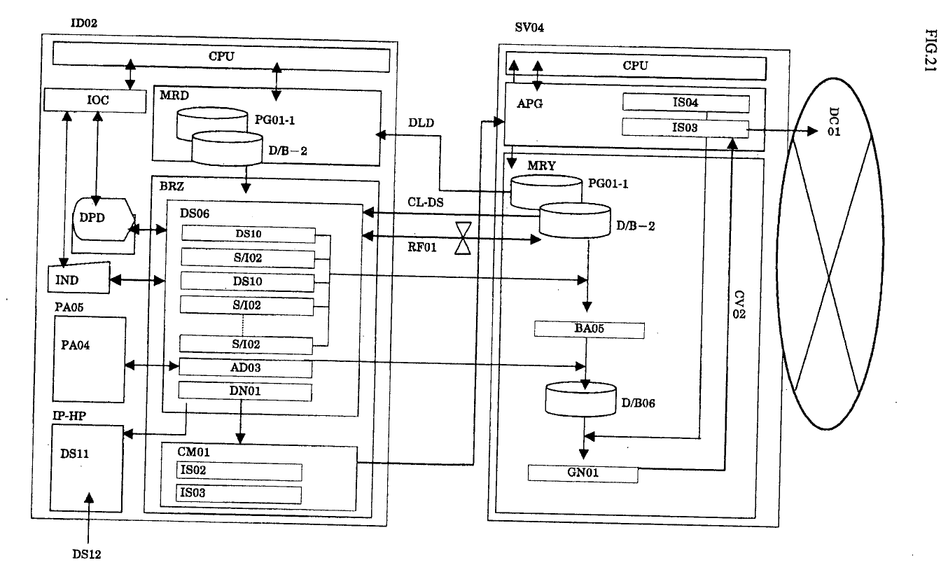

2-1. FIG. 21 shows the system of generating a retrieval checking information providing database according to an embodiment of the second invention. At least one server computer 5 declared to correspond to a generation system for the information providing and information requested databases according to the second invention is connected to the Internet 1. Also, the information device 4 of the information provider or the user computer of the information provider is connected to the Internet 1.

The server computer 5 comprises a main control unit 51, a drive program storage unit 52, and a storage area unit 53. The storage area unit 53 stores a computer program for generation of a retrieval checking information providing database and an information providing database.

The information device 4 of the information provider downloads and calls on the browser the computer program for generation of a retrieval checking information providing database and the generated information providing database from the storage area of the server computer 5 through the Internet, and generates the retrieval checking information providing database according to the following procedure.

(A) calling the generated information providing database;

(B) displaying providing information items and a plurality of options corresponding thereto on the display device, and promoting the information provider to select and input one or more options from among a plurality of options as a response to the corresponding items;

(C) generating and storing an identifier and a code indicating the priority information for retrieval and check on the selected and input options and corresponding items;

(D) sequentially repeating the procedures (B) and (C) on all necessary items of the providing information;

(E) adding the information about the address at which the information corresponding to the retrieval checking information providing database is stored and generating a retrieval checking information providing database when all information selection and input are completed;

(F) storing the generated information providing database in the storage area of the server computer;

(G) replacing the generated code information with a URL; and

(H) publishing the replaced URL on the Internet, retrieving the URL of the corresponding retrieval checking information requested database using an identifier as a key, checking the internal code, displaying the applied information about an information requester on the providing information description home page of the information provider or the URL of the code generated by the retrieval checking information database on the providing information description home page.

2-2. A generator of the retrieval checking information providing database calls a target information providing database on the browser of the information device. A dialog box is opened in the selection order of the indicated items, and a necessary item is input or selected from the list of selected items displayed on the dialog box (hereinafter referred to as an input box).

2-3. At an instruction from the input box, the information provider refers to the information providing database, and sequentially selects or inputs necessary providing information by performing an operation of selecting an option displayed on the screen. The information not to be selected or input can be passed to the subsequent items without input.

2-4. However, the retrieval checking information providing database generating function and the function defined in the above mentioned (A) to (H) can be collectively downloaded to the information device of the information provider, and the information provider can generate the retrieval checking information providing database offline.

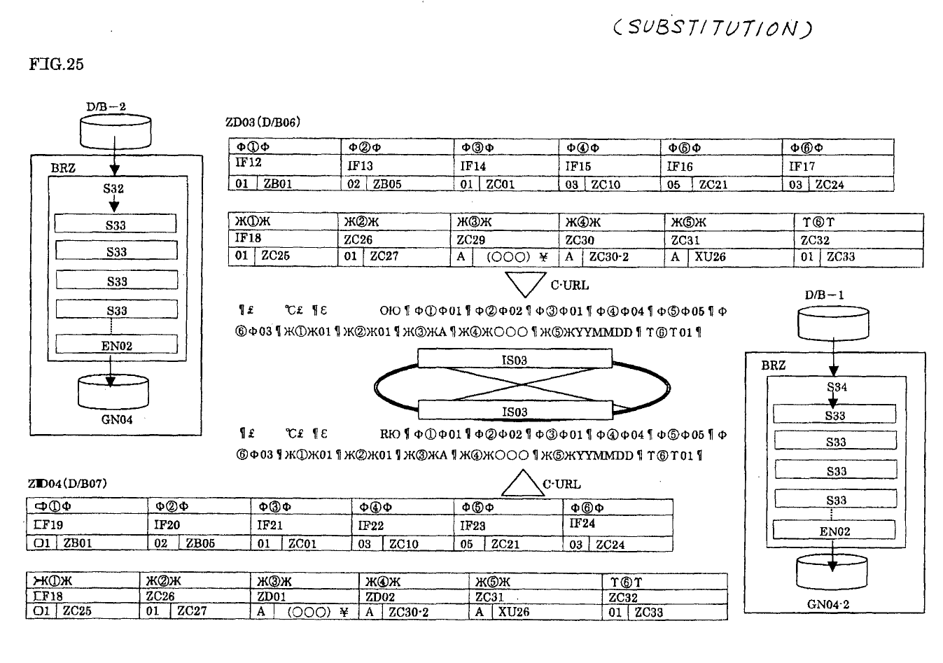

2-5. In this case, the information provider generates the information to be provided in the following procedure as a retrieval checking information providing database. FIG. 25 shows the process of generating a retrieval checking information providing database and a retrieval checking information requested database according to an embodiment of the second invention.

(A) calling a generated information providing database provided by the ∘∘∘ shopping mall;

(B) specifying ‘∘-th sales’ which is the sales title for the time being from the providing information class 1;

(C) automatically selecting the corresponding code ‘01’;

(D) selecting the type of information to be provided, that is, ‘foods’ from the providing information class 2;

(E) automatically selecting the corresponding code ‘02’;

(F) selecting the contents of the information to be provided, that is, ‘fresh foods’ from the providing information class 3;

(G) automatically selecting the corresponding code ‘01’;

(H) selecting ‘vegetables’ which is the product name of the information to be provided from the providing information class 4;

(I) automatically selecting the corresponding code ‘03 ’;

(J) selecting the product name of the information to be provided, that is, ‘spinach’, from the providing information class 5;

(K) automatically selecting the corresponding code ‘05’;

(L) selecting ‘no agrochemical’ indicating the characteristic of the information to be provided from the providing information class 6;

(M) automatically selecting the corresponding code ‘03’;

(N) selecting ‘sold out’ indicating the providing style of the information from the providing information basic style;

(O) automatically selecting the corresponding code ‘01’;

(P) selecting ‘cash’ indicating the reception style of the information from the providing information reception style;

(Q) automatically selecting the corresponding code ‘01’;

(R) directly inputting the value of providing information into the requested price in half-width numerics;

(S) automatically selecting the corresponding code ‘∘∘∘’;

(T) directly inputting the quantity of providing information into the requested quantity in half-width numerics;

(U) automatically selecting the corresponding code ‘∘∘∘’; and

(V) inputting a valid term of the information to be provided to ‘valid term’.

(W) automatically selecting the corresponding code ‘YYMMDD’. In the present example, it is set up to DD, that is, ‘day’, but can be set with the designation of time (for example, HHMM, that is, hour and minute) if specified in the information providing database.

(X) Furthermore, when plural pieces of information are specified from the same item, a plurality of items can be simultaneously selected and set by adding a ‘repeated selection recognition code’=‘§’. Using the function, requested information can be simultaneously retrieved and selected on a plurality of conditions.

2-6. When the selection is completed, the selected information is classified for each information item using an identifier as a delimiter code ‘å’ for each determination, or using a character not used or not prohibited in the HTML or XML markup language as a delimiter code, replaced with a URL code, and published on the Internet. However, the delimiter code depends on the future development of the international standard of the markup language.

In this case, the retrieval checking information providing database code replaced with the URL is represented as follows.

¶?□?¶?∘∘∘?¶ [symbol] 0 [symbol] ¶Φ□Φ01¶Φ□Φ02¶Φ□Φ01¶Φ□Φ04¶Φ□05Φ¶□Φ03¶ [symbol] □ [symbol] 01¶ [symbol] □ [symbol] 01¶ [symbol] □ [symbol] A¶ [symbol] □ [symbol] ∘∘∘¶

[symbol] □ [symbol] YYMMDD□¶Υ□Υ01¶Π (URL except http://www portion)Π

2-7. The input page on which the retrieval checking information providing database has been selected can be stored as a ‘providing information description home page’ in file form as is.

Step 3. Generating an Information Requested Database and a Retrieval Checking Information Requested Database

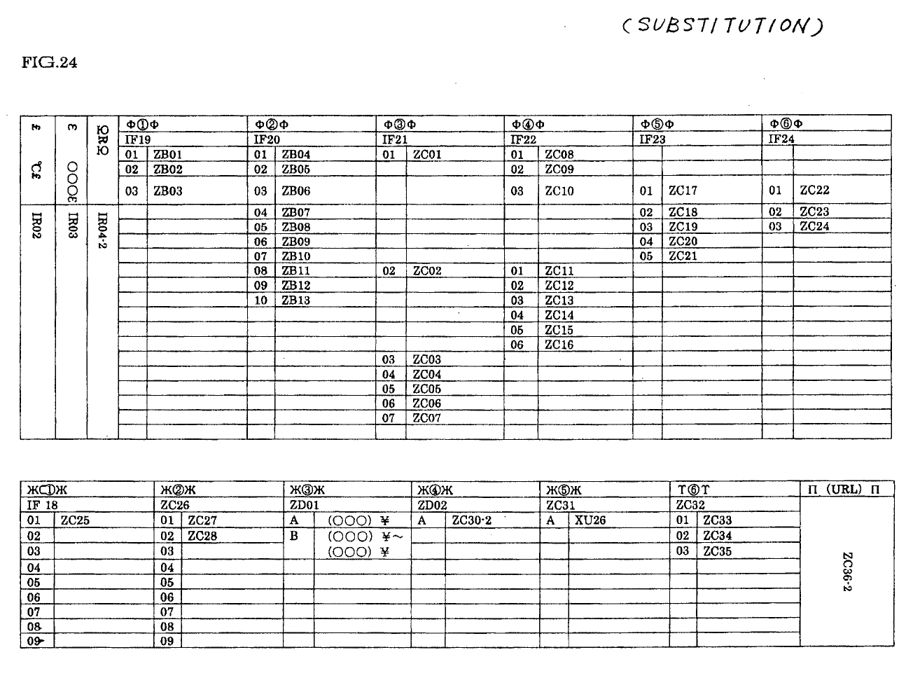

3-1. FIG. 24 shows the details of the information requested database according to an embodiment of the second invention. When an information providing database is generated or an information providing database is updated, the information for retrieval and check added to the third information element indicating the information providing database in the information providing databases generated in the above mentioned procedure 1 is replaced with the information for retrieval and check indicating the information requested database, and stored in the storage device of the computer in the position referred to by the information providing database, thereby generating an information requested database.

3-2. The information requester calls the information requested database on the request information description home page from the storage area of the server computer through the Internet using the computer program for generation of a retrieval checking information requested database and the above-mentioned procedure 3-1, and generates the retrieval checking information requested database in the procedure described below.

(A) calling the generated information requested database;

(B) displaying request information items and a plurality of options corresponding thereto on the display device, and prompting an information requester to select and input one or more options from among a plurality of options as a response to the corresponding items;

(C) generating and storing an identifier and a code indicating the priority information for retrieval and check on the selected and input options and corresponding items;

(D) sequentially repeating the procedures (B) and (C) on all necessary items of the request information, and generating a retrieval checking information requested database when all information selection and input are completed;

(E) downloading and storing the generated retrieval checking information requested database in the storage area of the server computer;

(F) replacing the generated code information with a URL; and

(G) publishing the replaced URL on the Internet, retrieving the URL of the corresponding retrieval checking information providing database using an identifier, checking the internal code, displaying the applied information about an information provider on the request information description home page or the URL of the code generated by the retrieval checking information database on the request information description home page.

FIG. 25 shows the system of generating a retrieval checking information providing database.

3-3. The retrieval checking information requested database generator calls a target information requested database on the request information description home page displayed on the information device of the information requester, opens a dial box (hereinafter referred to as an input box) in the order of the displayed item selection, and inputs or selects a necessary item from a list of items to be selected and displayed on the dial box.

3-4. At an instruction from the input box, the information requester refers to the information requested database, and sequentially selects or inputs necessary request information items by performing an operation of selecting an option displayed on the screen. The information not to be selected or input can be passing to the subsequent items without input.

3-5. However, the retrieval checking information requested database generating facility and the facility defined in the abovementioned procedures (A) to (G) of 3-2 can be collectively downloaded to the information device of the information requester, and the information requester can generate the retrieval checking information requested database offline.

3-6. In this case, as shown in FIG. 25, the information requester generates the request information in the following procedure as a retrieval checking information requested database.

(A) calling an information providing database provided by the ∘∘∘ shopping mall;

(B) specifying ‘∘-th sales’ which is the sales tile for the time being from the request information class 1;

(C) automatically selecting the corresponding code ‘01’;

(D) selecting the type of information to be requested, that is, ‘foods’ from the request information class 2;

(E) automatically selecting the corresponding code ‘02’;

(F) selecting the contents of the information to be requested, that is, ‘fresh foods’ from the request information class 3;

(G) automatically selecting the corresponding code ‘01’;

(H) selecting ‘vegetables’ which is the product name of the information to be requested from the request information class 4;

(I) automatically selecting the corresponding code ‘03’;

(J) selecting the product name of the request information, that is, ‘spinach’, from the request information class 5;

(K) automatically selecting the corresponding code ‘05’;

(L) selecting ‘no agrochemical’ indicating the characteristic of the request information from the request information class 6;

(M) automatically selecting the corresponding code ‘03’;

(N) selecting ‘sold out’ indicating the request style of the information from the request information basic style;

(O) automatically selecting the corresponding code ‘01’;

(P) selecting ‘cash’ indicating the reception style of the information from the request information reception style;

(Q) automatically selecting the corresponding code ‘01’;

(R) directly inputting the value of request information into the requested price in half-width numerics;

(S) automatically selecting the corresponding code ‘∘∘∘’;

(T) directly inputting the quantity of request information into the requested quantity in half-width numerics;

(U) selecting the corresponding code ‘∘∘∘’; and

(V) inputting a valid term of the request information to ‘valid term’.

(W) The corresponding code ‘YYMMDD’ is automatically selected. In this example, up to DD, that is, ‘day’ is specified, but up to the time can be specified in the information requested database.

(X) Furthermore, when plural pieces of information are specified from the same item, a plurality of items can be simultaneously selected and set by adding a ‘repeated selection recognition code’=‘§’. Using the function, requested information can be simultaneously retrieved and selected on a plurality of conditions.

3-7. When the selection is completed, the selected information is classified for each information item using an identifier as a delimiter code ‘¶’ for each determination, or using a character not used or prohibited in the HTML or XML markup language as a delimiter code, replaced with a URL code, and published on the Internet. However, the delimiter code depends of the future development of the markup language.

3-8. In this case, the retrieval checking information requested database code replaced with the URL is represented as follows.

¶?□?¶?∘∘∘¶ [symbol] R [symbol] ¶Φ□Φ01¶Φ□Φ02¶Φ□Φ01¶Φ□Φ04¶Φ□Φ05¶Φ□Φ03¶ [symbol] □ [symbol] 01¶ [symbol] □ [symbol] 01¶ [symbol] □ [symbol] A¶ [symbol] □ [symbol] ∘∘∘¶ [symbol] □ [symbol] YYDDMM□¶Υ□Υ01¶

3-9. The input page on which the retrieval checking information requested database has been selected can be stored as a ‘request information description home page’ in file form as is.

Step 4. Procedure of Checking and Retransmission Request of a Retrieval Checking Information Providing Database and a Retrieval Checking Information Requested Database

4-1. The retrieval checking information providing database published over the Internet and after URL-converted is compared with the retrieval checking information requested database published over the Internet and after URL-converted in the following procedure, and the information satisfying the request is displayed on the browser of the information provider and the information requester, or the URL list of the home page describing the matching providing information or the home page of the information requester is displayed on the browsers of the information provider and the information requester. Otherwise, the URL of the home page describing the providing information matching the request is returned to the information requester by MAIL text.

4-2. The retrieving program in the system according to the second invention determines the protocol such that when the retrieval checking information providing database and the retrieval checking information requested database having the identifier ‘□□□’ appears on the network, they can be detected. 4-3. In the case of generating a retrieval checking information providing database, the character string in the URL of the retrieval checking information requested database code having the information delimited by an identifier indicating a target information providing subject and having an identifier ‘ [symbol] R [symbol] ’ is retrieved, the character string in the URL of the retrieval checking information requested database code having the same identifier as the identifier as a retrieval key is extracted, and compared with the current code.

4-4. In the case of generating a retrieval checking information requested database, the character string in the URL of the retrieval checking information providing database having the information delimited by an identifier indicating a target information providing subject and having an identifier ‘ [symbol] R [symbol] ’ is retrieved, the character string in the URL of the retrieval checking information providing database having the same identifier as the identifier as a retrieval key is extracted, and compared with the current code.

4-5. The priority in the matching process in the above-mentioned procedures 4-3 and 4-4 is described below.

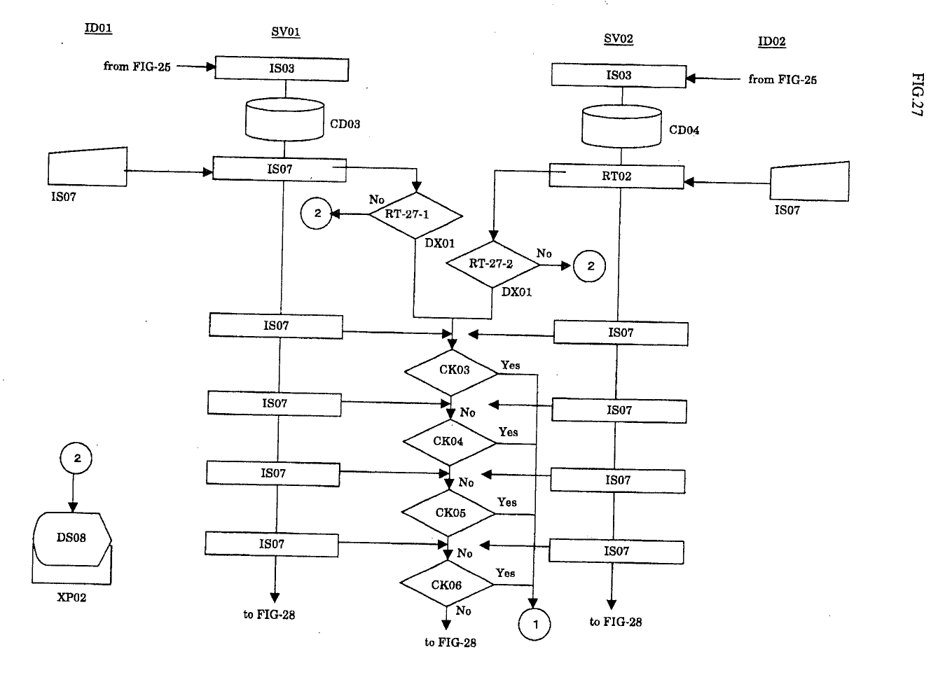

4-6. First, when the highest priority retrieval item is predetermined, the code determined by an identifier having the highest priority is retrieved and checked by highest priority (refer to FIG. 27).

4-7. If the codes do not match each other in the above mentioned procedure 4-6, the codes determined by the identifiers having the next priority is retrieved and checked. If they do not match either, the codes determined by the identifiers having lower priorities are retrieved and checked.

Thus, the codes determined by the identifiers having lower priorities are retrieved and checked until a matching result can be obtained, and the providing information having the matching code or the home page describing the providing information is displayed on the browser of the information requester.

4-8. Otherwise, a list of the URL of the home page describing the providing information having a matching code is displayed on the home page of the information requester after providing a display area.

4-9. Furthermore, for the information provider, the URL of the information requester matching the providing information is displayed on the browser of the information requester.

4-10. If a ‘re-offer input area’ for utilization of the reoffering facility described below in and after the procedure 4-18 is set at the end of the home page of the information requester, the ‘re-offer input area’ is transmitted to the information requester together with the home page describing the providing information matching the information requested database.

4-11. On the other hand, if a matching process is performed up to a predetermined identifier level and no matching information page can be detected, then a message ‘no corresponding information’ is displayed.

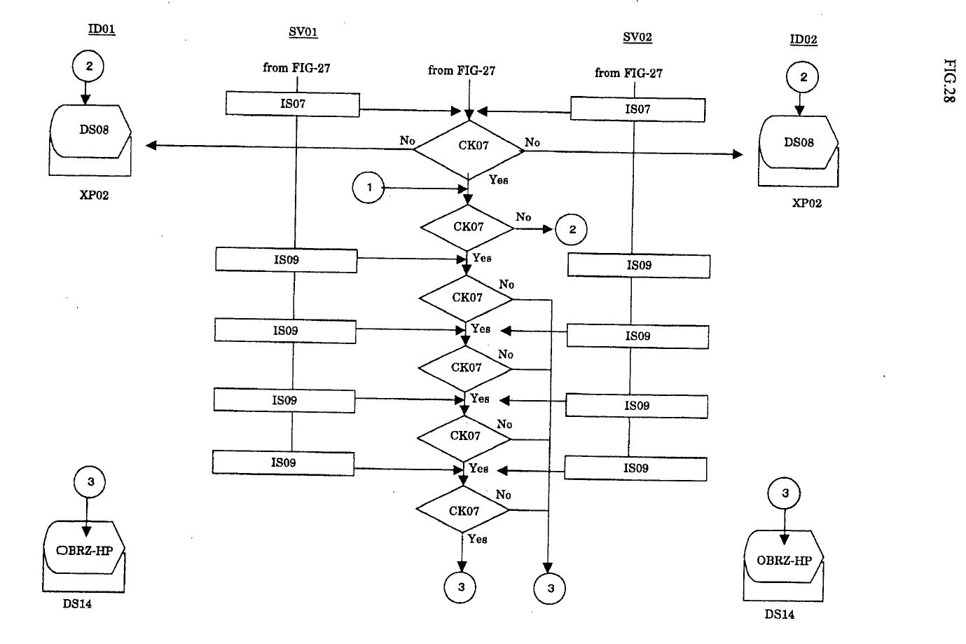

4-12. If a matching code is detected in the above mentioned matching process, then target information can be selected using an identifier whose priority is predetermined for selected information retrieval (refer to FIG. 28).

4-13. When it is certain that a retrieval checking information providing database code matches or does not match a retrieval checking information requested database code, it is displayed on the browsers of the information provider and the information requester.

4-14. If a plurality of corresponding targets are selected in the retrieving process, the information requester has the function of specifying the display orders in order from the earliest, the least expensive, etc.

4-15. In the XML using environment, the character string replaced by assigning an identifier is used as a tag having the function of a retrieval key, the identifier is specified as an attribute name using a command for use in extracting in the XML, and the WEB having the same identifier as the request code is directly called and displayed on the browser.

4-16. Also in the XML environment, the retrieval order starts with the retrieval of the code indicated by an identifier having a predetermined priority as indicated in the procedures 4-6 to 4-12, and the retrieving process is performed in the priority order of codes indicated by identifiers determined for selective retrieval.

4-17. Since the system according to the second invention has the structure of an information element database in MATRIX form, a change in retrieval condition easily corresponds to an arrow cursor. That is, a less severe condition corresponds to a ‘↑’ cursor, and narrowing a condition corresponds to a ‘↓’ cursor. The information about less expensive items corresponds to a ‘←’ cursor. The information about earlier items corresponds to a ‘→’ cursor.

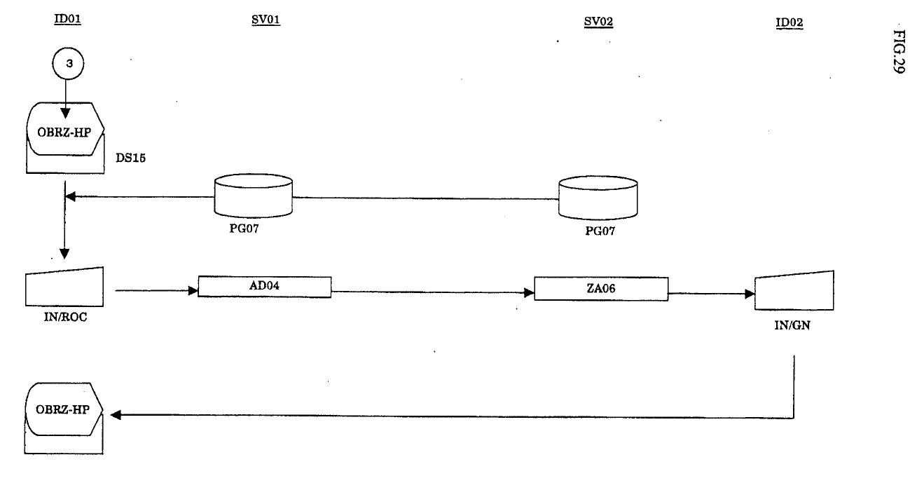

4-18. The information requester requesting further detailed information by referring to the home page describing the providing information and transmitted as a result of retrieval and check calls the computer program for generation of a re-offer code from the server, and generates and transmits the re-offer code according to the following procedures (refer to FIG. 29).

(A) Reception rejection code ‘□D□’: A code indicating no transmission again after inspecting the contents of the home page describing the providing information. It is added to the end of the URL of the information providing database, or returned to the transmitter after inserting the code into mail text. Otherwise, the code is detected on the server managed by the provider, and the URL with the code or the text with a mail address is rejected on the WEB server or the mail server of the receiver.

(B) Acceptance code ‘□O□’: A code for transmission of the information that the condition included in the providing information or request information has been accepted after inspecting the providing information or the request information. It is added to the end of the URL of the home page describing the providing information or request information, or inserted into mail text, and then returned to the transmitter.

(C) Re-offer code (retransmission request specification code) ‘□RO□’: A code prompting to retransmit further detailed information of the providing information after inspecting the contents of the home page describing the providing information It is configured by two code systems, that is, a basic re-offer and a detailed re-offer. It is added to the end of the URL of the requested information database, or inserted into mail text, and then returned to the transmitter.

A: Basic re-offer code: A condition is to be changed for further detailed, less expensive, earlier information, etc.

B: Detailed re-offer code: A code for detailed condition settings for information such as price, size, quantity, storage, freshness, etc.

4-19. In this example, it is assumed that a retransmission request code for ‘more detailed information’, ‘less expensive products’, etc. can be re-issued to matching food information.

4-20. The re-offer code can be generated and returned to the information provider in the following procedure.

(A) The area for input of a re-offer code determined in (A), (B), and (C) of the above mentioned procedure 4-18 is added to the end of the providing information description home page using the CGI or equivalent capability.

(B) The providing information description home page provided with an area for input of a re-offer code is transmitted to the domain of the information requester who has issued the retrieval checking information requested database matching the providing information.

(C) The information requester selects and inputs a necessary re-offer code in the area determined in (A) above, and returns it to the information provider.

Embodiment 3 of the Invention

Then, the embodiments of the third invention are described below in detail by referring to the attached drawings.

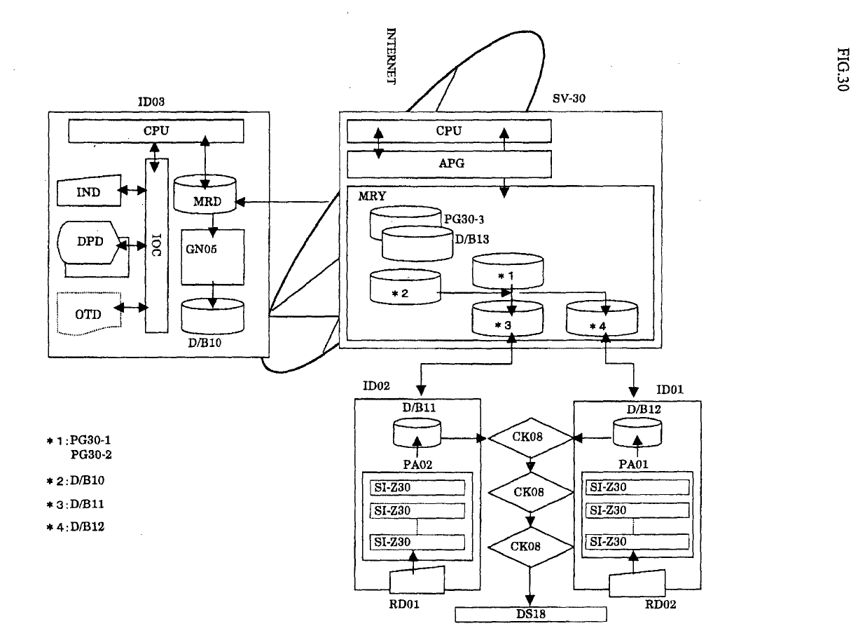

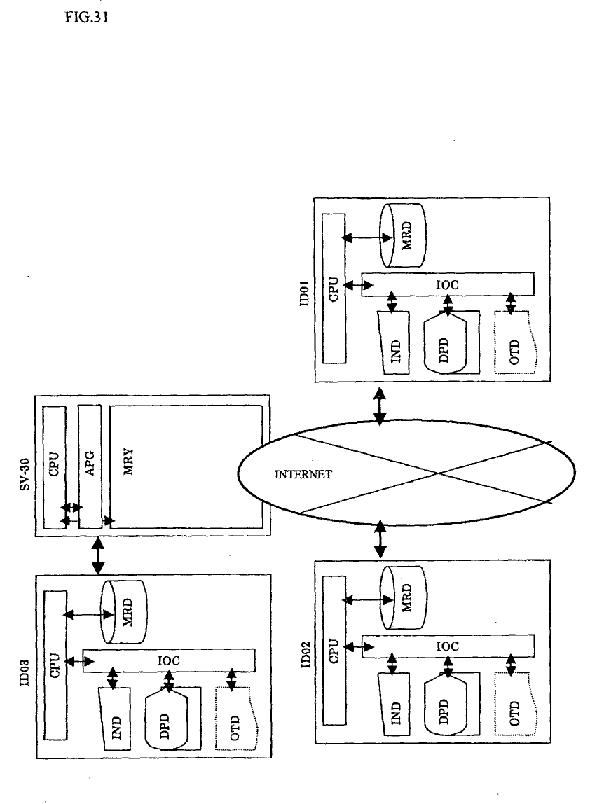

FIG. 30 shows the outline of the system of generating an information record and requested database according to an embodiment of the third invention, and generating an information provider database and an information requester database. FIG. 31 shows the configuration of the hardware of the system of generating an information record and requested database, an information provider database, and an information requester database according to an embodiment of the third invention.

As a case example, a method of generating and retrieving an information provider database and an information requester database is described below based on the assumption that a supermarket sets a process of generating an information record and requested database of the products to be provided and presenting it as an information provider database, and a process of retrieving a product by a user, that is, a consumer.

Step 1. Generating an Information Record and Requested Database, an Information Provider Database, and an Information Requester Database

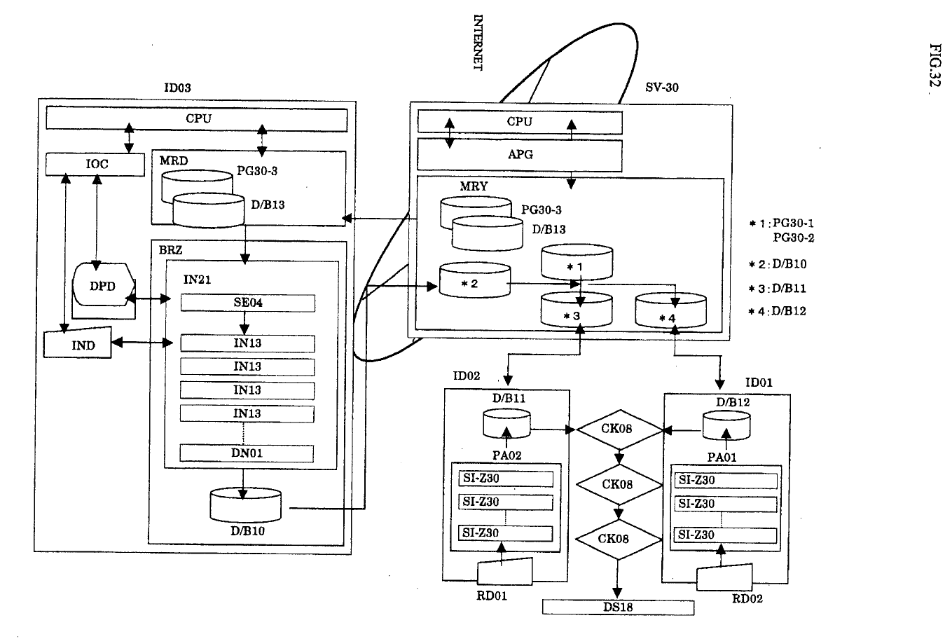

1-1. FIG. 32 shows the system of generating an information provider database and an information requester database in association with the generation and amendment of the information record and requested database according to an embodiment of the third invention. At least one information providing subject side server computer 6 declaring the correspondence to the information provider and the system of generation of information requester database according to an embodiment of the third invention is connected to the Internet 1. An information providing subject information device 7 or the user computer of the information provider is connected to the Internet

The information providing subject information device 7 comprises a main control unit 71, a drive program storage unit 72, and a storage area unit 73. The storage area unit 73 stores a computer program for generation of an information record and requested database, and a database for generation of an information record and requested database.

The information providing subject side server computer 6 comprises a main control unit 61 and a storage area unit 62. The storage area unit 62 stores a computer program for generation of an information record and requested database, a database for generation of an information record and requested database, a computer program for generation of an information provider database, and a computer program for generation of an information requester database. When the procedure 1-11 is completed, the information record and requested database is stored in the storage area unit 62.

An information provider information device 8 downloads the information provider database generated or updated in the procedures 1-14 and 1-16 from the information providing subject side server computer 6 to the storage area through the Internet 1, drives the computer program for generation of an information provider database, and records the providing and request information in the information provider database.

An information requester information device 9 downloads the information requester database generated or updated in the procedures 1-15 and 1-17 from the information providing subject side server computer 6 to the storage area through the Internet 1, drives the computer program for generation of an information requester database, and records the request information in the information requester database. 1-2. The computer program for generation of an information record and requested database has:

(A) the format for generation of an information record and requested database included in the database for generation of an information record and requested database;

(B) the function of opening a dialog box for input of necessary number of items in the format for generation of an information record and requested database;

(C) the function of displaying all columns into which providing information is to be input in table form comprising rows and columns depending on the number of items of input providing information;

(D) the function of generating priority information for retrieval and check on the corresponding items as identifiers;

(E) the function of inputting and storing an information item name to be provided for each column by item;

(F) the function of displaying a column of the providing information in which a plurality of selection items can be recorded on the display device, recording and storing plural pieces of providing information as options for the corresponding item, generating and storing the code information for retrieval and check of the input providing information;

(G) the function of freely adding and deleting as necessary the column in which an information item name and providing information name are input; and

(H) the function of storing a generated information record and requested database in the server side.

1-3. Described below is the generation of an information record and requested database determined in each of the items above. In this example, a supermarket generates an information record and requested database with the settings of a bargain sale to common consumers.

1-4. Generating an information record and requested database starts with settings of the number of items. In this example, the number of items of providing information is 12. The number of columns in which information names is input is initially 18 because they can be freely added or deleted at a generation stage.

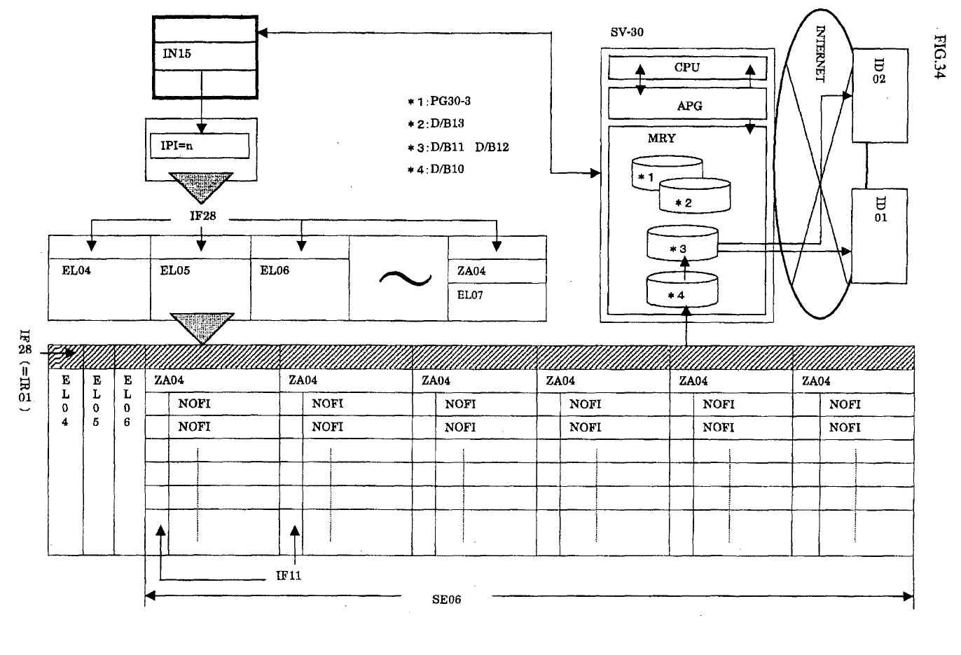

1-5. FIG. 34 shows a generation process of the information record and requested database according to an embodiment of the third invention. By setting the number of items, all columns in which providing information is input are displayed on the display device in table form, or a dialog box for prompting input is displayed, necessary information names are sequentially input, and an information record and requested database is formed. Otherwise, after specifying the information having hierarchical correlation, necessary information names are sequentially input, and an information record and requested database is generated.

1-6. The information item of the information record and requested database is defined by the following identifiers indicating the characteristic and structure of the information record and requested database.

(A) An identifier of the information record and requested database corresponding to the information retrieving method according to the fourth invention.

(B) An identifier of an information providing subject: In this case, the identifier refers to the information record and requested database provided by the ‘∘∘∘’ supermarket.

(C) An identifier of an information provider database or an information requester database corresponding to the information retrieving method according to the fourth invention.

(D) An identifier added to each item of providing information which is an item to be retrieved.

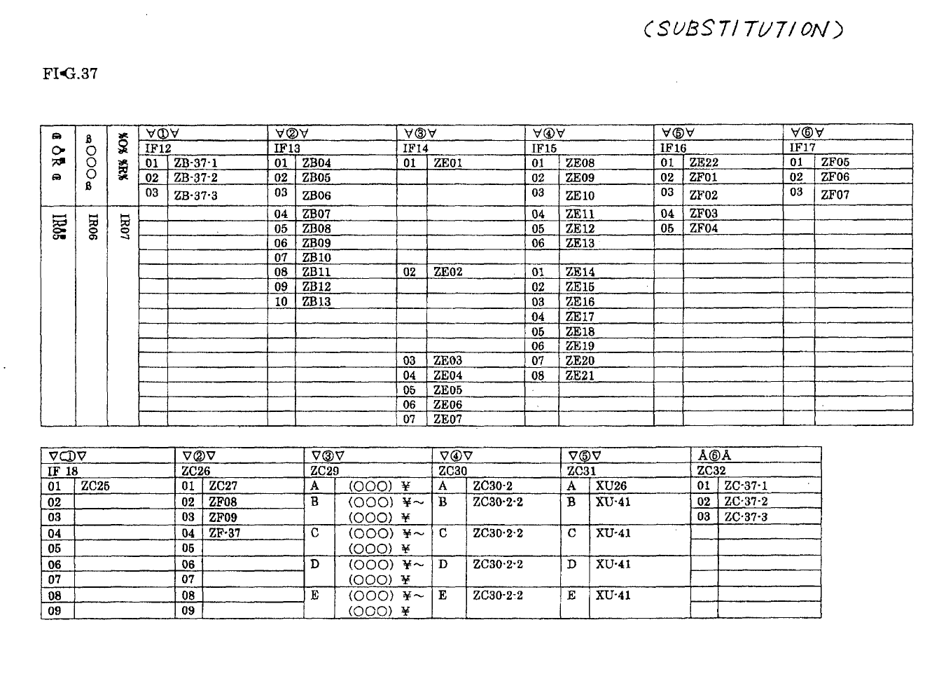

1-7. FIG. 37 shows the details of the information record and requested database according to an embodiment of the third invention. The generator of an information record and requested database freely sets an item to be prioritized in retrieval and matching among the information items to which identifiers are assigned.

1-8. As shown in FIGS. 34, 35, and 37, an information name arbitrarily provided by an information provider is entered in the column of an information name according to the function defined in the above mentioned procedure 2.

1-9. The code information for retrieval and matching corresponding one to one to the entered information is assigned to each piece of input information. The code can be automatically assigned or arbitrarily set by the information provider.

1-10. In this case, the information provider generates the information to be provided in the following procedure as the information record and requested database as shown in FIG. 37.

(A) First, since the information indicating the database generator which is a providing subject is the ∘∘∘ supermarket, ‘∘∘∘’ is input.

(B) Into the providing information class 1, the titles of the information to be retrieved, that is, ‘the X-th sales’, ‘Y-th sales’, and ‘Z-th sales’ are input.

(C) Into the providing information class 2, the type of information to be provided, that is, ‘notions’, ‘foods’, ‘draper’, ‘furniture’, etc. are input.

(D) An example generated when the ‘general goods’ is input is shown below. When other items in the providing information class 2 are entered, control is returned to the items in providing information class 2, and lower order information is input.

(E) Into the providing information class 3, the contents of the information to be provided, that is, ‘kitchenware, ‘goods for toilet and bath’, ‘foods’, etc. are input. As shown in the example, when detailed product information such as ‘goods for toilet and bath’, etc. is input, control is returned again to the providing information class 3, and lower order information is input.

(F) From the providing information class 4, the lower order information of the ‘kitchenware’, that is, ‘cleaner’, ‘towel’, ‘sponge’, etc. are input.

(G) From the providing information class 5, the lower order information of the ‘cleaner’, that is, ‘common cleaner’, ‘sterilizingcleaner’, ‘oil-removingcleaner’, etc. are input.

(H) Into the providing information class 6, the ‘sterilizing cleaner’, ‘hand protector’, ‘fragrance of lemon’, etc. indicating the details of the information to be provided are input.

(I) In the providing information basic style, ‘sold out’ indicating the information providing style is input.

(J) In the providing information reception style, ‘cash’, ‘specified card’, ‘cash on delivery’, ‘netbank’, etc. indicating the reception style of information are input.

(K) The ‘requested price’ is set such that the value of the providing information can be set for each piece of providing information.

(L) The ‘requested quantity’ is set such that the quantity of the providing information can be set for each piece of providing information.

(M) The valid term is set such that the valid term of the information to be provided can be set for each piece of providing information. In the present example, it is set up to DD, that is, ‘day’, but can be set with the designation of time in minute.

1-11. When all inputting operations are completed, the generated information record and requested database is stored in the storage area unit 62 of the information providing subject server computer 6 through the Internet 1.

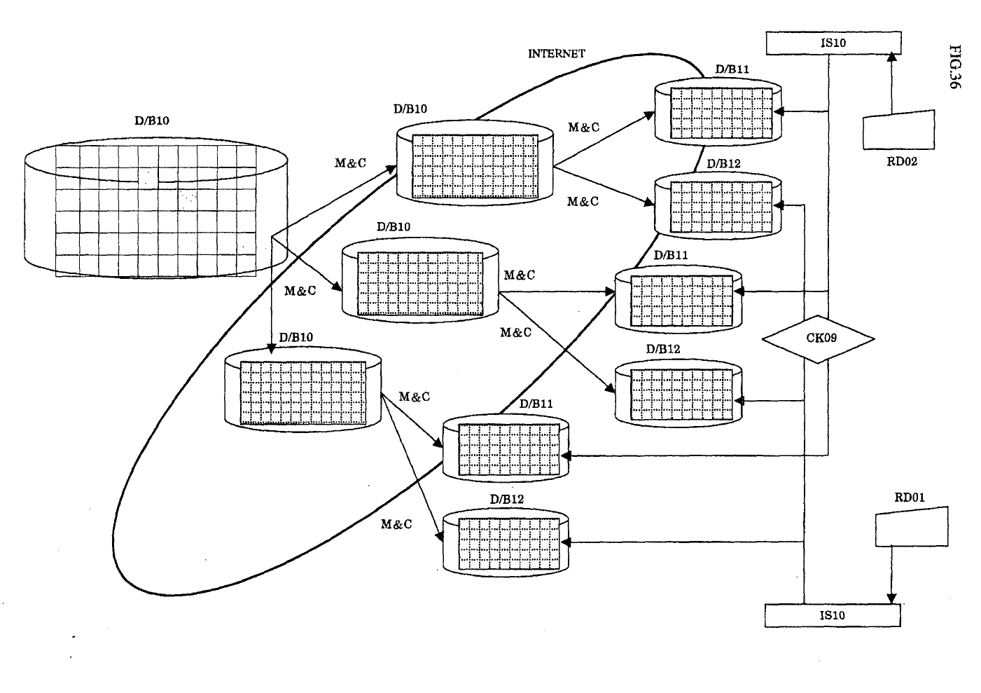

1-12. The generated information record and requested database holds and copies the contents without limiting to the information providing subject side server computer 6 to decrease the load of the process of a unit server as shown in FIG. 36, and holds them in the storage area of another server connected to the Internet 1.

1-13. In the case of the above mentioned procedure 1-12, the information provider database and the information requester database indicated by the procedures 2 and 3 can be accessed from the same server as the server holding the information record and requested database so that the load of the process in a single server can be decreased as shown in FIG. 36.

1-14. When the information record and requested database is generated in the method determined in each item of the procedure above, the information record and requested database is called, and the computer program for generation of an information provider database is called;

(A) Except that the identifier described in (C) of the above mentioned procedure 1-6 is converted into ‘%O%’ indicating an information provider database, an information provider database having the configuration of the same information element, information item, and code information for retrieval and check as the information record and requested database is generated.

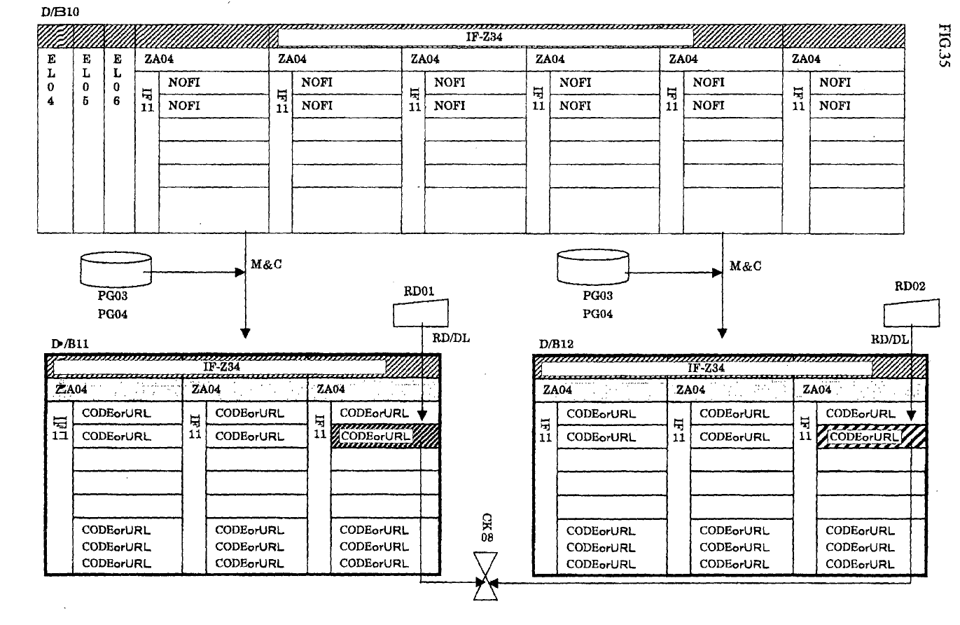

(B) In the information provider database generated in the method of (A) described above, an area sequentially storing the code or the URL address identifying the information providing requester, and assigned in advance to the information providing requester after being selected as the providing request information is set in the column for input of the information name defined in the above mentioned procedure 1-5 as shown in FIG. 35.

(C) Otherwise, a storage area is set for a retrieval identifier corresponding to the information element held in the information record and requested database and all information codes for retrieval and check, and the code for identification of an information providing requester assigned in advance to the information providing requester who selects the information as providing request information or the URL address of the information providing requester is sequentially stored.

(D) The generated information provider database is stored in the storage area of the information providing subject side server computer 6.

1-15. When the information record and requested database is generated in the method determined in each item of the procedure above, the information record and requested database is called, and the computer program for generation of an information requester database is called;

(A) Except that the identifier described in (C) of the above mentioned procedure 1-6 is converted into ‘%R%’ indicating an information requester database, an information requester database having the configuration of the same information element, information item, and code information for retrieval and check as the information record and requested database is generated.

(B) In the information requester database generated in the method of (A) of the procedure 1-15 described above, an area sequentially storing the code or the URL address identifying the information requester, and assigned in advance to the information requester after being selected as the request information is set in the column for input of the information name defined in the above mentioned procedure 1-5 as shown in FIG. 35.

(C) Otherwise, a storage area is set for a retrieval identifier corresponding to the information element held in the information record and requested database and all information codes for retrieval and check, and the code for identification of an information requester assigned in advance to the information requester who selects the information as request information or the URL address of the information requester is sequentially stored.

(D) The generated information requester database is stored in the storage area of the information providing subject side server computer 2.

1-16. When the information record and requested database is updated,

(A) Except that the identifier described in (C) of the above mentioned procedure 1-6 is converted into ‘%O%’ indicating an information provider database, and except that the expression of ‘providing’ in the information item name entry column is replaced with the expression of ‘request, the information provider database is updated with the code for identification of the information providing requester assigned to the information providing requester with the information selected as providing request information, or the URL address information about the information providing requester having the configuration of the same information element, information item, and code information for retrieval and check as the updated information record and requested database, and stored in the column for the information name in the information record and requested database.

(B) Otherwise, a new information provider database is sequentially updated with a storage area set for a retrieval identifier corresponding to the information element held in the information record and requested database and all information codes for retrieval and check, and the code for identification of an information providing requester assigned in advance to the information providing requester who selects the information as providing request information or the URL address of the information providing requester sequentially stored.

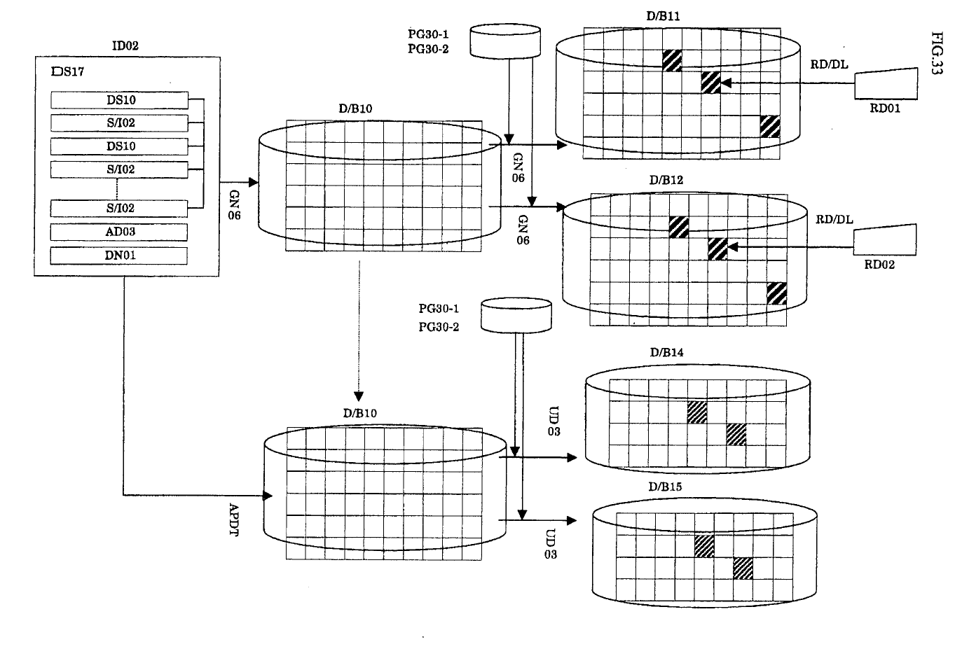

1-17. When the information record and requested database are updated, as shown in FIG. 33

(A) Except that the identifier described in (C) of the above mentioned procedure 1-6 is converted into ‘%R%’ indicating an information requester database, the information requester database is updated with the code for identification of the information requester assigned in advance to the information requester with the information selected as request information, or the URL address information about the information requester having the configuration of the same information element, information item, and code information for retrieval and check as the updated information record and requested database, and stored in the column for the information name in the information record and requested database.

(B) Otherwise, a new information requester database is sequentially updated with a storage area set for a retrieval identifier corresponding to the information element held in the information record and requested database and all information codes for retrieval and check, and the code for identification of an information requester assigned in advance to the information requester who selects the information as request information or the URL address of the information requester sequentially stored.

Step 2. Generating an Information Provider Database and Recording Providing Information

2-1. FIG. 32 shows the system of generating an information provider database and an information requester database in association with the generation and amendment of the information record and requested database according to an embodiment of the third invention. At least one information providing subject side server computer 6 declaring the correspondence to the information provider database and the system of generation of information requester database according to an embodiment of the third invention is connected to the Internet 1. An information providing subject information device 8 or the user computer of the information provider is connected to the Internet 1.

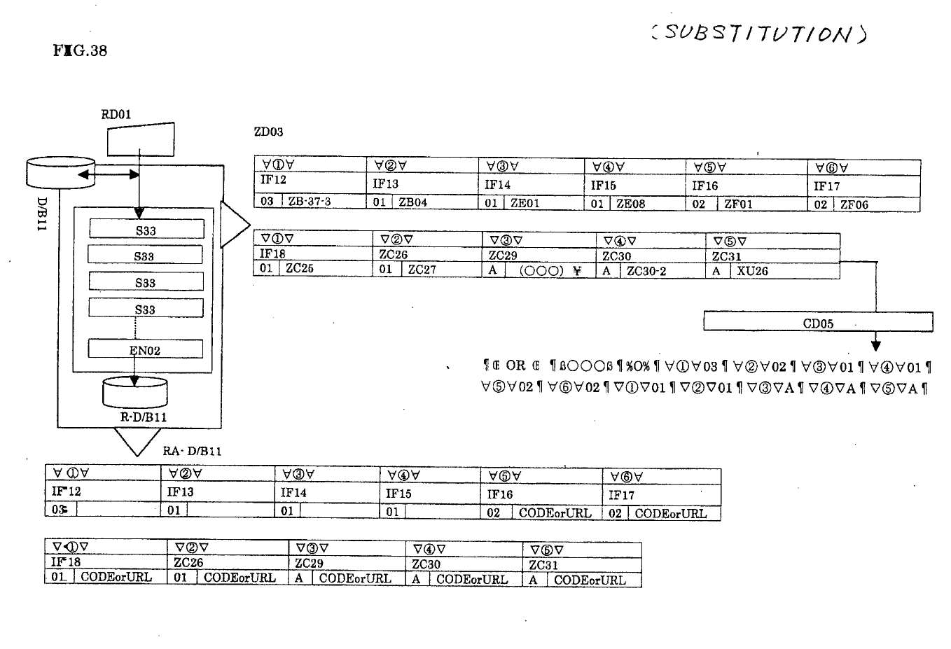

2-2. The information device 4 of an information provider downloads the computer program for generation of an information provider database and the generated information provider database through the Internet 1 from the storage area of the information providing subject side server computer 6, calls them on the information providing home page, and records the providing request information in the information provider database according to the following procedure as shown in FIGS. 35 and 38.

(A) The generated information provider database is called.

(B) Providing information items and a plurality of options corresponding thereto are displayed on the information providing home page, and the information provider is prompted to select one or more options from among a plurality of options as a response to the corresponding items.

(C) The information provider opens a dialog box according to the order of the displayed item selection, and selects a necessary item from a list of the items to be selected displayed on the dialog box (hereinafter referred to as an input box).

(D) The information provider sequentially selects and inputs necessary providing information by an operation of selecting an option displayed on the screen while referring to the information provider database at an instruction of the input box. The information not to be selected is ignored, and control is passed to the next item.

(E) When all information is completely selected, for the items recognized as necessary by the information provider, the code for identification of the information providing requester assigned in advance to the information providing requester with the information selected as providing request information, or the URL address of the information providing requester are sequentially stored in the area for input of the information name of the selection item.

2-3. Otherwise, the providing request information is recorded in the information provider database in the following procedure.

(A) For the selected option and the item, the identifier and code indicating the priority information for retrieval and check are sequentially generated and stored.

(B) When all information selection and input are completed, the information about the address of the information corresponding to the information provider database is added.

(C) The information generated in the procedures shown in (A) and (B) above is stored in the information providing subject side server.

(D) The generated code information is replaced with the URL.

(E) The replaced URL is published on the Internet, the URL of the corresponding information requester database using an identifier as a key is retrieved, the internal code is checked, the matching information requester information is displayed on providing information description home page of the information provider.

2-4. In this case, the providing request information is recorded in the information provider database in the following procedure. FIG. 38 shows the process of generating the information provider database according to an embodiment of the third invention.

In this example, the information providing requester selects a ‘sterilizing cleaner’ and ‘hand protector’ cleaner from among ‘notions’, ‘kitchenware’, and ‘cleaners’. When plural pieces of providing request information are set, a repetitive information recording process is performed in the similar procedure.

(A) calling a generated information provider database provided by the ∘∘∘ supermarket;

(B) specifying ‘Z-th sales’ which is the sales tile for the time being from the providing information class 1;

(C) automatically selecting the corresponding code ‘03’;

(D) selecting the type of information to be provided, that is, ‘notions’ from the providing information class 2;

(E) automatically selecting the corresponding code ‘01’;

(F) selecting the contents of the information to be provided, that is, ‘kitchenware’ from the providing information class 3;

(G) automatically selecting the corresponding code ‘01’;

(I) selecting ‘cleaner’ which is the product name of the information to be provided from the providing information class 4;

(J) automatically selecting the corresponding code ‘01’;

(K) selecting the product name of the information to be provided, that is, ‘sterilizingcleaner’, from the providing information class 5;

(L) automatically selecting the corresponding code ‘02’;

(M) selecting ‘hand protector’ indicating the characteristic of the information to be provided from the providing information class 6;

(N) automatically selecting the corresponding code ‘02’;

(O) selecting ‘sold out’ indicating the providing style of the information from the providing information basic style;

(P) automatically selecting the corresponding code ‘01’;

(Q) selecting ‘cash’ indicating the reception style of the information from the providing information reception style;

(R) automatically selecting the corresponding code ‘01’;

(S) selecting ‘∘∘∘’ as the value of providing information as a requested price;

(T) automatically selecting the corresponding code ‘A’;

(U) selecting ‘∘∘∘’ as the quantity of providing information into the requested quantity;

(V) automatically selecting the corresponding code ‘A’; and

(W) selecting a valid term of the information to be provided by ‘YYMMDD’.

(X) The corresponding code ‘A’ is automatically selected. In this example, up to DD, that is, ‘day’ is specified, but up to the time can be specified (for example, hour, minute, HHMM) in the information provider database.

2-5. When all selection is completed, relating to the item to be recognized by the information provider, the code for identification of the information providing requester assigned to the information providing requester in advance with the information as the providing request information, or the URL address of the information providing requester are stored in the area in which the information name of the selection item is input in the information provider database. In this example, as shown in FIG. 38, the ‘□□□’ indicating the ‘sterilizing cleaner’ to ‘□□□’ indicating the ‘valid term’ are recorded.

2-6. The selected information is classified for each information item using an identifier as a delimiter code ‘¶’ for each determination, or using a character not used or prohibited in the HTML or XML markup language as a delimiter code, replaced with a URL code, and published on the Internet. However, the delimiter code depends of the future development of the international standard of the markup language.

In this case, the information provider database code replaced with the URL is represented as follows.

¶?OR?¶s∘∘∘s¶%0%¶□□□03¶□□□02¶□□□01¶□□□01¶□□□02¶□□□02¶□□□01¶□□□01¶□□□A¶□□□A¶□□

□

A

2-7. The above mentioned code is used as a retrieval key for simultaneous retrieval and check of a plurality of databases when the information provider database and the information requester database are arranged on a plurality of servers to reduce the load on the servers as indicated by 1-12 of the procedure 1.

2-8. The input page on which an information provider database has been selected can be stored as a ‘providing information description home page’ in file form as is.

Step 3. Generating an Information Requester Database and Recording Request Information

3-1. FIG. 32 shows the system of generating an information provider database and an information requester database when the information record and requested database is generated and amended according to an embodiment of the third invention. At least one information providing subject side server computer 6 declaring the correspondence to the system of generating an information requester database and an information requested database according to the fourth invention is connected to the Internet 1. Then, the information device 8 of the information requester or the user computer of the information requester is also connected to the Internet 1.

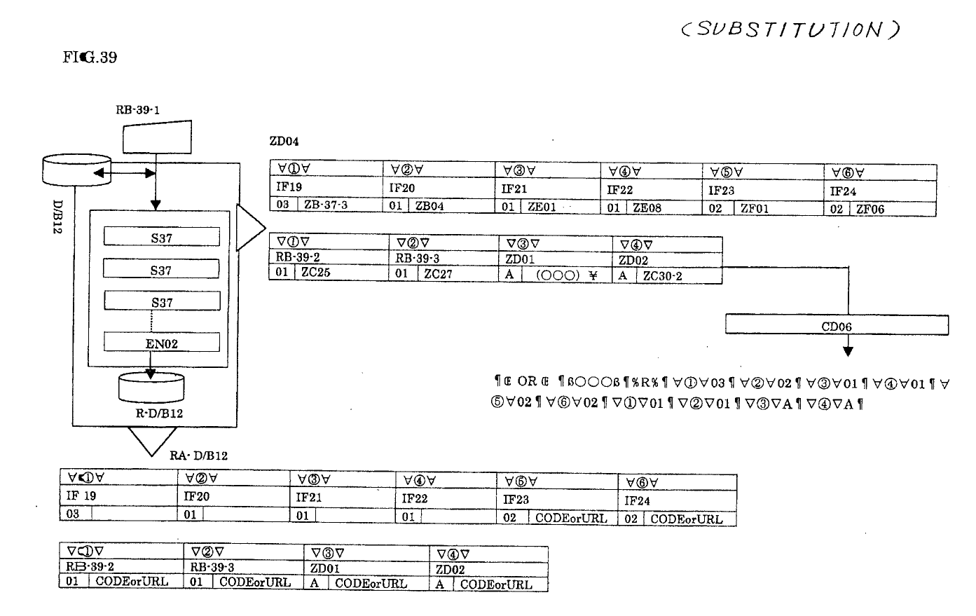

3-2. The information provider information device 8 of the information requester downloads the computer program for generation of an information requester database and the generated information requester database from the storage area of the information providing subject side server computer 6 through the Internet 1, and called to the information request home page, and the request information is recorded to the information requester database in the following procedure as shown in FIGS. 35 and 39.

(A) The generated information requester database is called.

(B) Request information items and a plurality of options corresponding thereto are displayed on the information request home page, and an information requester is prompted to select one or more options from among a plurality of options as a response to the corresponding items.

(C) The information requester opens a dialog box in the displayed item selection order, and selects a necessary item from a list of the items to be selected and displayed in the dialog box (hereinafter referred to as an input box).

(D) At an instruction from the input box, the information requester refers to the information requester database, and sequentially selects or inputs necessary request information by performing an operation of selecting an option displayed on the screen. The information not to be selected can be passing to the subsequent items without input.

(E) When all information is completely selected, for the items recognized as necessary by the information requester, the code for identification of the information requester assigned in advance to the information requester with the information selected as request information, or the URL address of the information requester are sequentially stored in the area for input of the information name of the selection item.

3-3. Otherwise, the request information is recorded in the information requester database in the following procedure.

(A) For the selected option and the item, the identifier and code indicating the priority information for retrieval and check are sequentially generated and stored.

(B) When all information selection and input are completed, the information about the address of the information corresponding to the information requester database is added.

(C) The information generated in the procedures shown in (A) and (B) above is stored in the information providing subject server.

(D) The generated code information is replaced with the URL.

(E) The replaced URL is published on the Internet, the URL of the corresponding information provider database using an identifier as a key is retrieved, the internal code is checked, the matching information provider information is displayed on request information home page of the information requester.

3-4. In this case, the request information is recorded in the information requester database in the following procedure. FIG. 39 shows the process of generating the information requester database according to an embodiment of the third invention.

In this example, the information requester selects a ‘sterilizing cleaner’ and ‘hand protector’ cleaner from among ‘notions’, ‘kitchenware’, and ‘cleaners’. When plural pieces of request information are set, a repetitive information recording process is performed in the similar procedure.

(A) calling a generated information requester database provided by the ∘∘∘ supermarket;

(B) specifying ‘Z-th sales’ which is the sales tile for the time being from the request information class 1;

(C) automatically selecting the corresponding code ‘03’;

(D) selecting the type of information to be provided, that is, ‘notions’ from the request information class 2;

(E) automatically selecting the corresponding code ‘01’;

(F) selecting the contents of the information to be provided, that is, ‘kitchenware’ from the request information class 3;

(G) automatically selecting the corresponding code ‘01’;

(H) selecting ‘cleaner’ which is the product name of the information to be provided from the request information class 4;

(I) automatically selecting the corresponding code ‘01’;

(J) selecting the product name of the information to be provided, that is, ‘sterilizing cleaner’, from the request information class 5;

(K) automatically selecting the corresponding code ‘02’;

(L) selecting ‘hand protector’ indicating the characteristic of the information to be provided from the request information class 6;

(M) automatically selecting the corresponding code ‘02’;

(N) selecting ‘sold out’ indicating the request style of the information from the request information basic style;

(O) automatically selecting the corresponding code ‘01’;

(P) selecting ‘cash’ indicating the reception style of the information from the request information reception style;

(Q) automatically selecting the corresponding code ‘01’;

(R) selecting ‘∘∘∘’ as the value of providing information as a requested price;

(S) automatically selecting the corresponding code ‘A’;

(T) selecting ‘∘∘∘’ as the quantity of providing information into the requested quantity;

(U) automatically selecting the corresponding code ‘A’; and

3-5. When all selection is completed, relating to the item to be recognized necessary by the information requester, the code for identification of the information requester assigned to the information requester in advance with the information as the request information, or the URL address of the information requester are stored in the area in which the information name of the selection item is input in the information requester database. In this example, as shown in FIG. 39, the ‘□□□’ indicating the ‘sterilizing cleaner’ to ‘□□□’ indicating the ‘request amount’ are recorded.

3-6. The selected information is classified for each information item using an identifier as a delimiter code ‘¶’ for each determination, or using a character not used or prohibited in the HTML or XML markup language as a delimiter code, replaced with a URL code, and published on the Internet. However, the delimiter code depends of the future development of the international standard of the markup language.

In this case, the information requester database code replaced with the URL is represented as follows.

¶?OR?¶s∘∘∘s¶%R%¶□□□03¶□□□02¶□∞□01¶□□□01¶□□□02¶□□□02¶□□□01¶□□□01¶□□□A□□□A¶

3-7. The above mentioned code is used as a retrieval key for simultaneous retrieval and check of a plurality of databases when the information provider database and the information requester database are arranged on a plurality of servers to reduce the load on the servers as indicated by 1-12 of the procedure 1.

3-8. The input page on which an information requester database has been selected can be stored as a ‘request information description home page’ in file form as is.

Step 4. Step of Retrieving and Checking an Information Provider Database and an Information Requester Database

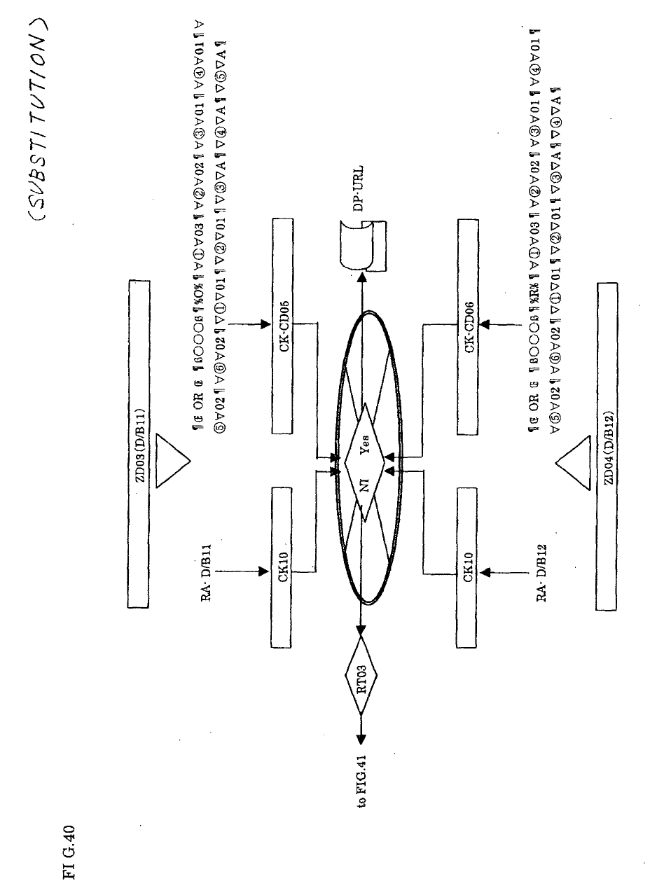

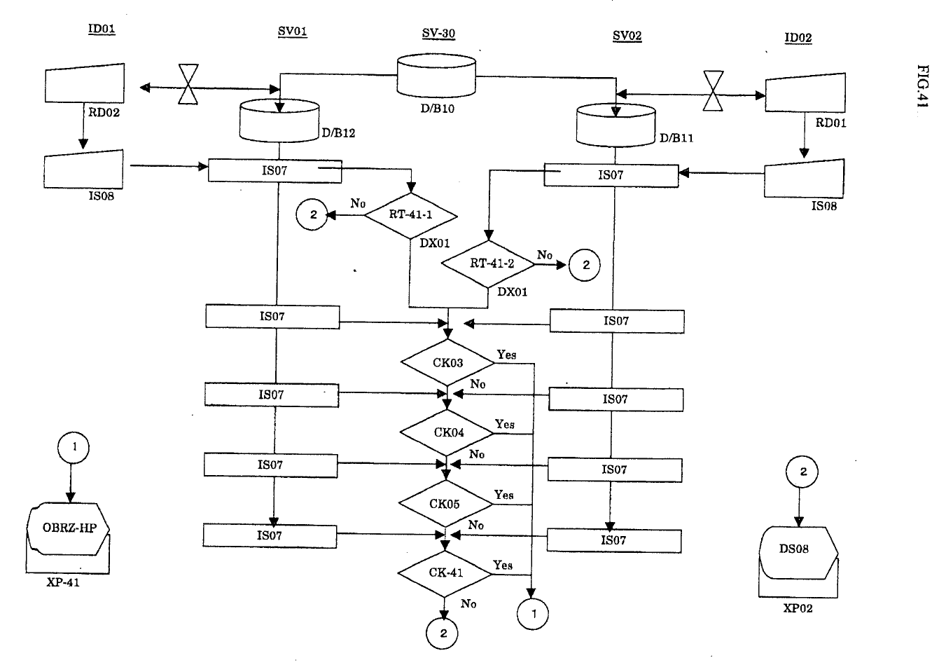

4-1. The information provider database generated and recorded in the abovementioned procedure 2 and the information requester database generated and recorded in the abovementioned procedure 3 are retrieved and checked in the following procedure as shown in FIGS. 40 and 41.

(A) When providing request information is recorded in the information provider database, or when request information is recorded in the information requester database,

(B) if the area assigned the same information name as the partner database is searched using a retrieval identifier added to the last selection item of each database and the code assigned to the information item name as retrieval keys, and

(C) if a code for identification of an information requester assigned in advance to the information requester selected with the information as providing request information, or the URL address of the information provider are stored in the area, or the code for identification of an information requester assigned in advance to the information requester selected with the information as request information, or the URL address of the information requester are stored in the area,

(D) then the information device of the partner is notified of the presence of the corresponding providing request information or the request information, and simultaneously, the code identifying the partner with ‘The corresponding information is described as follows.’, or the URL address list of the partner is displayed.

4-2. In the retrieving and matching procedure shown in the above mentioned step 4-1, if the code for identification of the partner or the URL address of the partner is not stored, then the retrieving and checking processes are continued in the following procedures.

(A) In the retrieval priority predetermined in the procedure shown in 1-7 of the step 1, the area of the partner database assigned the same information name as the code determined by the identifier having the next priority is retrieved and checked, the area of the information provider database and the area of the information requester database is compared with each other, and the record code of the information requester in the area or the URL of the information requester exists in the area, or the record code of the information requester or the URL address of the information requester exists in the area, then the information device of the partner is notified of the existence of the providing request information or the request information, and simultaneously, the code identifying the partner with ‘The corresponding information is described as follows.’, or the URL address list of the partner is displayed.

(B) If there is no code or address in the area of the partner, the area of the partner database assigned the same information name as the code determined by the identifier having the next priority is retrieved and checked, and, if no matching result is output, the area of the partner database assigned the same information name as the code determined by the identifier having the lower priority is retrieved and checked.

(C) Thus, to obtain a matching result, the corresponding area is retrieved and checked until the record code of the information provider or the URL address of the information provider can be found in the code area determined by the identifier having a lower priority, or the record code of the information requester or the URL address of the information requester can be found in the corresponding area. The providing information or request information having a matching code is transmitted to the information device of the partner by notifying that there is a corresponding providing request information or request information, and simultaneously the code identifying the partner matching ‘the corresponding information is described as follows.’, or the URL address list of the partner is displayed.

FIG. 40 shows the outline of the retrieval and checking process of the information provider database and the information requester database according to an embodiment of the third invention. FIG. 41 shows the details of the retrieval and checking process of the information provider database and the information requester database according to an embodiment of the third invention.

4-3. The URL-converted information provider database code and the information requester database code generated in the procedure shown in 2-6 of step 2 and 3-6 of the step 3 are retrieved and checked in the procedure described below.

4-4. The URL-converted information provider database code published on the Internet is compared in the procedure below with the URL-converted information requester database published on the Internet, and the information matching the request is displayed on the browser of the information provider and the information requester. Otherwise, a list of the home pages describing the matching providing information or the home pages of the information requesters is displayed on the browser on both sides, or the URL of the home page describing the providing information matching the request is returned to the information requester in MAIL text.

4-5. The retrieval program in the system according to the third invention determines the protocol such that it can be detected when the information provider database code having the identifier ‘%O%’ and the information requester database code having the identifier ‘%R%’ appear on the network.

4-6. Furthermore, when an information provider database is generated, a character string in the URL of the information requester database having the information segmented by an identifier indicating a target information providing subject, and the identifier ‘%R%’ is retrieved, the character string in the URL of the information requester database code having the same identifier as the according to identifier is extracted using the identifier as a retrieval key, and is compared with its own code.

4-7. When an information requester database is generated, a character string in the URL of the information provider database having the information segmented by an identifier indicating a target information providing subject, and the identifier ‘%O%’ is retrieved, the character string in the URL of the information provider database code having the same identifier as the according to identifier is extracted using the identifier as a retrieval key, and is compared with its own code.

4-8. The priority of the matching process when the above mentioned steps 4-6 and 4-7 are used is described below. 4-9. First, when the highest priority retrieval item is preset, the code determined by the identifier having the highest priority is retrieved and checked by highest priority.

4-10. When both codes do not match in the above mentioned step 4-9, the code determined by the identifier having the second highest priority is retrieved and checked, and, if no matching result is detected, the code determined by an identifier having a lower priority is retrieved and checked.

The code determined by the identifier having a lower priority is retrieved and checked until a matching is detected, and providing information having the matching code or the home page describing the providing information is displayed on the browser of the information requester.

4-11. Otherwise, the list of the URL of the homepage describing the providing information having a matching code is displayed on the option of the information requester with a display area prepared.

4-12. Furthermore, to the information provider, the URL of the information requester matching the providing information is displayed on the browser of the information provider.

4-13. On the other hand, if no matching information page can be detected after the checking process up to the predetermined identifier level, the message ‘no matching information’ is displayed.

4-14. If a matching code is detected in the above mentioned checking process, a further information retrieving process is performed by selecting the target information using a predetermined identifier.

4-15. When the information provider database code matches the information requester database code, or when no matching is detected, it is displayed on the browsers of the information provider and the information requester.

4-16. If a plurality of targets are selected in the retrieving process, the information requester has the function of specifying the display order ‘from the earliest’ or ‘from the least expensive’.

4-17. In the XML using environment, a character string replaced by assigning an identifier is used as a tag having the function of a retrieval key, the identifier is specified as an attribute name using a command for extraction in the XML environment, and the WEB having the same identifier as the request code is called and displayed on the browser.

4-18. In the XML environment, the retrieval order starts with the retrieval of the code indicated by the identifier having a predetermined priority as described in the steps 4-9 to 4-16, and the retrieving process is performed using the priority in the order of the code indicated by the identifier determined for selection and retrieval.

Embodiment 4 of the Invention

Then, the embodiments of the fourth invention are described below in detail by referring to the attached drawings.

FIG. 30 shows the outline of the system of generating an information record and requested database according to an embodiment of the fourth invention, and generating an information provider database and an information requester database. FIG. 31 shows the configuration of the hardware of the system of generating an information record and requested database, an information provider database, and an information requester database according to an embodiment of the fourth invention.

As a case example, a method of generating and retrieving an information provider database and an information requester database is described below based on the assumption that a supermarket sets a process of generating an information record and requested database of the products to be provided and presenting it as an information provider database, and a process of retrieving a product by a user, that is, a consumer.

Furthermore, using the system of the fourth invention, the product provided by an information provider is URL-coded, the product requested by the information requester is URL-coded, and the products requested by the information provider and the information requester can be retrieved by comparing the codes over the Internet. FIGS. 32 to 35 show the process and retrieving method.

Step 1. Generating an Information Record and Requested Database, an Information Provider Database, and an Information Requester Database

1-1. FIG. 32 shows the system of generating an information provider database and an information requester database in association with the generation and amendment of the information record and requested database according to an embodiment of the fourth invention. At least one information providing subject side server computer 6 declaring the correspondence to the information provider and the system of generation of information requester database according to an embodiment of the fourth invention is connected to the Internet 1. An information providing subject information device 7 or the user computer of the information provider is connected to the Internet 1.

The information providing subject information device 7 comprises a main control unit 71, a drive program storage unit 72, and a storage area unit 73. The storage area unit 73 stores a computer program for generation of an information record and requested database, and a database for generation of an information record and requested database.

The information providing subject side server computer 6 comprises a main control unit 61 and a storage area unit 62. The storage area unit 62 stores a computer program for generation of an information record and requested database, a database for generation of an information record and requested database, a computer program for generation of an information provider database, and a computer program for generation of an information requester database. When the step 1-11 is completed, the information record and requested database is stored in the storage area unit 62.

An information provider information device 8 downloads the information provider database generated or updated in the Steps 1-14 and 1-16 from the information providing subject side server computer 6 to the storage area through the Internet 1, drives the computer program for generation of an information provider database, and records the providing and request information in the information provider database.

An information requester information device 9 downloads the information requester database generated or updated in the steps 1-15 and 1-17 from the information providing subject side server computer 6 to the storage area through the Internet 1, drives the computer program for generation of an information requester database, and records the request information in the information requester database.

1-2. The computer program for generation of an information record and requested database has:

(A) the format for generation of an information record and requested database included in the database for generation of an information record and requested database;

(B) the function of opening a dialog box for input of necessary number of items in the format for generation of an information record and requested database;

(C) the function of displaying all columns into which providing information is to be input in table form comprising rows and columns depending on the number of items of input providing information;

(D) the function of generating priority information for retrieval and check on the corresponding items as identifiers;

(E) the function of inputting and storing an information item name to be provided for each column by item;

(F) the function of displaying a column of the providing information in which a plurality of selection items can be recorded on the display device, recording and storing plural pieces of providing information as options for the corresponding item, generating and storing the code information for retrieval and check of the input providing information;

(G) the function of freely adding and deleting as necessary the column in which an information item name and providing information name are input; and

(H) the function of storing a generated information record and requested database in the server side.

1-3. Described below is the generation of an information record and requested database determined in each of the items above. In this example, a supermarket generates an information record and requested database with the settings of a bargain sale to common consumers.

1-4. Generating an information record and requested database starts with settings of the number of items. In this example, the number of items of providing information is 12. The number of columns in which information names is input is initially 18 because they can be freely added or deleted at a generation stage.

1-5. FIG. 34 shows a generation process of the information record and requested database according to an embodiment of the fourth invention. By setting the number of items, all columns in which providing information is input are displayed on the display device in table form, or a dialog box for prompting input is displayed, necessary information names are sequentially input, and an information record and requested database is formed. Otherwise, after specifying the information having hierarchical correlation, necessary information names are sequentially input, and an information record and requested database is generated.

1-6. The information item of the information record and requested database is defined by the following identifiers indicating the characteristic and structure of the information record and requested database.

(A) An identifier of the information record and requested database corresponding to the information retrieving method according to the fourth invention.

(B) An identifier of an information providing subject: In this case, the identifier refers to the information record and requested database provided by the ‘∘∘∘’ supermarket.

(C) An identifier of an information provider database or an information requester database corresponding to the information retrieving method according to the fourth invention.

(D) An identifier added to each item of providing information which is an item to be retrieved.

1-7. FIG. 37 shows the details of the information record and requested database according to an embodiment of the fourth invention. The generator of an information record and requested database freely sets an item to be prioritized in retrieval and matching among the information items to which identifiers are assigned.

1-8. As shown in FIGS. 34, 35, and 37, an information name arbitrarily provided by an information provider is entered in the column of an information name according to the function defined in the above mentioned procedure 2.

1-9. The code information for retrieval and matching corresponding one to one to the entered information is assigned to each piece of input information. The code can be automatically assigned or arbitrarily set by the information provider.

1-10. In this case, the information provider generates the information to be provided in the following procedure as the information record and requested database as shown in FIG. 37.

(A) First, since the information indicating the database generator which is a providing subject is the ∘∘∘ supermarket, ‘∘∘∘’ is input.

(B) Into the providing information class 1, the titles of the information to be retrieved, that is, ‘the X-th sales’, ‘Y-th sales’, and ‘Z-th sales’ are input.

(C) Into the providing information class 2, the type of information to be provided, that is, ‘notions’, ‘foods’, ‘draper’, ‘furniture’, etc. are input.

(D) An example generated when the ‘general goods’ is input is shown below. When other items in the providing information class 2 are entered, control is returned to the items in providing information class 2, and lower order information is input.

(E) Into the providing information class 3, the contents of the information to be provided, that is, ‘kitchenware, ‘goods for toilet and bath’, ‘foods’, etc. are input. As shown in the example, when detailed product information such as ‘goods for toilet and bath’, etc. is input, control is returned again to the providing information class 3, and lower order information is input.

(F) From the providing information class 4, the lower order information of the ‘kitchenware’, that is, ‘cleaner’, ‘towel’, ‘sponge’, etc. are input.

(G) From the providing information class 5, the lower order information of the ‘cleaner’, that is, ‘common cleaner’, ‘sterilizingcleaner’, ‘oil-removingcleaner’, etc. are input.

(H) Into the providing information class 6, the ‘sterilizing cleaner’, ‘hand protector’, ‘fragrance of lemon’, etc. indicating the details of the information to be provided are input.

(I) In the providing information basic style, ‘sold out’ indicating the information providing style is input.

(J) In the providing information reception style, ‘cash’, ‘specified card’, ‘cash on delivery’, ‘netbank’, etc. indicating the reception style of information are input.

(K) The ‘requested price’ is set such that the value of the providing information can be set for each piece of providing information.

(L) The ‘requested quantity’ is set such that the quantity of the providing information can be set for each piece of providing information.

(M) The valid term is set such that the valid term of the information to be provided can be set for each piece of providing information. In the present example, it is set up to DD, that is, ‘day’, but can be set with the designation of time in minute.

1-11. When all inputting operations are completed, the generated information record and requested database is stored in the storage area unit 62 of the information providing subject server computer 6 through the Internet 1.

1-12. The generated information record and requested database holds and copies the contents without limiting to the information providing subject side server computer 6 to decrease the load of the process of a unit server as shown in FIG. 36, and holds them in the storage area of another server connected to the Internet 1.

1-13. In the case of the above mentioned step 1-12, the information provider database and the information requester database indicated by the steps 2 and 3 can be accessed from the same server as the server holding the information record and requested database so that the load of the process in a single server can be decreased as shown in FIG. 36.

1-14. When the information record and requested database is generated in the method determined in each item of the procedure above, the information record and requested database is called, and the computer program for generation of an information provider database is called;

(A) Except that the identifier described in (C) of the above mentioned step 1-6 is converted into ‘%O%’ indicating an information provider database, an information provider database having the configuration of the same information element, information item, and code information for retrieval and check as the information record and requested database is generated.

(B) In the information provider database generated in the method of (A) described above, an area sequentially storing the code or the URL address identifying the information providing requester, and assigned in advance to the information providing requester after being selected as the providing request information is set in the column for input of the information name defined in the above mentioned step 1-5 as shown in FIG. 35.

(C) Otherwise, a storage area is set for a retrieval identifier corresponding to the information element held in the information record and requested database and all information codes for retrieval and check, and the code for identification of an information providing requester assigned in advance to the information providing requester who selects the information as providing request information or the URL address of the information providing requester is sequentially stored.

(D) The generated information provider database is stored in the storage area of the information providing subject side server computer 6.

1-15. When the information record and requested database is generated in the method determined in each item of the procedure above, the information record and requested database is called, and the computer program for generation of an information requester database is called;

(A) Except that the identifier described in (C) of the above mentioned step 1-6 is converted into ‘%R%’ indicating an information requester database, an information requester database having the configuration of the same information element, information item, and code information for retrieval and check as the information record and requested database is generated.

(B) In the information requester database generated in the method of (A) of the procedure 1-15 described above, an area sequentially storing the code or the URL address identifying the information requester, and assigned in advance to the information requester after being selected as the request information is set in the column for input of the information name defined in the above mentioned step 1-5 as shown in FIG. 35.

(C) Otherwise, a storage area is set for a retrieval identifier corresponding to the information element held in the information record and requested database and all information codes for retrieval and check, and the code for identification of an information requester assigned in advance to the information requester who selects the information as request information or the URL address of the information requester is sequentially stored.

(D) The generated information requester database is stored in the storage area of the information providing subject side server computer 2.

1-16. When the information record and requested database is updated,

(A) Except that the identifier described in (C) of the above mentioned step 1-6 is converted into ‘%O%’ indicating an information provider database, and except that the expression of ‘providing’ in the information item name entry column is replaced with the expression of ‘request, the information provider database is updated with the code for identification of the information providing requester assigned to the information providing requester with the information selected as providing request information, or the URL address information about the information providing requester having the configuration of the same information element, information item, and code information for retrieval and check as the updated information record and requested database, and stored in the column for the information name in the information record and requested database.

(B) Otherwise, a new information provider database is sequentially updated with a storage area set for a retrieval identifier corresponding to the information element held in the information record and requested database and all information codes for retrieval and check, and the code for identification of an information providing requester assigned in advance to the information providing requester who selects the information as providing request information or the URL address of the information providing requester sequentially stored.

1-17. When the information record and requested database are updated, as shown in FIG. 33

(A) Except that the identifier described in (C) of the above mentioned step 1-6 is converted into ‘%R%’ indicating an information requester database, the information requester database is updated with the code for identification of the information requester assigned in advance to the information requester with the information selected as request information, or the URL address information about the information requester having the configuration of the same information element, information item, and code information for retrieval and check as the updated information record and requested database, and stored in the column for the information name in the information record and requested database.

(B) Otherwise, a new information requester database is sequentially updated with a storage area set for a retrieval identifier corresponding to the information element held in the information record and requested database and all information codes for retrieval and check, and the code for identification of an information requester assigned in advance to the information requester who selects the information as request information or the URL address of the information requester sequentially stored.

Step 2. Generating an Information Provider Database and Recording Providing Information

2-1. FIG. 32 shows the system of generating an information provider database and an information requester database in association with the generation and amendment of the information record and requested database according to an embodiment of the fourth invention. At least one information providing subject side server computer 6 declaring the correspondence to the information provider database and the system of generation of information requester database according to an embodiment of the fourth invention is connected to the Internet 1. An information providing subject information device 8 or the user computer of the information provider is connected to the Internet 1.

2-2. The information device 4 of an information provider downloads the computer program for generation of an information provider database and the generated information provider database through the Internet 1 from the storage area of the information providing subject side server computer 6, calls them on the information providing home page, and records the providing request information in the information provider database according to the following procedure as shown in FIGS. 35 and 38.

(A) The generated information provider database is called.

(B) Providing information items and a plurality of options corresponding thereto are displayed on the information providing home page, and the information provider is prompted to select one or more options from among a plurality of options as a response to the corresponding items.

(C) The information provider opens a dialog box according to the order of the displayed item selection, and selects a necessary item from a list of the items to be selected displayed on the dialog box (hereinafter referred to as an input box).

(D) The information provider sequentially selects and inputs necessary providing information by an operation of selecting an option displayed on the screen while referring to the information provider database at an instruction of the input box. The information not to be selected is ignored, and control is passed to the next item.

(E) When all information is completely selected, for the items recognized as necessary by the information provider, the code for identification of the information providing requester assigned in advance to the information providing requester with the information selected as providing request information, or the URL address of the information providing requester are sequentially stored in the area for input of the information name of the selection item.

2-3. Otherwise, the providing request information is recorded in the information provider database in the following procedure.

(A) For the selected option and the item, the identifier and code indicating the priority information for retrieval and check are sequentially generated and stored.

(B) When all information selection and input are completed, the information about the address of the information corresponding to the information provider database is added.

(C) The information generated in the procedures shown in (A) and (B) above is stored in the information providing subject side server.

(D) The generated code information is replaced with the URL.

(E) The replaced URL is published on the Internet, the URL of the corresponding information requester database using an identifier as a key is retrieved, the internal code is checked, the matching information requester information is displayed on providing information description home page of the information provider.

2-4. In this case, the providing request information is recorded in the information provider database in the following procedure. FIG. 38 shows the process of generating the information provider database according to an embodiment of the fourth invention.

In this example, the information providing requester selects a ‘sterilizing cleaner’ and ‘hand protector’ cleaner from among ‘notions’, ‘kitchenware’, and ‘cleaners’. When plural pieces of providing request information are set, a repetitive information recording process is performed in the similar procedure.

(A) calling a generated information provider database provided by the ∘∘∘ supermarket;

(B) specifying ‘Z-th sales’ which is the sales tile for the time being from the providing information class 1;

(C) automatically selecting the corresponding code ‘03’;

(D) selecting the type of information to be provided, that is, ‘notions’ from the providing information class 2;

(E) automatically selecting the corresponding code ‘01 ’;

(F) selecting the contents of the information to be provided, that is, ‘kitchenware’ from the providing information class 3;

(G) automatically selecting the corresponding code ‘01’;

(I) selecting ‘cleaner’ which is the product name of the information to be provided from the providing information class 4;

(J) automatically selecting the corresponding code ‘01’;

(K) selecting the product name of the information to be provided, that is, ‘sterilizingcleaner’, from the providing information class 5;

(L) automatically selecting the corresponding code ‘02’;

(M) selecting ‘hand protector’ indicating the characteristic of the information to be provided from the providing information class 6;

(N) automatically selecting the corresponding code ‘02 ’;

(O) selecting ‘sold out’ indicating the providing style of the information from the providing information basic style;

(P) automatically selecting the corresponding code ‘01’;

(Q) selecting ‘cash’ indicating the reception style of the information from the providing information reception style;

(R) automatically selecting the corresponding code ‘01 ’;

(S) selecting ‘∘∘∘’ as the value of providing information as a requested price;

(T) automatically selecting the corresponding code ‘A’;

(U) selecting ‘∘∘∘’ as the quantity of providing information into the requested quantity;

(V) automatically selecting the corresponding code ‘A’; and

(W) selecting a valid term of the information to be provided by ‘YYMMDD’.

(X) The corresponding code ‘A’ is automatically selected. In this example, up to DD, that is, ‘day’ is specified, but up to the time can be specified (for example, hour, minute, HHMM) in the information provider database.

2-5. When all selection is completed, relating to the item to be recognized by the information provider, the code for identification of the information providing requester assigned to the information providing requester in advance with the information as the providing request information, or the URL address of the information providing requester are stored in the area in which the information name of the selection item is input in the information provider database. In this example, as shown in FIG. 38, the ‘□□□’ indicating the ‘sterilizing cleaner’ to ‘□□□’ indicating the ‘valid term’ are recorded.

2-6. The selected information is classified for each information item using an identifier as a delimiter code ‘¶’ for each determination, or using a character not used or prohibited in the HTML or XML markup language as a delimiter code, replaced with a URL code, and published on the Internet. However, the delimiter code depends of the future development of the international standard of the markup language.

In this case, the information provider database code replaced with the URL is represented as follows.

¶?OR?¶s∘∘∘s¶%0%¶□□□03¶□□□02¶□□□01¶□□□01¶□□]02¶□□□01¶□□□01¶□□□01¶□□□A¶□□□A¶□□

□

2-7. The above mentioned code is used as a retrieval key for simultaneous retrieval and check of a plurality of databases when the information provider database and the information requester database are arranged on a plurality of servers to reduce the load on the servers as indicated by 1-12 of the step 1.

2-8. The input page on which an information provider database has been selected can be stored as a ‘providing information description home page’ in file form as is.

2-9. Using the system according to the fourth invention, the information record and requested database to the information provider database code can be generated in the following procedure.

(A) The programs for generation of an information record and requested database and an information provider database generated in the above mentioned procedure 1 are called to the information device of the information provider.

(B) The items of the providing information recorded in the information record and requested database and a plurality of options corresponding thereto are displayed on the information providing home page, and the information provider is prompted to select one or more options in response to the items.

(C) The information provider selects a necessary item from a list of items displayed to be selected in the displayed item selection order.

(D) The information provider sequentially selects or inputs necessary providing information in the operation of selecting options displayed on the screen in the displayed item selection order. The information not to be selected can be ignored, and control is passed to the next item.

(E) The identifier and code indicating the selected options and the priority information for retrieval and check on the items are sequentially generated and stored.

(F) When information is selected and input, the identifier indicating the information record and requested database is converted into the identifier ‘%O%’ indicating the information provider database.

(G) The generated code information is replaced with the URL.

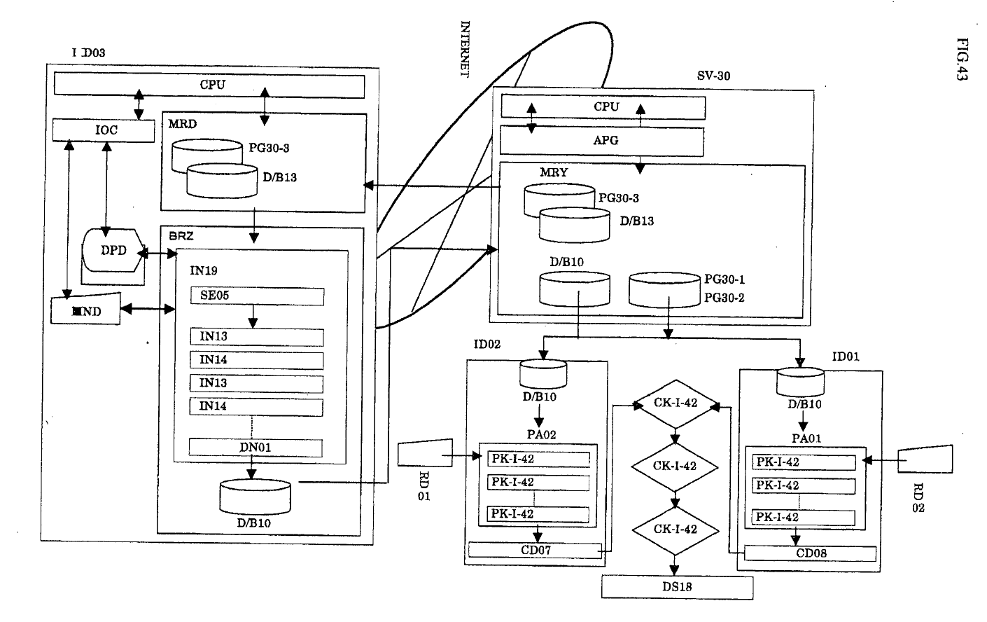

(H) The replaced URL is published on the Internet, the URL of the corresponding information requester database using an identifier as a key is retrieved, the internal code is checked, the matching information requester information is displayed on providing information description home page of the information provider. FIG. 43 shows the system of generating an information provider database code according to an embodiment of the fourth invention.

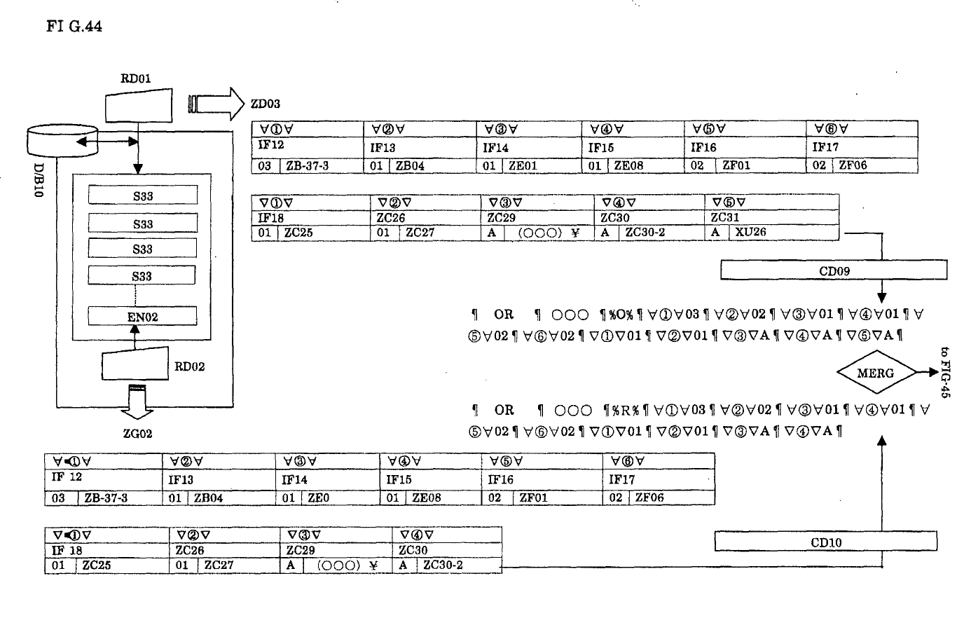

2-10. In this case, the providing request information is generated as the information provider database code in the same procedure as in 2-4 to 2-5 of the above mentioned step 2. The generated information provider database code is the same as the code in 2-6 of the step 2. FIG. 44 shows the process of generating the information provider database according to an embodiment of the fourth invention.

Step 3. Generating an Information Requester Database and Recording Request Information

3-1. FIG. 32 shows the system of generating an information provider database and an information requester database when the information record and requested database is generated and amended according to an embodiment of the fourth invention. At least one information providing subject side server computer 6 declaring the correspondence to the system of generating an information requester database and an information requested database according to the fourth invention is connected to the Internet 1. Then, the information device 8 of the information requester or the user computer of the information requester is also connected to the Internet 1.

3-2. The information provider information device 8 of the information requester downloads the computer program for generation of an information requester database and the generated information requester database from the storage area of the information providing subject side server computer 6 through the Internet 1, and called to the information request home page, and the request information is recorded to the information requester database in the following procedure as shown in FIGS. 35 and 39.

(A) The generated information requester database is called.

(B) Request information items and a plurality of options corresponding thereto are displayed on the information request home page, and an information requester is prompted to select one or more options from among a plurality of options as a response to the corresponding items.

(C) The information requester opens a dialog box in the displayed item selection order, and selects a necessary item from a list of the items to be selected and displayed in the dialog box (hereinafter referred to as an input box).

(D) At an instruction from the input box, the information requester refers to the information requester database, and sequentially selects or inputs necessary request information by performing an operation of selecting an option displayed on the screen. The information not to be selected can be passing to the subsequent items without input.

(E) When all information is completely selected, for the items recognized as necessary by the information requester, the code for identification of the information requester assigned in advance to the information requester with the information selected as request information, or the URL address of the information requester are sequentially stored in the area for input of the information name of the selection item.

3-3. Otherwise, the request information is recorded in the information requester database in the following procedure.

(A) For the selected option and the item, the identifier and code indicating the priority information for retrieval and check are sequentially generated and stored.

(B) When all information selection and input are completed, the information about the address of the information corresponding to the information requester database is added.

(C) The information generated in the procedures shown in (A) and (B) above is stored in the information providing subject server.

(D) The generated code information is replaced with the URL.

(E) The replaced URL is published on the Internet, the URL of the corresponding information provider database using an identifier as a key is retrieved, the internal code is checked, the matching information provider information is displayed on request information home page of the information requester.

3-4. In this case, the request information is recorded in the information requester database in the following procedure. FIG. 39 shows the process of generating the information requester database according to an embodiment of the fourth invention.

In this example, the information requester selects a ‘sterilizing cleaner’ and ‘hand protector’ cleaner from among ‘notions’, ‘kitchenware’, and ‘cleaners’. When plural pieces of request information are set, a repetitive information recording process is performed in the similar procedure.

(A) calling a generated information requester database provided by the ∘∘∘ supermarket;

(B) specifying ‘Z-th sales’ which is the sales tile for the time being from the request information class 1;

(C) automatically selecting the corresponding code ‘03’;

(D) selecting the type of information to be provided, that is, ‘notions’ from the request information class 2;

(E) automatically selecting the corresponding code ‘01’;

(F) selecting the contents of the information to be provided, that is, ‘kitchenware’ from the request information class 3;

(G) automatically selecting the corresponding code ‘01’;

(H) selecting ‘cleaner’ which is the product name of the information to be provided from the request information class 4;

(I) automatically selecting the corresponding code ‘01 ’;

(J) selecting the product name of the information to be provided, that is, ‘sterilizing cleaner’, from the request information class 5;

(K) automatically selecting the corresponding code ‘02’;

(L) selecting ‘hand protector’ indicating the characteristic of the information to be provided from the request information class 6;

(M) automatically selecting the corresponding code ‘02’;

(N) selecting ‘sold out’ indicating the request style of the information from the request information basic style;

(O) automatically selecting the corresponding code ‘01 ’;

(P) selecting ‘cash’ indicating the reception style of the information from the request information reception style;

(Q) automatically selecting the corresponding code ‘01’;

(R) selecting ‘∘∘∘’ as the value of providing information as a requested price;

(S) automatically selecting the corresponding code ‘A’;

(T) selecting ‘∘∘∘’ as the quantity of providing information into the requested quantity;

(U) automatically selecting the corresponding code ‘A’; and

3-5. When all selection is completed, relating to the item to be recognized necessary by the information requester, the code for identification of the information requester assigned to the information requester in advance with the information as the request information, or the URL address of the information requester are stored in the area in which the information name of the selection item is input in the information requester database. In this example, as shown in FIG. 39, the ‘□□□’ indicating the ‘sterilizing cleaner’ to ‘□□□’ indicating the ‘request amount’ are recorded.

3-6. The selected information is classified for each information item using an identifier as a delimiter code ‘¶’ for each determination, or using a character not used or prohibited in the HTML or XML markup language as a delimiter code, replaced with a URL code, and published on the Internet. However, the delimiter code depends of the future development of the international standard of the markup language.

In this case, the information requester database code replaced with the URL is represented as follows.

¶?OR?¶s∘∘∘s¶%R%¶□□□03¶□□□03¶□□□01¶□□□01¶□□□02¶□□□02¶□□□01¶□□□01¶□□□A¶□□□A¶

3-7. The above mentioned code is used as a retrieval key for simultaneous retrieval and check of a plurality of databases when the information provider database and the information requester database are arranged on a plurality of servers to reduce the load on the servers as indicated by 1-12 of the step 1.

3-8. The input page on which an information requester database has been selected can be stored as a ‘request information description home page’ in file form as is.

3-9. Using the system according to the fourth invention, the information record and requested database to the information requester database code can be generated in the following procedure.

(A) The programs for generation of an information record and requested database and an information requester database generated in the above mentioned step 1 are called to the information device of the information requester.

(B) The items of the request information recorded in the information record and requested database and a plurality of options corresponding thereto are displayed on the information request home page, and the information requester is prompted to select one or more options in response to the items.

(C) The information requester selects a necessary item from a list of items displayed to be selected in the displayed item selection order.

(D) The information requester sequentially selects or inputs necessary request information in the operation of selecting options displayed on the screen in the displayed item selection order. The information not to be selected can be ignored, and control is passed to the next item.

(E) The identifier and code indicating the selected options and the priority information for retrieval and check on the items are sequentially generated and stored.

(F) When information is selected and input, the identifier indicating the information record and requested database is converted into the identifier ‘%R%’ indicating the information requester database.

(G) The generated code information is replaced with the URL.

(H) The replaced URL is published on the Internet, the URL of the corresponding information provider database code using an identifier as a key is retrieved, the internal code is checked, the matching information provider information is displayed on request information description home page of the information requester. FIG. 43 shows the system of generating an information requester database code according to an embodiment of the fourth invention.

3-10. In this case, the request information is generated as the information requester database code in the same procedure as in 3-4 to 3-5 of the above mentioned step 3. The generated information requester database code is the same as the code in 3-6 of the step 3. FIG. 44 shows the process of generating the information requester database according to an embodiment of the fourth invention.

Step 4. Step of Retrieving and Checking an Information Provider Database and an Information Requester Database

4-1. The information provider database generated and recorded in the above mentioned step 2 and the information requester database generated and recorded in the above mentioned step 3 are retrieved and checked in the following procedure as shown in FIGS. 40 and 41.

(A) When providing request information is recorded in the information provider database, or when request information is recorded in the information requester database,

(B) if the area assigned the same information name as the partner database is searched using a retrieval identifier added to the last selection item of each database and the code assigned to the information item name as retrieval keys, and

(C) if a code for identification of an information requester assigned in advance to the information requester selected with the information as providing request information, or the URL address of the information provider are stored in the area, or the code for identification of an information requester assigned in advance to the information requester selected with the information as request information, or the URL address of the information requester are stored in the area,

(D) then the information device of the partner is notified of the presence of the corresponding providing request information or the request information, and simultaneously, the code identifying the partner with ‘The corresponding information is described as follows.’, or the URL address list of the partner is displayed.

4-2. In the retrieving and matching procedure shown in the above mentioned step 4-1, if the code for identification of the partner or the URL address of the partner is not stored, then the retrieving and checking processes are continued in the following procedures.

(A) In the retrieval priority predetermined in the step shown in 1-7 of the step 1, the area of the partner database assigned the same information name as the code determined by the identifier having the next priority is retrieved and checked, the area of the information provider database and the area of the information requester database is compared with each other, and the record code of the information requester in the area or the URL of the information requester exists in the area, or the record code of the information requester or the URL address of the information requester exists in the area, then the information device of the partner is notified of the existence of the providing request information or the request information, and simultaneously, the code identifying the partner with ‘The corresponding information is described as follows.’, or the URL address list of the partner is displayed.

(B) If there is no code or address in the area of the partner, the area of the partner database assigned the same information name as the code determined by the identifier having the next priority is retrieved and checked, and, if no matching result is output, the area of the partner database assigned the same information name as the code determined by the identifier having the lower priority is retrieved and checked.

(C) Thus, to obtain a matching result, the corresponding area is retrieved and checked until the record code of the information provider or the URL address of the information provider can be found in the code area determined by the identifier having a lower priority, or the record code of the information requester or the URL address of the information requester can be found in the corresponding area. The providing information or request information having a matching code is transmitted to the information device of the partner by notifying that there is a corresponding providing request information or request information, and simultaneously the code identifying the partner matching ‘the corresponding information is described as follows.’, or the URL address list of the partner is displayed.

FIG. 40 shows the outline of the retrieval and checking process of the information provider database and the information requester database according to an embodiment of the fourth invention. FIG. 41 shows the details of the retrieval and checking process of the information provider database and the information requester database according to an embodiment of the fourth invention.

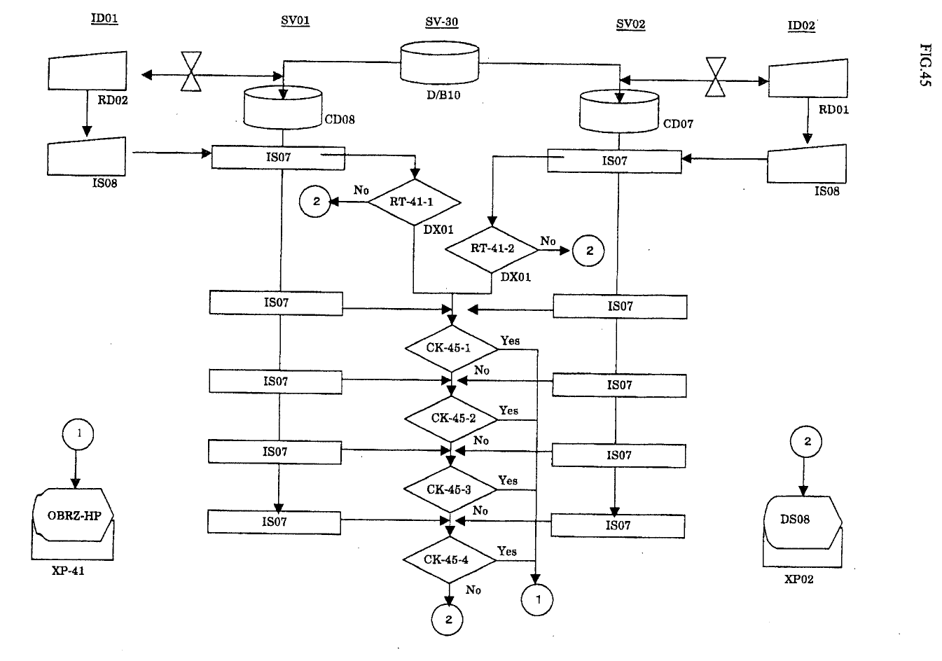

4-3. The URL-converted information provider database code and the information requester database code generated in the procedure shown in 2-6 and 2-9 of the step 2 and 3-6 and 3-9 of the step 3 are retrieved and checked in the procedure described below. FIG. 45 shows the details of the retrieval and checking process of the information provider database code and the information requester database code according to an embodiment of the fourth invention.

4-4. The URL-converted information provider database code published on the Internet is compared in the procedure below with the URL-converted information requester database published on the Internet, and the information matching the request is displayed on the browser of the information provider and the information requester. Otherwise, a list of the home pages describing the matching providing information or the home pages of the information requesters is displayed on the browser on both sides, or the URL of the home page describing the providing information matching the request is returned to the information requester in MAIL text.

4-5. The retrieval program in the system according to the fourth invention determines the protocol such that it can be detected when the information provider database code having the identifier ‘%O%’ and the information requester database code having the identifier ‘%R%’ appear on the network.

4-6. Furthermore, when an information provider database is generated, a character string in the URL of the information requester database having the information segmented by an identifier indicating a target information providing subject, and the identifier ‘%R%’ is retrieved, the character string in the URL of the information requester database code having the same identifier as the according to identifier is extracted using the identifier as a retrieval key, and is compared with its own code.

4-7. When an information requester database is generated, a character string in the URL of the information provider database having the information segmented by an identifier indicating a target information providing subject, and the identifier ‘%O%’ is retrieved, the character string in the URL of the information provider database code having the same identifier as the according to identifier is extracted using the identifier as a retrieval key, and is compared with its own code.

4-8. The priority of the matching process when the above mentioned steps 4-6 and 4-7 are used is described below.

4-9. First, when the highest priority retrieval item is preset, the code determined by the identifier having the highes priority is retrieved and checked by highest priority.

4-10. When both codes do not match in the above mentioned step 4-9, the code determined by the identifier having the second highest priority is retrieved and checked, and, if no matching result is detected, the code determined by an identifier having a lower priority is retrieved and checked.

The code determined by the identifier having a lower priority is retrieved and checked until a matching is detected, and providing information having the matching code or the home page describing the providing information is displayed on the browser of the information requester.

4-11. Otherwise, the list of the URL of the home page describing the providing information having a matching code is displayed on the option of the information requester with a display area prepared.

4-12. Furthermore, to the information provider, the URL of the information requester matching the providing information is displayed on the browser of the information provider.

4-13. On the other hand, if no matching information page can be detected after the checking process up to the predetermined identifier level, the message ‘no matching information’ is displayed.

4-14. If a matching code is detected in the above mentioned checking process, a further information retrieving process is performed by selecting the target information using a predetermined identifier.

4-15. When the information provider database code matches the information requester database code, or when no matching is detected, it is displayed on the browsers of the information provider and the information requester.

4-16. If a plurality of targets are selected in the retrieving process, the information requester has the function of specifying the display order ‘from the earliest’ or ‘from the least expensive’.

4-17. In the XML using environment, a character string replaced by assigning an identifier is used as a tag having the function of a retrieval key, the identifier is specified as an attribute name using a command for extraction in the XML environment, and the WEB having the same identifier as the request code is called and displayed on the browser.

4-18. In the XML environment, the retrieval order starts with the retrieval of the code indicated by the identifier having a predetermined priority as described in the steps 4-9 to 4-16, and the retrieving process is performed using the priority in the order of the code indicated by the identifier determined for selection and retrieval.

### INDUSTRIAL APPLICABILITY

In the information retrieving method using the information providing database and the information requested database according to the first invention, an the Internet user obtains the following effects.

1) An information requester can take the initiative in collecting information.

2) Since request information can be easily recorded, any user can quickly obtain desired information.

3) Since request information can be easily recorded on the information request home page, and can be recorded in a catalog, any user can set a desired database portal site.

4) Since a home page is retrieved using an information element, a retrieving process can be performed at a much higher speed than the entire text logical recognizing method using a net browsing robot.

5) The existence of desired information can be immediately checked without visiting the portal site, and the desired information can be immediately displayed.

6) Since the information provider shows the essence of the information, more correct information can be obtained than the information collected by a net browsing robot.

7) Since unified information items and corresponding options are retrieved, the minimal information interchange is performed, or the information can be provided depending on the appliance characteristic of the partner, a system having a limited display facility such as a mobile phone and a portable information terminal can access desired information without inconveniences.

8) Using unified information items and the corresponding options, the request information or providing information described in English or each language can be automatically translated into a specified language by referring to databases. Therefore, the product information can be quickly communicated among the countries of different languages.

Furthermore, according to the information providing database generating method and the information requested database generating method according to the second invention, the information providing database and the information requested database can be easily separated and generated from one basic database without changing the recorded contents, and a retrieval identifier can be set. By separating two databases which can be retrieved from each other and providing a code and retrieval identifier in them, a prescribed information item is not data itself, but an address, for example, a URL, an XML, etc. indicating the location of the data. Conventionally, data has to be stored in a database, and a retrieving process is performed by specifying and checking data in the database. On the other hand, according to the present invention, it is not necessary to record data in a database, but a code is externally generated, and is checked outside the database. Thus, a database can be easily generated and updated with a reduced load.

Thus, only the retrieval identifier and the code has to be managed in the information providing database and the information requested database, and the data management structure can be flexibly designed, thereby quite easily updating the database when a large volume of data is frequently updated.

That is, when the information providing database and the information requested database are generated according to the second invention, a user-set code system can be used in addition to a predetermined code system, and the code system can be easily updated.

Furthermore, according to the information providing database and the information requested database generating methods according to the third or fourth invention, the information providing database and the information requested database are separately designed, and a retrieval identifier is set. By separating two databases which can be retrieved from each other and providing a code and retrieval identifier in them, a prescribed information item is not data itself, but an address, for example, a URL, an XML, etc. indicating the location of the data.

Thus, only the retrieval identifier and the code has to be managed in the information providing database and the information requested database, and the data management structure can be flexibly designed, thereby quite easily updating the database when a large volume of data is frequently updated.

That is, when the information providing database and the information requested database are generated according to the third or fourth invention, a user-set code system can be used in addition to a predetermined code system, and the code system can be easily updated.

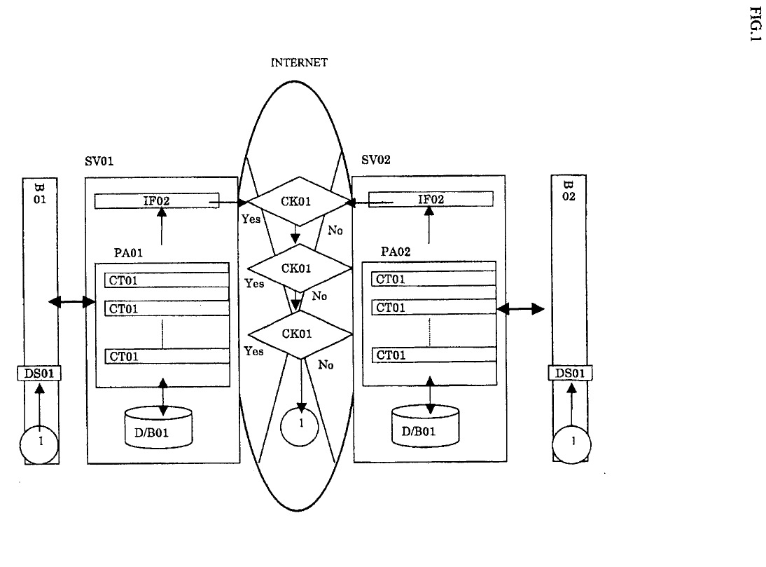

### FIG. 1

Abbrev.

SV01 Server computer of information requestor side

SV02 Server computer of information provider side

B01 Browser of information requestor side

B02 Browser of information provider side

IF02 URL converted information

PA01 Home page of information requesting

PA02 Home page of information provided

CT01 Information contents with identifier

CK01 Checking of information contents

D/B01 Common database

DS01 Display

Yes YES

No NO

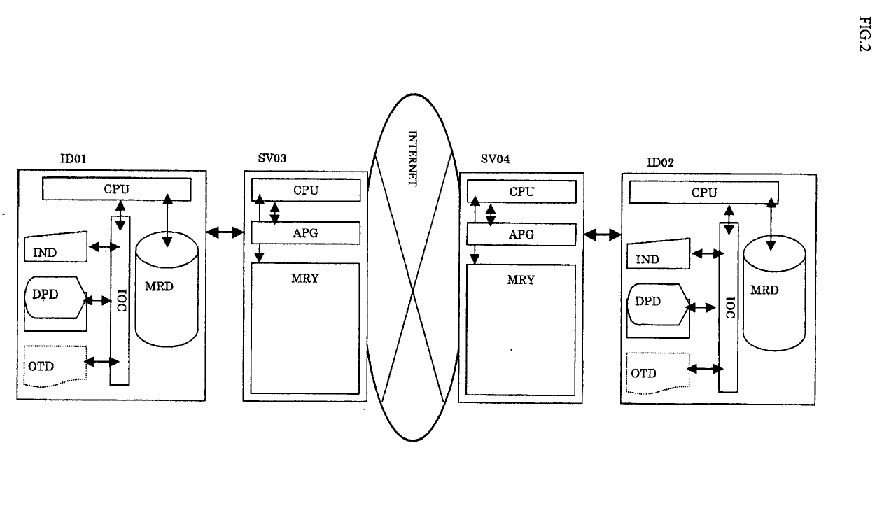

### FIG. 2

Abbrev.

ID01 Information requester side information device

ID02 Information provider side information device

SV03 Server computer of information requestor side supporting the present invention system

SV04 Server computer of information provider side supporting the present invention system

CPU Main control unit

IND Input device

DPD Display device

OTD Ourput device

IOC Input/output control unit

MRD Storage unit

APG Drive program

MRY Memory (storage area)

### FIG. 3

Abbrev.

PA03 Information requesting Home Page

DS02 Display of items for generating an information requested D/B and options

IN01 Input of information requestor's attribute I

IN02 Input of information requestor's attribute II

IN03 Input of requesting information base

IN04 Input of requesting information details

IN05 Input of request detail-classification

IN06 Input of sender system's attribute

DN01 Designation of input end

CV01 Convertion of information element into URL converted information

CM01 Instruction command of server computer control

IS01 Instruction of sorting

IS02 Instruction of conversion into URL

IS03 Disclosure for internet/Instruction of retrieving

IS04 Instruction of re-naming

CL-DS Calling/Display

RF01 Reference of D/B

AD01 Addition of identifier to information requested information contents

BA01 Buffer area for input or information requested information contents

ST01 Sorting of information requesting information contents

GN01 Generating URL with URL converted information

CV02 Convertion of URL into sub-index

DC01 Disclose on Internet

BRZ Browser

DLD Down load

IRPG Program for generation of an information requested D/B

IRDB D/B for generation of an information requested D/B

### FIG. 4 (1/2)

Abbrev.

FQ01 Formatting of information requested D/B generation on information requester side information device browser

GN02 Generating information requested HP

S01 Selection of information requestor's attribute I

XA01 Individual

XA02 Group/circle of like

XA03 Nonprofit organization/Nongovernmental organization

XA04 Media and journalism

XA05 Government and other public offices/station

XA06 Official body

XA07 Academic juridical person

XA08 Religious corporation

XA09 Medical corporation

XA10 Agricultural organization

XA11 Co-op

XA12 Labor organization

XA13 Business organization

XA14 Business juridical person

S02 Selection of information requestor's attributte II—Sex

S03 Selection of information requestor's attributte II—input of age

XB01 “Input your age (half-width numerics)”.

S04 Selection of information requestor's attributte II—Selection of profession

XC01 Proprietor

XC02 Executive

XC03 Senior managerial positions

XC04 Medium managerial positions

XC05 Ordinary business person

XC06 Temporary staff

S05 Selection of information requestor's attributte II—Input of annual earnings

XD01 “Please input your annual income (half-width numerics)”.

S06 Selection of information requestor's attributte II—Selection of hobby/taste

D/B02 D/B for generating an, information requested D/B

TB01 Table for selection of information requestor's attribute I

TB02 Table for selection of sex

TB03 Table for selection of profesions

TB04 Table for selection of hobbies

BA02 Buffer area

### FIG. (2/2)

Abbrev.

S-Z4 Information requestor's server computer declared as corresponding to the present invention system

OTR Others

MEN M (Male)

WMN F (Female)

AGE Age

SPT Sports

BSB Baseball

SCR Soccer

SKI Skiing

SNB Snowboard

SKT Skating

ALN Individual

GRP Group

AGE Age

PCD Occupation code

INC Annual income

HCD Hobby/taste code

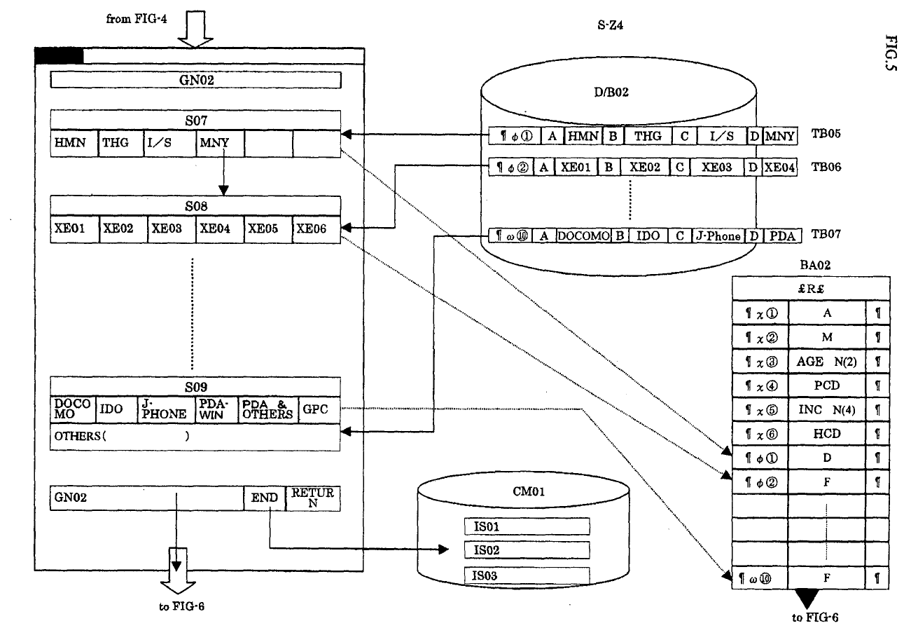

### FIG. 5

Abbrev.

S07 Selection of basic requesting information

S08 Selection of specific requesting information

XE01 Information to want to get soon

XE02 Stock/investment trust information

XE03 Interest/foreign exchange

XE04 Corporate bond/public bond

XE05 Commodities market

XE06 Financial products

S09 Selection of attributte of information requestor's system

GN02 Generating information requested HP

D/B02 D/B for generating an information requested D/B

TB05 Table for selection of requesting information basic

TB06 Table for selection of requesting information specific

TB07 Table for selection of attitude of information requestor's system

CM01 Instruction command of server computer control

HMN Human

THG Things

I/S Information/service

MNY Money

GPC General personal computer

S-Z4 Information requestor's server computer declared as corresponding to the present invention system

IS01 Instruction of sorting

IS02 Instruction to convert into URL

IS03 Instruction of internet disclosure and retrieving

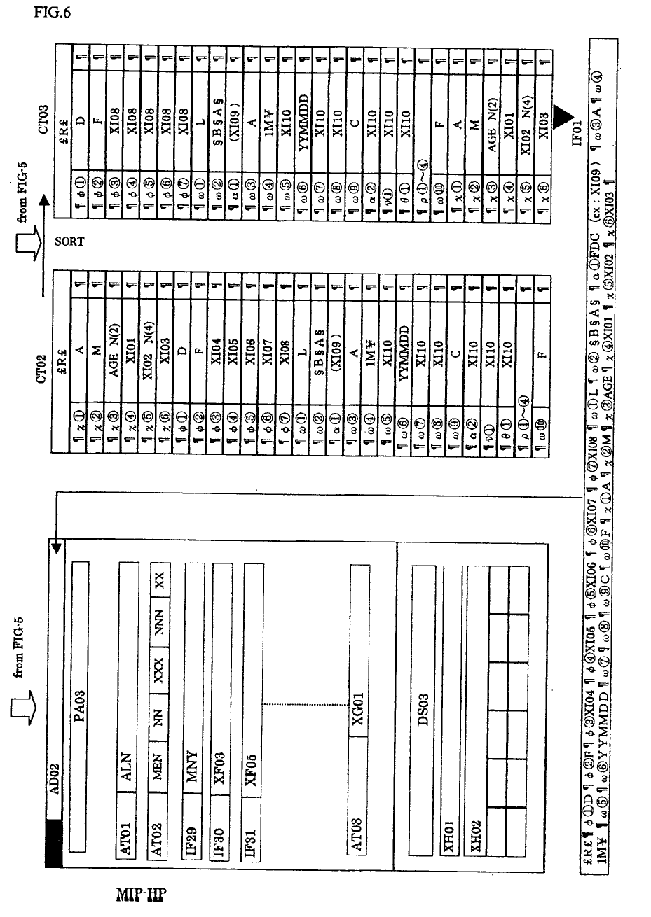

### FIG. 6

Abbrev.

AD02 Addition of URL converted information to URL

AT01 Attribute I of information requester

AT02 Attribute II of information requestor

IF29 Request information base

IF30 Requesting information statement

XF03 Information for each financial products

IF31 Request information details

XF05 Foreign currency deposit

AT03 Attribute of information requestor's system

XG01 General personal computer

DS03 Display of an information requested retrieving results

XH01 “No infromation providing corresponding to information requested contents”.

XH02 “Information providing corresponding to information requested contents”.

CT02 Information contents in buffer area

CT03 Information contents sorted

XI01 Occupation code

XI02 Annual income

XI03 Hobby/taste code

XI04 Foreign money deposit code

XI05 Dollar basis code

XI06 Foreign money deposit product code

XI07 Projected earnings

XI08 Code of capital safe

XI09 Capital safe

xI10 anonymous

IF01 URL converted information of information requested contents

PA03 Information requesting Home Page

ALN Individual

MNY Money

1M¥ One million yen

FDC Free comment

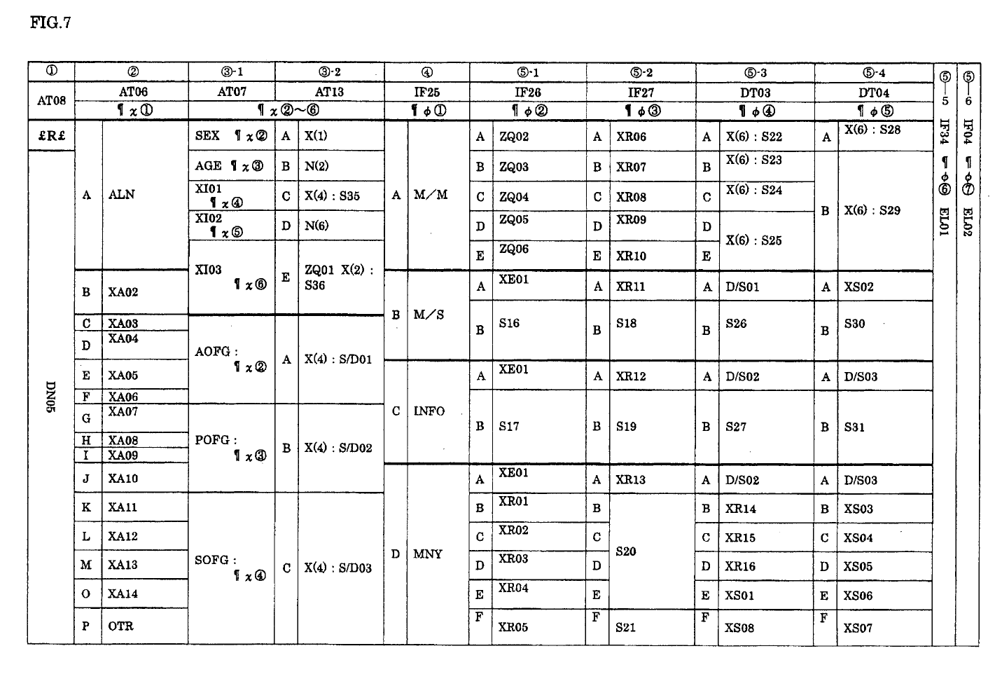

### FIG. 7 (1/3)

Abbrev.

AT08 Basic attribute

DN05 Received file=Designation of R code

AT06 Attribute I of receiver

AT07 Attribute II of receiver

AT13 Classification of Attribute II

IF25 Requested information base

IF26 Requested information statement

IF27 Requested information—details

DT03 Request detail—classification

DT04 Request detail—fragmentation

S35 Selection among D/B of profession

ZQ01 Sports, music, car, travel etc.

S36 Selection among D/B of hobby

S/D01 Selection among D/B of characters or description of characters with free sentence

S/D02 Selection among D/B of purposes or description of purposes with free sentence

S/D03 Selection among D/B of sizes or description of other notes with free sentence

ZQ02 Intellectual result

ZQ03 Personal attribute

ZQ04 Intellectual ability

ZQ05 Specialty

ZQ06 Others

S16 Selection among D/B of industrial fields, for example, life/food/fashion/leisure/hobby

S17 Selection among D/B of industrial fields, for example, administration/business/life/leisure/culture

XR01 Information of stocks and investment trust

XR02 Interest/foreign exchange

XR03 Corporate bond/public bond

XR04 Commodities market

XR05 Financial products

XR06 Opinion/argument/article/critique

XR07 Charm/physical ability

XR08 Fundamental academic achievement/Specialty knowledge/Performing a task ability

XR09 Professional skill of each specialty field

### FIG. 7 (2/3)

Abbrev.

XR10 Human network

XR11 Auction/sale

S18 Selection among D/B of maker's names/manufacturer's names

XR12 Disaster report/weather report

S19 Selection among D/B of information provider's names

XR13 Economy news/foreign exchange

S20 Selection among D/B of measurement about present status, prediction, bond rating, corporate performance

S21 Selection among industrial fields

S22 Selection among D/B of industrial fields

S23. Selection among D/B of appeal details

S24 Selection among D/B of adaptation

S25 Selection among D/B of fields details

D/S01 Designation and selection among providing firms' names

S26 Selection among D/B of goods' names or brand's names

D/S02 Designation and selection among providing information firms

S27 Selection among D/B of providing information's names

XR14 Domestic market

XR15 Condition of domestic market

XR16 Oversea market

XS01 Condition of oversea market

XS08 Fields—small sort (class 3)

S28 Selection among D/B of authors

S29 Selection among D/B of ability details

XS02 Goods name or event name

S30 Selection among D/B of goods=goods' names or goods' codes variously defined by firms

D/S03 Designation and selection among providing information's names

S31 Selection among D/B of information codes=codes variously defined by firms

XS03 Each brand

XS04 Each corporation

XS05 Each market

XS06 Each index

XS07 Each financial product

IF34 Request information—fine classification

EL01 Information elements showing character of each goods, services, and informations

IF04 Request information—finest classification

### FIG. 7 (3/3)

Abbrev.

EL02 Information elements showing concrete contents of each goods, services, and informations

AOFG Characteristic of group or juridical person

POFG Purpose of group or juridical person

SOFG Size of group or juridical person

M/M Human/Encounter

M/S Things/Service

INFO Information

MNY Money

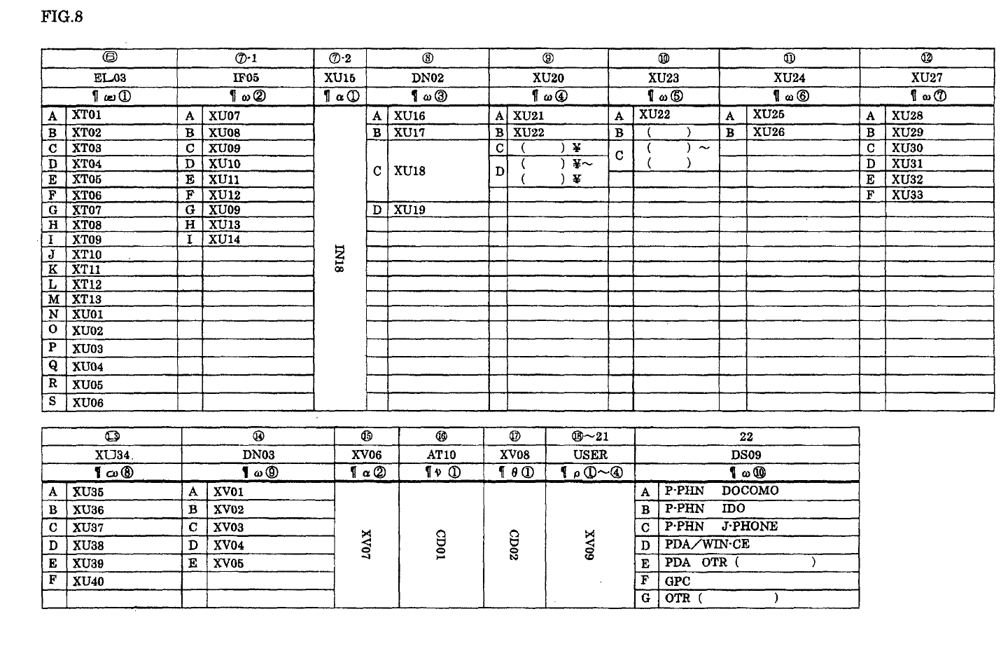

### FIG. 8 (1/2)

Abbrev.

EL03 Request information base element

XT01 Request to communicate

XT02 Request to meet

XT03 Recruitment

XT04 Request to be lent with charge

XT05 Request to be lent without charge

XT06 Request to buy

XT07 Request to sell

XT08 Request to have it

XT09 Request to exchange

XT10 Request to test

XT11 Request to know with charge

XT12 Request to know without charge

XT13 Request to learn with charge

XU01 Request to learn without charge

XU02 Request to receive with charge

XU03 Request to receive without charge

XU04 Request to cooperate

XU05 Request to receive an estimate

XU06 Others

IF05 Requested information distribution constitution

XU07 Request to have electronic mail

XU08 Request to have a guide

XU09 Request to have a meeting

XU10 Request to go and see it

XU11 Request to go and take it

XU12 Request a delivery

XU13 Request to receive a sample

XU14 Others

XU15 Comment

IN18 Input of free sentence: comment to 5), 6) or 7)

DN02 Specifying information request range

XU16 Restriction to Japan

XU17 Restriction to ◯◯◯ state

XU18 Designation to ◯◯◯ domestic district (Designation of ZIP)

XU19 Others

XU20 Requested price

XU21 No charge

### FIG. 8 (2/2)

Abbrev.

XU22 No designation

XU23 Request quantity

XU24 Term of information request

XU25 No time limit

XU26 By the date (YYMMDD)

XU27 Distribution method

XU28 Home delivery

XU29 Convenient store resting

XU30 Mailing

XU31 Request to go and take it

XU32 Transmission to designated store

XU33 Transmission to designated place

XU34 Payment method

XU35 Change

XU36 Credit card

XU37 Cash on delivery

XU38 Funds transfer after receiving of goods

XU39 Funds transfer after checking of goods

XU40 Others

DN03 Reply information specification

XV01 All pages

XV02 Only needed pages

XV03 Only needed items

XV04 Request to answer by E-mail

XV05 Others

XV06 Summary

XV07 Part for describing free sentences summary

AT10 Attribute of file

CD01 Code to designate file attribute of still image, animation, and sound to send

XV08 Home page requested

CD02 Selection code of home page requested pattern

XV09 Area which user can define freely

DS09 Display of attribute for requetor's system

P-PHN Handy phone

GPC General personal computer

OTR Others

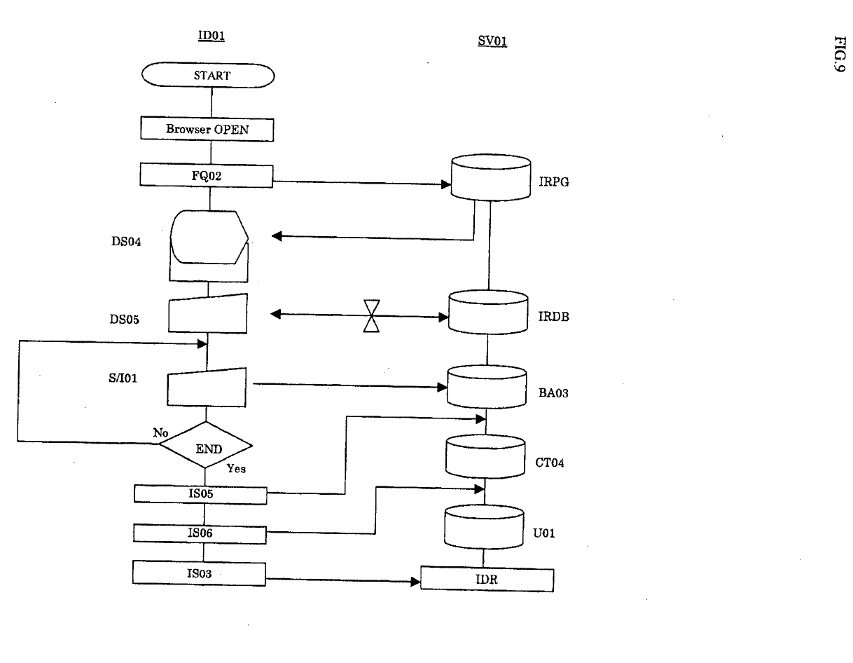

### FIG. 9

Abbrev.

FQ02 Calling of formatting of information requested HP input

DS04 Display of information requested HP

DS05 Display of information items and options

S/I01 Selection and input of selection items

END End of procedure

IS05 Instruction of information requested contents sorting

IS06 Instruction of conversion information requested contents into

URL

BA03 Buffer area of information requested contents

CT04 Information requested contents sorted

U01 URL added URL converted information

ID01 Information requester side information device

SV01 Server computer of information requestor side

IRPG Program for generation of an information requested D/B

IRDB D/B for generation of an information requested D/B

BRZ Browser

IS03 Instruction of internet disclosure and retrieving

IDR Internet disclosure and retrieving

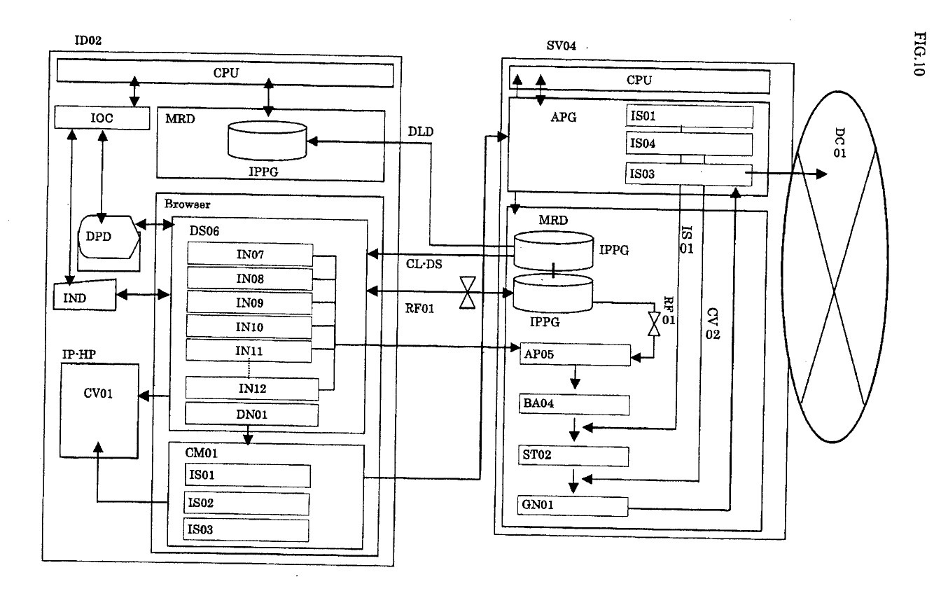

### FIG. 10

Abbrev.

DS06 Display of items for generating an information providing D/B and options

IN07 Input of information provider's attribute I

IN08 Input of information provider's attribute II

IN09 Input of providing information base

IN10 Input of providing information details

IN11 Input of request detail—classification

IN12 Input of user definition area

DN01 Designation of input end

CV01 Conversion of information element into URL converted information

AP05 Addition of identifier to information providing information contents

BA04 Buffer area for input of information providing information contents

ST02 Sorting of information providing information contents

GN01 Generating URL with URL converted information

CV02 Conversion of URL into sub-index

IS04 Instruction of re-naming

ID02 Information provider side information device

CPU Main control unit

IOC Input/output control unit

DPD Display device

IND Input device

IP-HP Information providing HP

MRD Storage unit

DLD Down load

CL-DS Calling/Display

RF01 Reference of D/B

CM01 Instruction command of server computer control

IS01 Instruction of sorting

IS02 Instruction to convert into URL

IS03 Instruction of internet disclosure and retrieving

S04 Server computer of information provider side supporting the present invention system

APG Drive program

IS03 Instruction of internet disclosure and retrieving

IPPG Program for generation of an information providing D/B

IPDB D/B for generation of an information providing D/B

DC01 Disclose on Internet

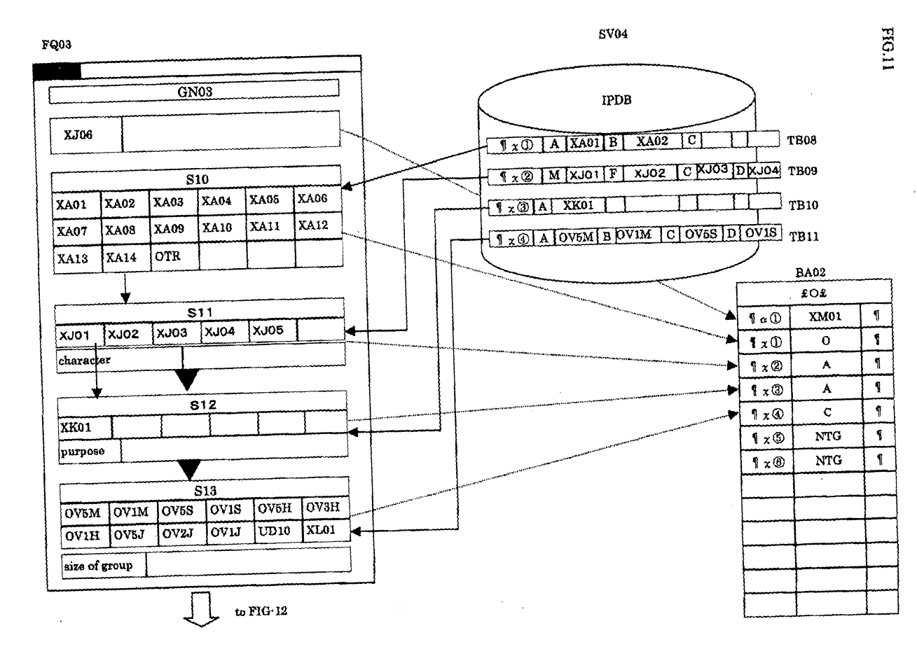

### FIG. 11

Abbrev.

FQ03 Formatting of information providing D/B generation on information provider side information device browser

GN03 Generating information providing HP

XJ06 Title of providing information

S10 Selection of information provider's attribute I

S11 Selection of information provider's attribute II—character of group and legal body

XJ01 Kabushiki Kaisha

XJ02 Limited private company

XJ03 Limited partnership company

XJ04 Ordinary partnership

XJ05 Mutual company

S12 Selection of information provider's attribute II—purpose of group and legal body

XK01 Profit-making business

S13 Selection of information provider's attribute II—size of group and legal body

XL01 Private enterprise

TB08 Table for selection of information provider's attitude I

TB09 Table for selection of information provider's attitude II—character

TB10 Table for selection of information provider's attitude II—purpose

TB11 Table for selection of information provider's attitude II—size

XM01 Free sentence

OV5M Over 50,000 people

OV1M Over 10,000 people

OV5S Over 5,000 people

OV1S Over 1,000 people

OV5H Over 500 people

OV3H Over 300 people

OV1H Over 100 people

OV5J Over 50 people

OV2J Over 20 people

OV1J Over 10 people

UD10 Not over 10 people

NTG Nothing

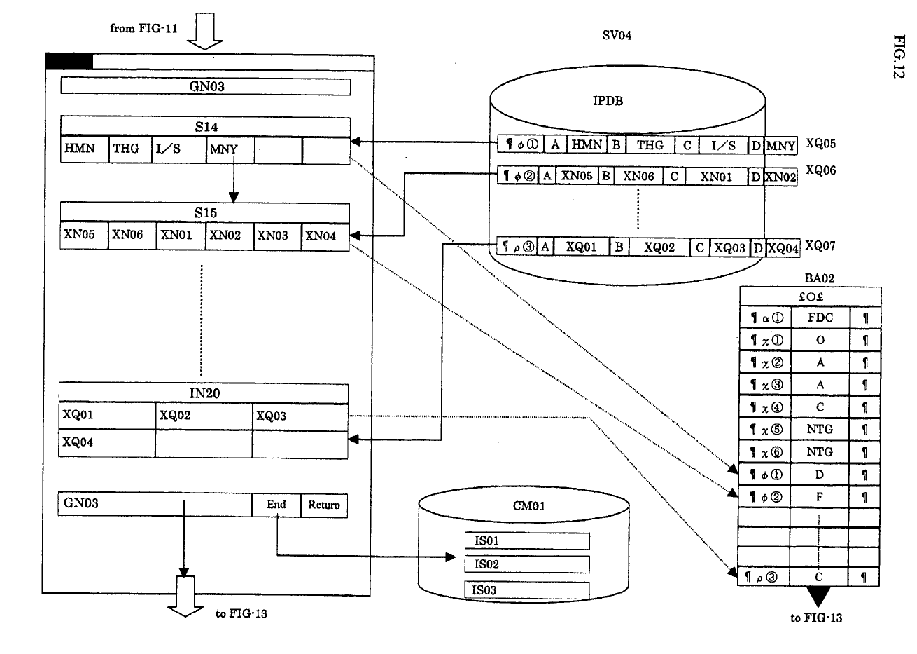

### FIG. 12

Abbrev.

S14 Selection of basic providing information

S15 Selection of specific providing information

XN05 Information to want to get soon

XN06 Information of stocks and investment trust

XN01 Interest/foreign exchange

XN02 Corporate bond/public bond

XN03 Commodities market

XN04 Financial products

IN20 Input of user definition area—selection of campaigns

XQ01 Given favorable treatment to the first ◯◯◯ persons

XQ02 We will send a present to all applicants

XQ03 Charge-free try-on campaign by the date MMDD

XQ04 New customer introduction campaign

XQ05 Table for selection of providing information basic

XQ06 Table for selection of providing information specific

XQ07 Table for selection of sender's system attribute

XQ08 Favorable treatment for first commer

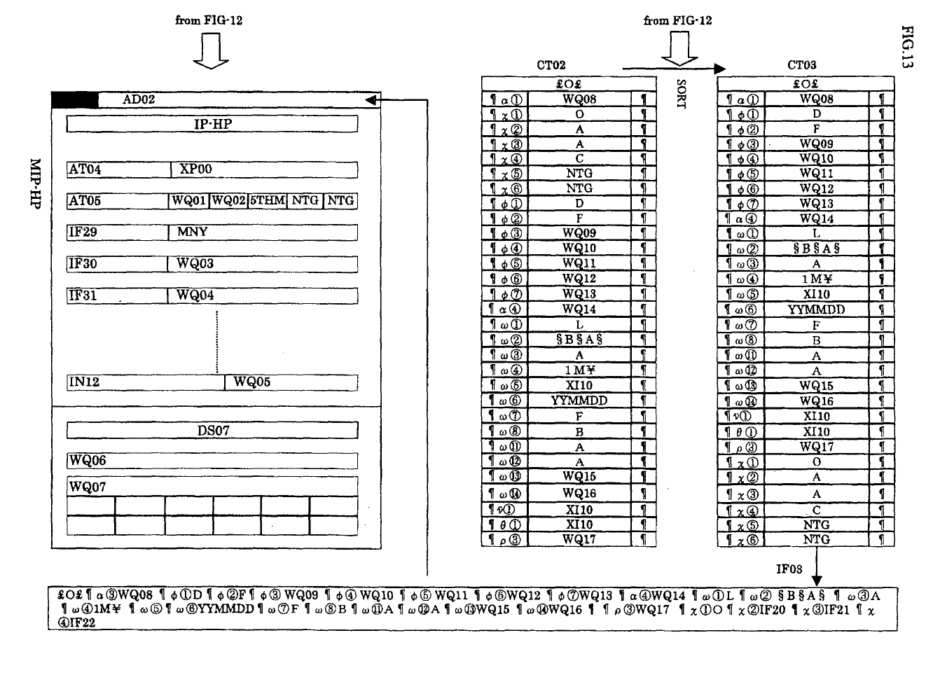

### FIG. 13

Abbrev.

AD02 Addition of URL converted information to URL

AT04 Attribute I of information provider

XP00 Business juridical person

AT05 Attribute II of information provider

WQ01 Kabushiki Kaisha

WQ02 Commercial gain

IF29 Request information base

IF30 Request information statement

WQ03 Information of each financial products

IF31 Request information details

WQ04 Foreign money deposit

IN12 Input of user definition area

WQ05 Charge-free try-on campaign

DS07 Display of an information providing retrieving results

WQ06 “No information corresponding to information providing contents”

WQ07 “Infromation corresponding to information providing contents is as following.”

WQ08 Title: Free sentence

WQ09 Foreign money deposit code

WQ10 U.S. dollar base code

WQ11 Name of foreign money deposit product

WQ12 Estimated yield of 5% or more

WQ13 Guaranteed principal code

WQ14 Summary

WQ15 Code of rating agency name

WQ16 Raiting point

WQ17 Campaign code

IF03 URL converted information of information providing products

IF20 Characteristic of the corporation

IF21 Purpose of the corportaion

IF22 Size of the corporation

MIP-HP Information request HP generated

5THM 5,000 people

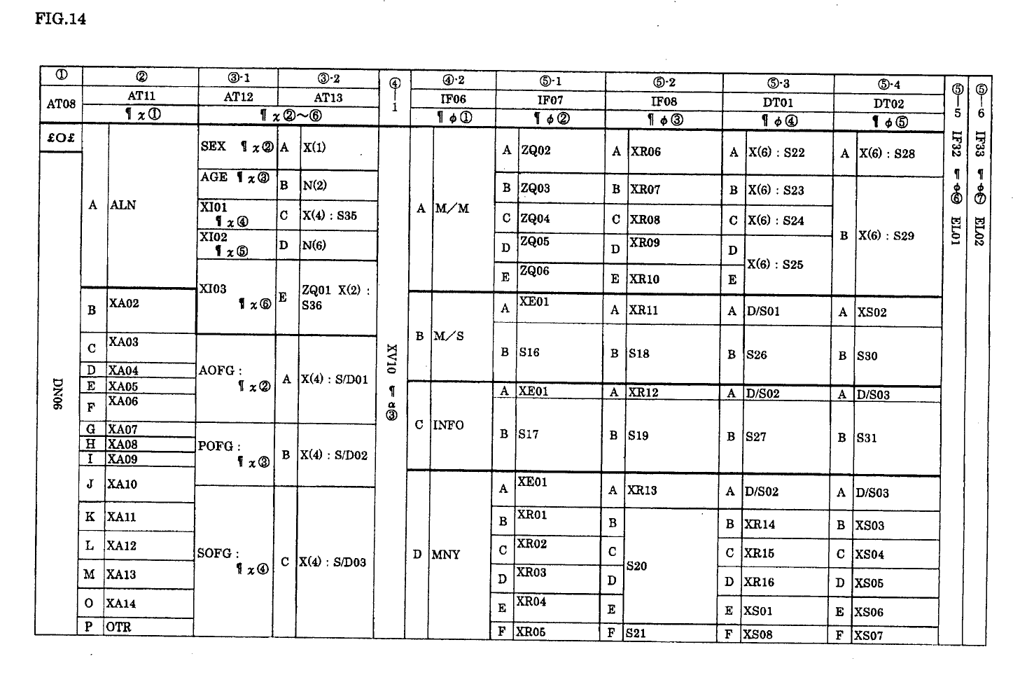

### FIG. 14

Abbrev.

AT08 Basic attribute

AT11 Attribute I of sender

AT12 Attribute II of sender

AT13 Classification of Attribute II

IF06 Providing information—base

IF07 Providing information—statement

IF08 Providing information—details

DT01 Providing details—classification

DT02 Providing detail—fragmentation

DN06 Sending file=Designation of ◯ code

XV10 Title of service and information, etc to provide/Description of free sentences

IF32 Providing information—fine classification

IF33 Providing information—finest classification

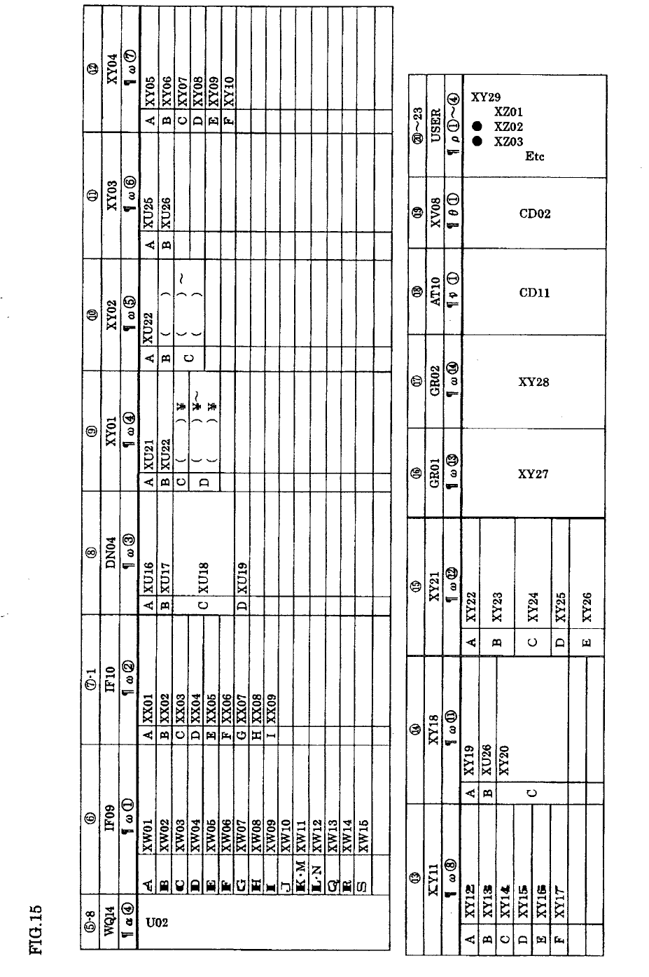

### FIG. 15 (1/2)

Abbrev.

U02 Summary of providing service and information (free sentence) or

URL showing homepage describing providing sevice and information

IF09 Providing information base style

XW01 Communicating

XW02 Meeting

XW03 Recruitment

XW04 Lending with charge

XW05 Lending without charge

XW06 Buying

XW07 Selling

XW08 Giving

XW09 Exchanging

XW10 Testing?

XW11 Teaching with charge

XW12 Teaching without charge

XW13 Cooperating

XW14 Sending an estimate

XW15 Others

IF10 Request information reception style

XX01 Send electronic mail

XX02 Sending a guide

XX03 Let's have a meeting

XX04 Come and see it

XX05 Come and take it

XX06 Coming

XX07 Sending a sample

XX08 Delivering

XX09 Others

DN04 Designation of providing information range

XY01 Providing price

XY02 Providing quantity

XY03 Term of order

XY04 Distribution method

XY05 Home delivery

XY06 Convenient store resting

XY07 Mailing

XY08 Come and take it

### FIG. 15 (2/2)

Abbrev.

XY09 Transmission to designated store

XY10 Transmission to designated place

XY11 Payment method

XY12 Change

XY13 Credit card

XY14 Cash on delivery

XY15 Funds transfer after receiving of goods

XY16 Funds transfer after checking of goods

XY17 Others

XY18 Delivery term

XY19 No time limit

XY20 Fixed period for down loading

XY21 Warranty deed responsibility

XY22 No warranty

XY23 Charge-free change

XY24 Charge-free remedies

XY25 Remedies for value

XY26 Duty of charge defect goods (Yes No)

GR01 Ranking notation I

XY27 Name of rating third party agency

GR02 Ranking notation II

XY28 Rating point

AT10 Attribute of file

CD11 Code to designate file attribute of still image, animation, and sound to send

XY29 User-defined area

XZ01 Prize-winning result

XZ02 Discount privilege

XZ03 campaign

### FIG. 16

Abbrev.

IS07 Instruction of identifier extraction

DS08 Display on browser

xP01 “Information corresponding to information request contents is as following.”

XP02 “No infromation corresponding.”

D/B04 URL converted information requested D/B

IS07 Instruction of identifier extraction

RT01 Retrieving of codes

CK02 Checking of codes

D/B05 URL converted information providing D/B

RT02 Retrieving in network

XP03 “Informations corresponding to information providing contents are as following:”

D/B-IURL Information providing D/B converted into URL

OBRZ Display on browser

XP-NI “No information corresponding.”

### FIG. 18

Abbrev.

PA02 Information providing page

CT01 Information contents with identifier

D/B06 Information providing D/B to retrieval and check

PA01 Information requested page

D/B07 Information requested D/B to retrieval and check

SV01 Server computer of information requestor side

SV02 Server computer of information provider side

B01 Browser of information requestor side

B02 Browser of information provider side

D/B-1 Information requested D/B

D/B-2 Information providing D/B

IF02 URL converted information

M&C Generation/Updating

DS01 Display

CK01 Checking of information contents

Yes YES

CH-ID Change of identifier

### FIG. 20

Abbrev.

PG05 Computer program for generating an information providing D/B

D/B08 D/B for generating an information providing D/B

SE01 Setting of numbers of providing information items

IN13 Input of information item name

IN14 Input of providing information name

DN01 Designation of input end

CH-ID Change of identifier

D/B08-IN Input of name of items and information for generation of information providing D/B

PG05-2 Program for generation of information requested D/B

### FIG. 21

Abbrev.

PG01-1 Computer program for generating an information providing D/B to retrieval and check

DS06 Display of items for generating an information providing D/B and options

DS10 Display of providing information items

S/I02 Selection and input of providing information

AD03 Addition of providing information address

PA04 Home Page where providing information is placed

PA05 Home Page where providing information is described

DS11 Display of a list of providing information selected

DS12 Display of retrieving and checking results

BA05 Buffer area for input of providing information contents

GN01 Generating URL with URL converted information

CV02 Conversion of URL into sub-index

### FIG. 22

Abbrev.

IN15 Input of item numbers

IF28 Information for retrieving and distinction

EL04 First information element

EL05 Second information element

EL06 Third information element

ZA04 Name of information item

EL07 Sixth information element

IR01 Identifier for retrieving

IF11 Code information for retrieving and checking

SE06 Setting of numbers of n of input items

NOFI Name of information

IPI=n The number of items=n

### FIG. 23 (1/2)

Abbrev.

IR02 Identifier showing of corresponding to information retrieving method

IR03 Identifier showing of being ◯◯◯ shopping street providing D/B

IR04 Identifier showing of being information providing D/B

IF12 Providing information class 1 (large)

ZB01 ◯-th sales

ZB02 ⊚-th sales

ZB03 Δ-th sales

IF13 Providing information class 2 (middle)

ZB04 Notions

ZB05 Foods

ZB06 Clothing

ZB07 Furniture

ZB08 Plaything

ZB09 Printed book

ZB10 Infants' outfit

ZB11 Schoolchildren's outfit

ZB12 Accessories

ZB13 Cosmetics

IF14 Providing information class 3 (classification)

ZC01 Fresh foods

ZC02 Cake and other sweet

ZC03 Canned and bottled foods

ZC04 Salted dried fish

ZC05 Rice

ZC06 Bread

ZC07 Delicatessen

IF15 Providing information class 4 (fragmentation)

ZC08 Meat

ZC09 Fish

ZC10 Vegetables

ZC11 Chocolate

ZC12 Gum

ZC13 Cookie

ZC14 Cake

ZC15 Japanese confectionery

ZC16 Steamed bread

IF16 Providing information class 5 (detail)

### FIG. 23 (2/2)

Abbrev.

ZC17 Radish

ZC18 Carrot

ZC19 Cabbage

ZC20 Chinese cabbage

ZC21 Spinach

IF17 Providing information class 6 (fine)

ZC22 Made in ◯◯◯

ZC23 Gathered this morning

ZC24 Without agrochemical

IF18 Providing information basic type

ZC25 Subject to being unsold

ZC26 Providing information reception type

ZC27 Cash

ZC28 Specified card

ZC29 Providing price

ZC30 Providing quantity

ZC31 Valid term

ZC32 Special note

ZC33 Only the first 100 people

ZC34 Only for ◯ days

ZC35 By ⊚ o'clock

ZC36 URL cut off http://www part or e-mail address of information provider

XU26 By the due date (YYMMDD) ZC30-2 Numbers of items (◯◯◯)

### FIG. 24

Abbrev.

IF19 Requested information class 1 (large)

IF20 Requested information class 2 (middle)

IF21 Requested information class 3 (classification)

IF22 Requested information class 4 (fragmentation)

IF23 Requested information class 5 (detail)

IF24 Requested information class 6 (fine)

ZD01 Requested price

ZD02 Requested quantity

IR04-2 Identifier showing information requested D/B

ZC36-2 URL cut off http://www part or e-mail address of information requestor

### FIG. 25

Abbrev.

S32 Selection among information providing D/B

S33 Selection among providing information items

EN02 End of selection among information

GN04 Generating information providing D/B for retrieving and check

ZD03 Providing information item selected

ZD04 Requested information item selected

S34 Selection among information requested D/B

C-URL Conversion into URL

GN04-2 Generating information requested D/B for retrieving and check

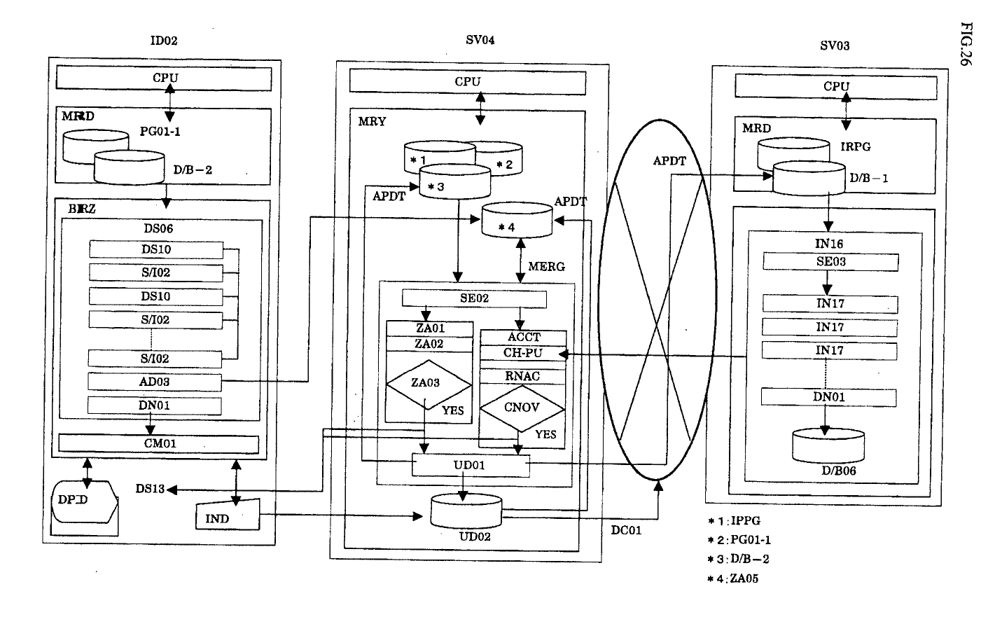

### FIG. 26

Abbrev.

PG01-1 Computer program for generating an information providing D/B to retrieval and check

D/B-2 Information providing D/B

DS13 Display of warning

SE02 Setting of warning and automatic update function

ZA01 Counter for due date

ZA02 Days count

ZA03 Elapse of designated due date

UD01 Updating of information providing D/B.

UD02 Updating of information providing D/B for retrieving and checking

IN16 Input of information requesting item name and information name

SE03 Setting of numbers of requesting information items

IN17 Input of requesting information item name

ZA05 Storage area for retrieving and checking of information requested

D/B

APDT Updating

MERG Checking

ACCT Accumulative counter

CH-PU Detection of identifier

RNAC Counting of request quantity

CNOV Excess to designated quantity

### FIG. 27

Abbrev.

CD03 Request code to convert into URL

IS07 Instruction of identifier extraction

CK03 Checking of codes having highest priority identifier

CK04 Checking of codes having second highest priority identifier

CK05 Checking of codes having third highest priority identifier

CK06 Checking of codes having forth highest priority identifier

DX01 Detection

CD04 Offer code to convert into URL

RT-27-1 Retrieving of £ ° C. £ code/ code/ |OR|O code

RT-27-2 Retrieving of £ ° C. £ code/ code/ |OO|O code

Yes YES

### FIG. 28

Abbrev.

IS09 Instruction of narrow down identifier extraction

DS14 Or Display of ‘Corresponded informations are as following’ on a requested page

CK07 Checking of priority setting codes

OBRZ-HP Display of corresponding page on browser

### FIG. 29

Abbrev.

DS15 Or Display of ‘corresponded information are as following’ on an information requested Home Page

PG07 Computer program for generating re-offer codes

AD04 Addition of re-offer code to offer code

ZA06 Receipt of re-offer code

IN/GN Input and generating re-offer code corresponding information

IN/ROC Input of re-offer code

### FIG. 30

Abbrev.

GN05 Generating information record and requested D/B

PG30-1 Computer program for generating an information provider D/B

PG30-2 Computer program for generating an information requester D/B

D/B10 An information record and requested D/B

D/B11 An information provider D/B

D/B12 An information requester D/B

ID02 Information provider side information device

ID01 Information requestor side information device

PA02 Home page of information provided

PA01 Home page of information requesting

RD01 Record of information provider

RD02 Record of information requester

CK08 Checking of recorded information

DS18 Display on mutual information devices

ID03 Information provider subject side information device

PG30-3 Computer program for generating an information record and requested D/B

D/B13 D/B for generating an information record and requested D/B

SV-30 Information provider subject server computer

SI-Z30 Selection of information contents

### FIG. 32

Abbrev.

ID03 Information provider subject side information device

PG30-3 Computer program for generating an information record and requested D/B

D/B13 D/B for generating an information record and requested D/B

IN21 Input of item for generating information record and request D/B and name of information

SE04 Setting of numbers of providing information items

IN13 Input of information item name

IN14 Input of providing information name

D/B10 An information record and requested D/B

D/B11 An information provider D/B

D/B12 An information Requestor D/B

DN01 Designation of input end

### FIG. 33

Abbrev.

DS17 Display of items for generating an information record and requested D/B and options

DS10 Display of providing information items

S/102 Selection and input of providing information

AD03 Addition of providing information address

DN01 Designation of input end

PG03 Computer program for generating an information provider D/B

PG04 Computer program for generating an information requester D/B

RD01 Record of information provider

RD02 Record of information requestor

RD/DL Record/Delete

GN06 Generating new document

UD03 Updating as saving record information

D/B14 An updated information provider D/B

D/B15 An updated information requester D/B

### FIG. 34

Abbrev.

ID02 Information provider side information device

ID01 Information requestor side information device

### FIG. 36

Abbrev.

IF-Z34 Information for retrieving and distinction (Retrieving identifier)

CK08 Checking of recorded information

### FIG. 36

Abbrev.

CK09 Checking of recorded contents

IS10 Instruction of retrieving/Extraction of identifier

### FIG. 37 (1/2)

Abbrev.

IR05 Identifier showing of being information record and requested D/B

IR06 Identifier showing of being 000 super market providing D/B

IR07 Identifier showing of being information provider D/B or information requester D/B

ZE01 Kitchen things

ZE02 Washing things

ZE03 Table ware

ZE04 Miscellaneous goods

ZE05 Rice

ZE06 Bread

ZE07 Delicatessen

ZE08 Detergent

ZE09 Towel

ZE10 Sponge

ZE11 Kitchen-roll

ZE12 Barm-cloth

ZE13 Dishwashing basket

ZE14 Detergent for rest room

ZE15 Detergent for bath

ZE16 Brush for rest room

ZE17 Brush for bath

ZE18 Washing towel

ZE19 Tub

ZE20 Towel

ZE21 Mule

ZE22 General detergent

ZF01 Eradication detergent

ZF02 Cleanser

ZF03 Mildew cleaner

ZF04 Grease cutting detergent

ZF05 Used both as eradication and as . . .

ZF06 Skin-cared

ZF07 Lemon fragrant

ZF08 Designated credit card

ZF09 Cash on delivery

ZB-37-1 X-th sales

ZB-37-2 Y-th sales

ZB-37-3 Z-th sales

### FIG. 37 (2/2)

Abbrev.

ZF-37 Internet banking

ZC30-2-2 Numbers of items (from ◯◯◯ to ◯◯◯)

XU-41 Date (from YYMMDD to YYMMDD)

ZC-37-1 Only the first ◯◯ people

ZC-37-2 Only for ◯◯ days

ZC-37-3 By ◯◯ o'clock

### FIG. 38

Abbrev.

CD05 Code of URL converted information provider D/B

R-D/B11 Registration of information provider D/B

RA-D/B11 Registration area of information provider D/B

### FIG. 39

Abbrev.

SL37 Selection of requesting information items

CD06 Code of URL converted information requestor D/B

RB-39-1 Registration of information requestor

R-D/B12 Registration of information requestor D/B

RB-39-2 Requested information base style

RB-39-3 Requested information reception style

RA-D/B12 Registration area of information requestor D/B

### FIG. 40

Abbrev.

CK10 Checking of recorded information in record area

RT03 Re-retrieving

NI No

CK-CD05 Checking of URL converted information provider D/B code

CK-CD06 Checking of URL converted information requestor D/B code

DP-URL Display of URL or code

### FIG. 41

Abbrev.

IS08 Instruction of retrieving

DX01 Detection

IS07 Instruction of identifier extraction

CK03 Checking of codes having highest priority identifier

CK04 Checking of codes having second highest priority identifier

CK05 Checking of codes having third highest priority identifier

CK-41 Checking of codes having n-th highest priority identifier

DX01 Detection

Yes YES

RT-41-1 Detection of (E OR (E code/β code/% O% code

RT-41-2 Detection of (E OR (E code/β code/% R% code

DS08 Display on browser

OBRZ-HP Display corresponding pages on browser

XP02 Display of “No information corresponding.”

XP-41 Or display of “Information corresponding is as following.” on information requestor page/information provider page

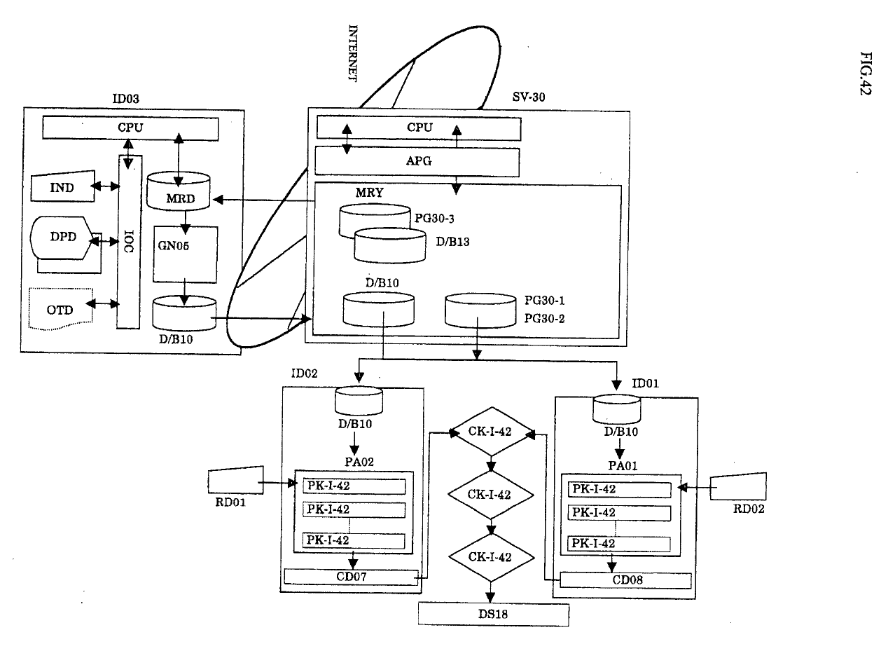

### FIG. 42

Abbrev.

PG-30-3 Computer program for generating an information record and requested D/B

D/B13 D/B for generating an information record area and requested D/B

PG30-1 Computer program for generating an information provider D/B

PG30-2 Computer program for generating an information requester D/B

CD07 Code of information provider D/B

CD08 Code of information requestor D/B

PK-I-42 Selection of information item

CK-I-42 Checking of information item

### FIG. 43

Abbrev.

SE05 Setting of numbers of providing information items

IN19 Input of items for generating an information record and requested

D/B and information names

### FIG. 44

Abbrev.

CD09 Code of URL converted information provider D/B

CD10 Code of URL converted information requestor D/B

ZG01 Providing information item selected

ZG02 Requesting information item selected

### FIG. 45

Abbrev.

RT-41-1 Retrieving of (E OR (E code/β code/%O% code

RT-41-2 Retrieving of (E OR (E code/β code/%R% code

CK-45-1 Checking of code area having highest priority identifier

CK-45-2 Checking of code area having second highest priority identifier

CK-45-3 Checking of code area having third highest priority identifier

CK-45-4 Checking of code area having n-th highest priority identifier

1. An information providing database generating method comprising a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check, characterized in that:
a computer storing a computer program for generation of an information providing database and a database for generation of an information providing database is used;
(O1) the computer program for generation of an information providing database is operated and calls the database for generation of an information providing database including a providing information item and a plurality of corresponding options and an information interchange system and a plurality of corresponding option;
(O2) a providing information item and a plurality of corresponding options are displayed on a display device, and one of the plurality of options is prompted to select and input to an information provider as a reply to the item;
(O3) a third information element indicating selected and input options and the priority information for retrieval and check on the item is generated and stored;
(O4) sequentially repeating the procedures (O2) and (O3) on all necessary items of providing information;
(O5) then, an item of an information interchange system and a plurality of corresponding options are displayed on a display device, and one of the plurality of options is prompted to select and input to an information provider as a reply to the item;
(O6) a fourth information element indicating selected and input options and the priority information for retrieval and check on the item is generated and stored;
(O7) sequentially repeating the procedures (O5) and (O6) on all necessary items of information interchange system; and
(O8) a first information element indicating an information providing database is further added.

2. An information providing database generating method comprising a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check, characterized in that:
a computer storing a computer program for generation of an information providing database and a database for generation of an information providing database is used;
(O1) the computer program for generation of an information providing database is operated and calls the database for generation of an information providing database including a providing information item and a plurality of corresponding options and an information interchange system and a plurality of corresponding option;
(O2) a providing information item and a plurality of corresponding options are displayed on a display device, and one of the plurality of options is prompted to select and input to an information provider as a reply to the item;
(O3) a third information element indicating selected and input options and the priority information for retrieval and check on the item is generated and stored;
(O4) sequentially repeating the procedures (O2) and (O3) on all necessary items of providing information;
(O5) then, an item of an information interchange system and a plurality of corresponding options are displayed on a display device, and one of the plurality of options is prompted to select and input to an information provider as a reply to the item;
(O6) a fourth information element indicating selected and input options and the priority information for retrieval and check on the item is generated and stored;
(O7) sequentially repeating the procedures (O5) and (O6) on all necessary items of information interchange system;
(O8) a first information element indicating an information providing database is further added; and
(O9) the first, second, third, and fourth information elements are converted into URL information as an identifier which is described in characters available for a URL and not defined for use in tags, etc., and the URL information is added to an arbitrary URL.

3. The information providing database generating method according to claim 1 or 2, characterized in that
the information interchange system is selected from among a ‘providing information basic type’ such as ‘communicating’, ‘meeting’, ‘recruitment’, ‘lending with charge’, ‘lending withoutcharge’, ‘buying’, ‘selling’, ‘giving’, ‘exchanging’, ‘testing?’, ‘teaching with charge’, teaching without charge’ ‘cooperating’, ‘sending an estimate’, a ‘request information reception type’ such as ‘send electronic mail’, ‘sending a guide’, ‘let's have a meeting’, ‘come and see it’, ‘come and take it’, ‘coming’, ‘sending a sample’, ‘delivering’, etc., and options for determining ‘information providing value’, ‘delivery term’, ‘delivery method’, ‘paymentmethod’, ‘order valid term’, etc.

4. An information requested database generating method comprising a first information element indicating an information requested database, a second information element indicating an attribute of an information requester, a third information element having requesting information and priority information for retrieval and check and having multiple structures in a complete inclusive relation, a fourth information element of parallel structure having priority information for an information interchange system and retrieval and check, characterized in that:
a computer storing a computer program for generation of an information requesting database and a database for generation of an information requesting database is used;
(R1) the computer program for generation of an information requesting database is operated and calls the database for generation of an information requesting database including a requesting information item and a plurality of corresponding options and an information interchange system and a plurality of corresponding option;
(R2) a requesting information item and a plurality of corresponding options are displayed on a display device, and one of the plurality of options is prompted to select and input to an information requester as a reply to the item;
(R3) a third information element indicating selected and input options and the priority information for retrieval and check on the item is generated and stored;
(R4) sequentially repeating the procedures (O2) and (O3) on all necessary items of requesting information;
(R5) then, an item of an information interchange system and a plurality of corresponding options are displayed on a display device, and one of the plurality of options is prompted to select and input to an information requester as a reply to the item;
(R6) a fourth information element indicating selected and input options and the priority information for retrieval and check on the item is generated and stored;
(R7) sequentially repeating the procedures (R5) and (O6) on all necessary items of information interchange system; and
(O8) a first information element indicating an information requesting database is further added.

5. An information requested database generating method comprising a first information element indicating an information requested database, a second information element indicating an attribute of an information requester, a third information element having requesting information and priority information for retrieval and check and having multiple structures in a complete inclusive relation, a fourth information element of parallel structure having priority information for an information interchange system and retrieval and check, characterized in that:
a computer storing a computer program for generation of an information requesting database and a database for generation of an information requesting database is used;
(R1) the computer program for generation of an information requesting database is operated and calls the database for generation of an information requesting database including a requesting information item and a plurality of corresponding options and an information interchange system and a plurality of corresponding option;
(R2) a requesting information item and a plurality of corresponding options are displayed on a display device, and one of the plurality of options is prompted to select and input to an information requester as a reply to the item;
(R3) a third information element indicating selected and input options and the priority information for retrieval and check on the item is generated and stored;
(R4) sequentially repeating the procedures (O2) and (O3) on all necessary items of requesting information;
(R5) then, an item of an information interchange system and a plurality of corresponding options are displayed on a display device, and one of the plurality of options is prompted to select and input to an information requester as a reply to the item;
(R6) a fourth information element indicating selected and input options and the priority information for retrieval and check on the item is generated and stored;
(R7) sequentially repeating the procedures (R5) and (O6) on all necessary items of information interchange system;
(O8) a first information element indicating an information requesting database is further added; and
(O9) the first, second, third, and fourth information elements are converted into URL information as an identifier which is described in characters available for a URL and not defined for use in tags, etc., and the URL information is added to an arbitrary URL.

6. The information requested database generating method according to claim 4 or 5, characterized in that
the information interchange system is selected from among a ‘request information basic type’ such as ‘request to communicate’, ‘request to meet’, ‘recruitment’, ‘request to be lent with charge’, ‘request to be lent without charge’, ‘request to buy’, ‘request to sell’, ‘request to have it’, ‘request to exchange’, ‘request to test’, ‘request to know with charge’, ‘request to know without charge’, ‘request to learn with charge’, ‘request to learn without charge’, ‘request to receive with charge’, ‘request to receive without charge’, ‘request to cooperate’, ‘request to receive an estimate’, a ‘request information delivery type’ such as ‘request to have electronic mail’, ‘request to receive a guide’, ‘request to have a meeting’, ‘request to go and see it’, ‘come and take it’, ‘request to receive a sample’, ‘request a delivery’, etc., and options for determining ‘request area’, ‘requested price’, ‘requestamount’, ‘deliverymethod’, ‘paymentmethod’, ‘return information specification’, ‘request valid term’, etc.

7. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested database, when a completely matching combination is detected, a statement that a matching partner has been detected are displayed to both a home page of an information provider of the information providing database and a home page of an information requester of the information requested database and a partner homepage is directly displayed for the combination.

8. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested database, when a completely matching combination is detected, a statement that a completely matching partner has been detected and a URL specifying a partner home page are displayed to both a home page of an information provider of the information providing database and a home page of an information requester of the information requested database for the combination.

9. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested, when a completely matching combination is detected, a statement that a completely matching partner has been detected and a URL specifying a partner home page are transmitted to both an electronic mail address of an information provider of the information providing database and an electronic mail address of an the information requester of the information requested database for the combination.

10. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected are displayed to both a home page of an information provider of the information providing database and a home page of an information requester of the information requested database and a partner homepage is directly displayed for the combination.

11. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected and a URL specifying a partner home page are displayed to both a home page of an information provider of the information providing database and a home page of an information requester of the information requested database for the combination.

12. An information retrieving method for:
publishing an information providing database in a communications circuit network comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check;
publishing an information requested database in a communications circuit network comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected and a URL specifying a partner home page are transmitted to both an electronic mail address of an information provider of the information providing database and an electronic mail address of an the information requester of the information requested database for the combination.

13. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested database, when a completely matching combination is detected, a statement that a matching partner has been detected are displayed to both a home page of an information provider of the information providing database and a home page of an information requester of the information requested database and a partner homepage is directly displayed for the combination.

14. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested database, when a completely matching combination is detected, a statement that a completely matching partner has been detected and a URL specifying a partner home page are displayed to both a home page of an information provider of the information providing database and a home page of an information requester of the information requested database for the combination.

15. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested, when a completely matching combination is detected, a statement that a completely matching partner has been detected and a URL specifying a partner home page are transmitted to both an electronic mail address of an information provider of the information providing database and an electronic mail address of an the information requester of the information requested database for the combination.

16. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected are displayed to both a home page of an information provider of the information providing database and a home page of an information requester of the information requested database and a partner homepage is directly displayed for the combination.

17. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected and a URL specifying a partner home page are displayed to both a home page of an information provider of the information providing database and a home page of an information requester of the information requested database for the combination.

18. An information retrieving method for:
converting an information providing database comprising: a first information element indicating an information providing database, a second information element indicating an attribute of an information provider, a third information element having providing information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information providing database in a communications circuit network by adding the URL information to an arbitrary URL;
converting an information requested database comprising: a first information element indicating an information requested database, a second information element indicating an attribute of an information requester, a third information element having request information and priority information for retrieval and check and having multiple structures in a complete inclusive relation, a fourth information element of parallel structure having priority information for an information interchange system and retrieval and check into URL information using a character available in a URL and not used for a tag, etc. as an identifier and publishing the information requested database in a communications circuit network by adding the URL information to an arbitrary URL; and
using an information providing database and an information requested database when information about each item of a third information element of the information providing database is compared with information about each item of a third information element of the information requested database on an item of the third information element to which an identifier is assigned for determining a same priority for retrieval and check from a highest priority item which is a narrowest and lowest order concept gradually until a matching combination can be detected, and information about each item of the information providing database is sequentially compared with information about each item of the information requested database on a lower item in priority which is a broader and higher order concept, when a matching combination is detected, a statement that a matching partner has been detected and a URL specifying a partner home page are transmitted to both an electronic mail address of an information provider of the information providing database and an electronic mail address of an the information requester of the information requested database for the combination.

19. An information record and requested database generating method, characterized in that:
the information record and requested database generated according to claim 1 is converted into HTML and presented on a WEB, and a WEB link record program and a WEB link database are provided for setting a link for each information item on the information record and requested database;
(1) an information item for a link on the information record and requested database presented on the WEB is specified, and a URL linked to the information item is input, and then link information for the information item on the information record and requested database is automatically generated;
(2) the generated link information is stored in the WEB link database together with information indicating an information item in the information record and requested database as a link target; and
(3) each time the information record and requested database generated according to claim 1 is updated, the database is converted into an HTML, and when the database is presented on the WEB, it is compared with the information indicating the information item in the information record and requested database as a link target, and link information is automatically generated again.

20. (OS11) A retrieval checking information providing database generating method, characterized in that:
an information providing database for operating a computer program for generation of an information providing database in a user computer, comprising a first information element indicating a database corresponding to an information retrieving method and including information for retrieval and check, a second information element indicating a database generator who is an information providing subject and including information for retrieval and check, a third information element indicating an information providing database and including information for retrieval and check, and a fourth information element in multiple structures including priority information for retrieval and check;
a server computer storing a computer program for generation of an information providing database and a database for generation of an information providing database is used;
(O11) a computer program for generation of an information providing database is operated in a user computer, and the database for generation of an information providing database is called;
(O12) when an information providing subject sets the number of items of providing information, all columns for input of providing information are displayed on a display device, the information providing subject inputs priority information for retrieval and check for the item, and stores the information in the user computer;
(O13) the information providing subject inputs information item name provided for each items into the column, and stores it in the user computer;
(O14) the information providing subject inputs the information name corresponding to the information item name, and stores it in the user computer;
(O15) for the column of the item of the providing information in which a plurality of selection items can be recorded, a column recording a plurality of options is displayed on the display device, the information providing subject inputs a plurality of options as options for the items, and generates and stores the code information for retrieval and check for the input options and the item;
(O16) the procedures (O13) and (O14) and (O15) are sequentially performed on all items of the providing information, thereby calling the information providing database generated in the information providing database generating method;
(OS12) the item of the providing information and a plurality of corresponding options are displayed on the display device, and the information provider is prompted to select and input one or more options from among the plurality of options as a reply to the item;
(OS13) the selected and input options and the fourth information element indicating the priority information for retrieval and check for the item are generated and stored;
(OS14) the procedures (OS12) and (OS13) are sequentially repeated on all necessary items of the providing information;
(OS15) then, an item of the information interchange system and a plurality of corresponding options are displayed on a display device, and the information provider is prompted to select and input one or more options from among the plurality of options as a reply to the item;
(OS16) the selected and input options and the fifth and sixth information elements indicating the priority information for retrieval and check for the item are generated and stored;
(OS17) the procedures (OS15) and (OS16) are sequentially repeated on all necessary items of the information interchange system;
(OS18) when all information selection and input is completed, information indicating the address at which the information corresponding to the retrieval checking information providing database is stored is added; thereby
generating a retrieval checking information providing database.

21. A retrieval checking information providing database generating method, characterized in that:
in the retrieval checking information providing database according to claim 20, information requested by an information requester is selected, a retrieval checking information providing database is generated, a user computer converts a first information element, a second information element, a third information element, a fourth information element, a fifth information element, and a sixth information element into URL information using a character, which is available by a URL and whose use in a tag, etc. is not defined, as an identifier, and the URL information is added to an arbitrary URL, and the information indicating an address at which information corresponding to the retrieval checking information providing database is stored is added.

22. An information requested database generating method, characterized in that:
when an information providing database is generate or when an information providing database is updated, the database comprises a first information element indicating a database corresponding to an information retrieving method and including information for retrieval and check, a second information element indicating a database generator who is an information providing subject and including information for retrieval and check, a third information element indicating an information providing database and including information for retrieval and check, and a fourth information element in multiple structures including priority information for retrieval and check;
a server computer storing a computer program for generation of an information providing database and a database for generation of an information providing database is used;
(O11) a computer program for generation of an information providing database is operated in a user computer, and the database for generation of an information providing database is called;
(O12) when an information providing subject sets the number of items of providing information, all columns for input of providing information are displayed on a display device, the information providing subject inputs priority information for retrieval and check for the item, and stores the information in the user computer;
(O13) the information providing subject inputs information item name provided for each items into the column, and stores it in the user computer;
(O14) the information providing subject inputs the information name corresponding to the information item name, and stores it in the user computer;
(O15) for the column of the item of the providing information in which a plurality of selection items can be recorded, a column recording a plurality of options is displayed on the display device, the information providing subject inputs a plurality of options as options for the items, and generates and stores the code information for retrieval and check for the input options and the item;
(O16) the procedures (O13) and (O14) and (O15) are sequentially performed on all items of the providing information; thereby
information for retrieval and check added to the third information element indicating an information providing database in the information providing database generated in the information providing database generating method is converted into information for retrieval and check and indicating an information requested database, the information is stored in a storage device of the same or a different server computer in a position referred to by the information providing database, thereby generating an information requested database.

23. A retrieval checking information requested database generating method for generating a new information requested database in the procedure according to claim 22 when an information providing database is generated or when information recorded in the information providing database is updated, and generating a retrieval checking information requested database when an information requester specifies an information item or a selection item according to procedures (R11) to (R16), characterized in that:
a server computer storing a computer program for generation of an information requested database and a database for generation of an information requested database is used;
(R11) the computer program for generation of an information requested database is operated in a user computer, the information requested database generated in the information requested database generating method according to claim 21 is called;
(R12) an item of providing information and a plurality of corresponding options are displayed on a display device, and the information provider is prompted to select and input one or more options from among the plurality of options as a reply to the item;
(R13) the selected and input options and the fourth information element indicating the priority information for retrieval and check for the item are generated and stored;
(R14) the procedures (R12) and (R13) are sequentially repeated on all necessary items of the providing information;
(R15) then, an item of the information interchange system and a plurality of corresponding options are displayed on a display device, and the information provider is prompted to select and input one or more options from among the plurality of options as a reply to the item;
(R16) the selected and input options and the fifth and sixth information elements indicating the priority information for retrieval and check for the item are generated and stored;
(R17) the procedures (R15) and (R16) are sequentially repeated on all necessary items of the information interchange system, thereby generating a retrieval checking information requested database.

24. A retrieval checking information requested database generating method, characterized in that:
after generating the retrieval checking information requested database according to claim 23, a user computer converts a first information element, a second information element, a third information element, a fourth information element, a fifth information element, and a sixth information element into URL information using a character, which is available by a URL and whose use in a tag, etc. is not defined, as an identifier, and the URL information is added to an arbitrary URL.

25. An information retrieving method for comparing a retrieval checking information providing database generated in the retrieval checking information providing database generating method according to claim 20 with a retrieval checking information requested database generated in the retrieval checking information requested database generating method according to claim 23 in the same or a different server computer, characterized in that
a comparison is made from a highest priority item, as determined by an information provider and an information requester, which is a narrowest concept gradually until a matching combination can be detected, and information about each item of the retrieval checking information providing database is sequentially compared with information about each item of the retrieval checking information requested database on a lower item in priority which is a broader and higher order concept, when a matching combination is detected, the combination is transmitted to a home page of an information provider of the retrieval checking information providing database and a home page of an the information requester of the retrieval checking information requested database that a matching partner has been detected, and a partner home page displayed.

26. An information retrieving method for publishing a retrieval checking information providing database generated in the retrieval checking information providing database generating method according to claim 21 on a communications circuit network, and publishing a retrieval checking information requested database generated in the retrieval checking information requested database generating method according to claim 24 on a communications circuit network, characterized in that
a comparison is made from a highest priority item, as determined by an information provider and an information requester, which is a narrowest and lowest order concept gradually until a matching combination can be detected, and information about each item of the retrieval checking information providing database is sequentially compared with information about each item of the retrieval checking information requested database on a lower item in priority which is a broader and higher order concept, when a matching combination is detected, the combination is transmitted to an electronic mail address of an information provider of the retrieval checking information providing database and an electronic mail address of an the information requester of the retrieval checking information requested database that a matching partner has been detected, and a partner home page displayed.

27. An information retrieving method for converting a retrieval checking information providing database generated in the retrieval checking information providing database generating method according to claim 21 into URL information together with code information about a selected item using a character available in a URL as an identifier and whose use in a tag, etc. is not defined, and the database is published on a communications circuit network by adding the URL information to an arbitrary URL, and converting a retrieval checking information requested database generated in the retrieval checking information requested database generating method according to claim 24 into URL information together with code information about a selected item using a character available in a URL as an identifier and whose use in a tag, etc. is not defined, and the database is published on a communications circuit network by adding the URL information to an arbitrary URL, characterized in that
a comparison is made from a highest priority item, as determined by an information provider and an information requester, which is a narrowest and lowest order concept gradually until a matching combination can be detected, and information about each item of the retrieval checking information providing database is sequentially compared with information about each item of the retrieval checking information requested database on a lower item in priority which is a broader and higher order concept, when a matching combination is detected, the combination is transmitted to an electronic mail address of an information provider of the retrieval checking information providing database and an electronic mail address of an the information requester of the retrieval checking information requested database that a matching partner has been detected, and a partner home page displayed.

28. A retrieval checking information providing database generating method, characterized in that:
providing in a server computer an area for storing the retrieval checking information providing database according to claim 20, a term counter for management of overdue information providing and/or an aggregate counter for adding up the number of requesters for providing information;
the term counter compares the term set in the retrieval checking information providing database with the current date and time, and, if overdue information providing is indicated, a warning of overdue information providing is transmitted to a user computer of an information requester, or the retrieval checking information providing database is automatically updated, and an information providing database and an information requested database are automatically updated; and
the accumulation counter constantly compares providing information having a quantity limit set in the retrieval checking information providing database with the current requested quantity, and, if the requested quantity reaches the set quantity, a warning of reaching the set quantity is transmitted to a user computer of an information provider, or the retrieval checking information providing database is automatically updated, and simultaneously an information providing database and an information requested database are updated.

29. An information record and requested database generating method, comprising:
a first information element indicating a database corresponding to an information retrieving method and including information for retrieval and check, a second information element indicating a database generator who is an information providing subject and including information for retrieval and check, a third information element indicating an information providing database and including information for retrieval and check, and a fourth information element in multiple structures including priority information for retrieval and check, characterized in that:
a computer storing a computer program for generation of an information record and requested database and a database for generation of an information record and requested database is used;
(O21) a computer program for generation of the information record and requested database is operated in a user computer, and
a server computer storing an information record and requested database comprising: a first information element indicating a database corresponding to an information retrieving method, a second information element indicating a database generator who is an information providing subject, a third information element indicating an information record and requested database, and a fourth information element in multiple structures including priority information for retrieval and check is used;
(O22) a computer program for generation of an information record and requested database is operated in a user computer, and the database for generation of an information record and requested database is called;
(O23) when an information providing subject sets the number of items of providing information, all columns for input of providing information are displayed on a display device, the information providing subject inputs priority information for retrieval and check for the item, and stores the information in the user computer;
(O24) the information providing subject inputs information item name provided for each items into the column, and stores it in the user computer;
(O25) the information providing subject inputs the information name corresponding to the information item name, and stores it in the user computer;
(O26) for the column of the item of the providing information in which a plurality of selection items can be recorded, a column recording a plurality of options is displayed on the display device, the information providing subject inputs a plurality of options as options for the items, and generates and stores the code information for retrieval and check for the input options and the item;
(O27) the procedures (O24) and (O25) and (O26) are sequentially performed on all items of the providing information.

30. An information provider database generating method for calling the information record and requested database generated in the method according to claim 29 when the information record and requested database is generated, and further calling a computer program for generation of an information provider database, characterized in that:
(O21) an information provider database having a shape formed by an information element, an information item, and code information for retrieval and check completely the same as those in the information record and requested database except replacing the third information element with an information element indicating an information provider database;
(O22) in an information provider database generated in the method above (O21), a code identifying an information providing requester assigned in advance and selected with the information as providing request information, or an URL address of an information providing requester is sequentially stored in a column corresponding to a column for input of an information name described in claim 29 (O25) in an information record and requested database; or
(O23) a storage area is set for each retrieval identifier corresponding to an information element held in the information record and requested database and each information code for retrieval and check, and a code identifying an information providing requester assigned in advance and selected with the information as providing request information, or an URL address of an information providing requester is sequentially stored.

31. An information requester database generating method for calling the information record and requested database generated in the method according to claim 29 when the information record and requested database is generated, and further calling a computer program for generation of an information requester database, characterized in that:
(O21) an information requester database having a shape formed by an information element, an information item, and code information for retrieval and check completely the same as those in the information record and requested database except replacing the third information element with an information element indicating an information requester database;
(O22) in an information requester database generated in the method above (O21), a code identifying an information requester assigned in advance and selected with the information as requesting information, or an URL address of an information requester is sequentially stored in a column corresponding to a column for input of an information name described in claim 29 (O25) in an information record and requested database; or
(O23) a storage area is set for each retrieval identifier corresponding to an information element held in the information record and requested database and each information code for retrieval and check, and a code identifying an information requester assigned in advance and selected with the information as requesting information, or an URL address of an information requester is sequentially stored.

32. (O21) An information provider database generating method for having a shape formed by an information element, an information item, and code information for retrieval and check completely the same as those in the information record and requested database, and updating an information provider database while holding a code identifying an information providing requester assigned in advance and selected with the information as providing request information, or an URL address of an information providing requester stored in a column corresponding to a column for input of an information name in an information record and requested database,
(O22) or a storage area being set for each retrieval identifier corresponding to an information element held in the information record and requested database and each information code for retrieval and check, and sequentially updating a new information provider database while holding information having a recorded code identifying an information providing requester assigned in advance and selected with the information as providing request information, or an URL address of an information providing requester.

33. (O21) An information requester database generating method for having a shape formed by an information element, an information item, and code information for retrieval and check completely the same as those in the information record and requested database, and updating an information requester database while holding a code identifying an information providing requester assigned in advance and selected with the information as providing request information, or an URL address of an information providing requester stored in a column corresponding to a column for input of an information name in an information record and requested database,
(O22) or a storage area being set for each retrieval identifier corresponding to an information element held in the information record and requested database and each information code for retrieval and check, and sequentially updating a new information requester database while holding information having a recorded code identifying an information providing requester assigned in advance and selected with the information as providing request information, or an URL address of an information providing requester.

34. An information retrieving method using an information provider database and an information requester database for comparing an information provider database generated in the method according to claim 30 or 32 with an information requester database generate in the method according to claim 31 or 33 in the same or a different server computer, checking a storage area of an information provider database corresponding to a storage area determined by the code having the same code information element and information item as a code for retrieval and check, and, when there is a code identifying an information provider assigned in advance to an information provider selecting the recorded code or a URL address of an information provider in the information provider database, transmitting the code or the URL address to an information requester, characterized in that
when there is no code identifying an information provider assigned in advance to an information provider or a URL address of an information provider in the information provider database corresponding to a selection code determined by an information requester, items of lower priorities in a higher concept are gradually compared between the information provider database and the information requester database or using a computer connected to a communications circuit network until an information provider database including a record code of an information provider or a URL address of an information provider can be detected, and, when a storage area of an information provider database including a record code of an information provider or a URL address of an information provider can be detected is detected, information that a matching partner has been detected or a home page of a partner is displayed on home pages of an information provider and an information requester about a code identifying an information provider assigned in advance to an information provider stored in the storage area or a URL address of an information provider.

35. An information retrieving method using an information provider database and an information requester database for comparing an information provider database generated in the method according to claim 30 or 32 with an information requester database generate in the method according to claim 31 or 33 in the same or a different server computer, checking a storage area of an information requester database corresponding to a storage area determined by the code having the same code information element and information item as a code for retrieval and check, and, when there is a code identifying an information requester assigned in advance to an information requester selecting the recorded code or a URL address of an information requester in the information requester database, transmitting the code or the URL address to an information provider, characterized in that
when there is no code identifying an information requester assigned in advance to an information requester or a URL address of an information requester in the information requester database corresponding to a selection code determined by an information provider, items of lower priorities in a higher concept are gradually compared between the information provider database and the information requester database or using a computer connected to a communications circuit network until an information requester database including a record code of an information requester or a URL address of an information requester can be detected, and, when a storage area of an information requester database including a record code of an information requester or a URL address of an information requester can be detected is detected, information that a matching partner has been detected or a home page of a partner is displayed on home pages of an information provider and an information requester about a code identifying an information requester assigned in advance to an information requester stored in the storage area or a URL address of an information requester.
